(19) United States
(12) Patent Application Publication
(10) Pub. No.: US 2026/0049889 A1
(43) Pub. Date: Feb. 19, 2026

(54) MULTI-MODAL IMAGING SYSTEM FOR LEAK DETECTION

(71) Applicant: IntelliView Technologies Inc., Calgary (CA)

(72) Inventors: Junchi BIN, Nanning (CN); Choudhury Ashiq RAHMAN, Calgary (CA); Pablo ADAMES, Calgary (CA); Samuel LAU, Calgary (CA); Shane ROGERS, Calgary (CA); Zheng LIU, Kelowna (CA)

(21) Appl. No.: 19/258,704

(22) Filed: Jul. 2, 2025

(30) Foreign Application Priority Data
Jul. 3, 2024 (CA) 3246008

(51) Int. Cl. G01M 3/38; G01M 3/00; G06T 7/246; G06T 7/73

(52) U.S. Cl. CPC G01M 3/38; G01M 3/002; G06T 7/248; G06T 7/74; G06T 2207/10004; G06T 2207/10048; G06T 2207/20081; G06T 2207/20084; G06T 2207/20221

(57) ABSTRACT

A leak of a cold fluid (e.g., a chilled fluid, or a fluid that is initially pressurized and becomes cold on leakage) is detected using a sequence of Infrared (IR) and Visual (VI) images. Using neural nets, in each of VI and IR image-level features are extracted from images and compared with image-level features from images of different times to obtain motion-enhanced features. The motion enhanced features from VI and IR are then compared to obtain fused features from which the leak is detected. The image-level features may be extracted using a neural net with multiple stages. The motion-enhanced and fused features may be obtained in parallel using the image-level features from the multiple stages, and the leak detection based on the stage-specific fused features.

### TECHNICAL FIELD

Leak detection from video images.

### BACKGROUND

Natural gas plays a significant role in not only the global energy system but also in manufacturing. Ethane, (C₂H₆) a colorless chemical compound which is a major flammable chemical compound in natural gas, is the primary input for producing plastic and other industrial and consumer products. The growing demand of ethane from global market requires Canadian petrochemical industries to refine hundred of thousands of barrels per day for export. Ethane leaks from pipelines and facilities have severe consequences such as economic losses, environmental impact, and public safety.

The primary usage of ethane is ethylene production for plastics that are indispensable in people's daily life. Canada, as one of the world's largest producers of natural gas, has numerous petrochemical industries to produce ethylene for international exports. The Chemistry Industry Association of Canada (CIAC) reported that the exports of ethylene contributed approximately $1.2 billions of economic profits in 2011. To meet the rising demand of ethylene consumption, the Canadian government has approved several projects to expand the pipelines for ethane transportation across North America. The ethane will be converted into liquid form under high-pressure and low-temperature environments. However, most of the pipelines are functioning beyond the expected life spans. Especially for pipelines in rural areas, the pipelines are corroded by moist air and soils, resulting in cracked on pipelines. Without timely inspection of pipelines, pipeline cracks can cause a severe explosion and environmental pollution, such as the disasters in Prince George, Canada and Mont Belvieu, USA. Accordingly, petrochemical industries are required to conduct a leak detection and repair (LDAR) survey to discover leaks on pipelines. Optical gas imaging (OGI) is a prevalent technique that employs middle wavelength infrared (IR) cameras to perceive ethane leaks from pipelines. Conventional LDAR procedure requires the surveyors to carry portable OGI to scan every sector of pipelines. Such a manual approach is labor-intense, significantly increasing the capital cost of energy industries. Meanwhile, an empirical study indicates that only experienced surveyors can achieve satisfactory accuracy in leak detection. Besides, training or employing experienced surveyors increases the petrochemical industry's financial burden.

An ethane or gas leak can make an acoustic signal due to its escaping from the breach in the pipeline or storage. A conventional way of recording the internal acoustic signals is using a stethoscope or listening stick to listen to the suspected segments of pipelines. In order to achieve continuous monitoring for a segment of pipeline, two acoustic sensors are attached to the surface of pipelines at certain distance. Then the leak can be detected by calculating the correlation of acoustic noises at the two sensors. Recent study evolves the process by conducting a Kolmogorov-Smirnov statistical test to better compare the noises between two sensors. However, the flow noises and environmental noises (such as human passing) may cover the leaks' sound. Meanwhile, the attenuation of acoustic signals is also significant inside the transmission pipelines and storage tanks, which requires to install numerous sensors. The cost of numerous sensors is also high for both governments and industries.

Both electrical and optical cable sensors can be employed to monitor the changes of physical and chemical properties inside the transmission pipelines when ethane leaks occur. For example, Tanimola et al. deployed optical cable to monitor the concentration of hydrocarbon in the natural gas compound. Electrical cable sensors are used to measure the changes of resistance and capacitance which is influenced by changes in the contents of pipelines. The advantage of cable sensors is the fast response to the change of conditions in the pipelines. However, it is not a direct perception of the gas leak which may arouse numerous false alarms. Meanwhile, the deployment of cable sensor and corresponding analytic systems is expensive especially for long expansion pipelines.

For underground pipelines, chemical sensors and instruments can be used to monitor the surface or the soil above the pipelines through analysis of chemical compounds. Compared with cable sensors, it is a direct perception of gas or ethane leaks. Meanwhile, the advantage of chemical sensors is the low rate of false alarms during the process of leak detection. However, chemical sensors are also expensive. And, the corresponding sensors and instruments often need to be continuously supplied with chemical materials to maintain the sensitivity to the gas leak, which requires field engineers to apply additional efforts during the inspection.

Ultrasonic flow meters are also broadly used to detect the escaping gas from the pipelines. Specifically, for each segment of pipelines, there are a transmitter and a receiver that produce sound waves from one end and receive the signal at another end, accordingly. The leak detection can then be resolved based on the properties of sonic propagation. Compared with cable sensors and soil monitoring, the cost of ultrasonic flow meters is much lower. However, they are difficult to retrofit to existing pipelines or storage tanks.

Optical gas imaging (OGI) is an emerging technology that allows engineers to remotely perceive a gas leak. Specifically, OGI employs middle-wavelength infrared (IR) imaging and long-wavelength IR imaging (or thermal imaging) to monitor for leaks at petrochemical industries. IR imaging can visualize the escaping gas to help engineers fast localize the gas leaks. Meanwhile, deploying IR imaging to any petrochemical infrastructure does not require any retrofitting process, which reduces the cost during monitoring. Meanwhile, with the fast development of imaging hardware, the cost of implementing IR imaging is significantly reduced to an affordable price for petrochemical industries. In summary, compared with other contemporary techniques as presented in Table 1, IR imaging is affordable and sensitive hardware to fast detect a gas leak without additional effort in installment. In this regard, IR imaging is becoming the mainstream hardware for leak detection.

TABLE 1

| | Acoustic | Cable | Chemical | Ultrasonic | |
|---|---|---|---|---|---|
| Features | Techniques | Sensor | Sensors | Flow Meters | IR Imaging |
| Cost | Low | High | High | Low | Moderate |
| Perception | Slow | Fast | Fast | Moderate | Fast |
| Speed | | | | | |
| Sensitivity | Low | High | Moderate | Moderate | High |
| Easy to Use | No | Yes | No | Yes | Yes |
| Easy | Yes | No | Yes | No | Yes |
| Retrofitting | | | | | |

Generally, there are three ways of deploy IR imaging to screen the ethane or gas leaks, e.g., manual screening, airborne scanning and visual surveillance. Manual screening is a common way to use IR imaging that requires certified engineers to carry portable IR cameras to screen the surface of pipelines or storage facilities. If any leak occurs, the engineers observe the leak from the screen of IR cameras and document the properties of leaks. Although manual screening is an effective way to inspect ethane leaks, it is still laborious to screen entire petrochemical industries. To relieve the laborious burdens of on-site engineers, petro-chemical industries launch aircraft or unmanned aerial vehicles (UAVs) equipped with IR cameras to perceive the leaks in the air. Compared with conventional manual screening, airborne scanning can effectively detect the spreading escaping gas from facilities with large coverage, reducing the labor costs. However, since the distance between aircraft and leak sources is usually long, IR cameras may not perceive leaks of small sizes from aircraft. Thus, the sensitivity is lower than the manual scanning from IR cameras on aircraft. On the other hand, UAVs are undergoing rapid uptake through industrial applications. They can be launched closer to the leak sources to perceive small leaks. Besides, UAVs have lower mobilization costs than aircraft, which makes them more prevalent nowadays. Although empirical studies demonstrate the effectiveness of both manual screening and airborne scanning for gas leak detection, none of them can continuously monitor the gas leaks at petrochemical facilities. In this regard, recent industrial applications start embracing the advances in internet of things and sensory technology to deploy surveillance (or fixed) IR cameras to achieve a sustainable perception of gas leaks. There are two layers, i.e. edge layer and cloud layer, in the system. First, several surveillance IR cameras are deployed to cover the entire industrial infrastructure. Then, the recorded videos are uploaded to the cloud layer to visualize the leaks and inform engineers for repair. Compared with manual screening and airborne scanning, the monitoring process is continuously online to help engineers discover the leak as soon as possible. For example, a pioneer Canadian company, Intelliview Technology Inc, has deployed a DCAM-M system to monitor gas plants 24/7, making up 12% of global gas emissions. This research also employs the concept of visual surveillance for ethane leak detection.

Conventional visual surveillance relies on manual inspection for gas leaks detection from engineers at early development, which is still laborious. Meanwhile, an empirical report indicates that only experienced engineers (who have scanned over hundreds of facilities) can achieve a satisfactory detection rate of gas leaks, which also requires additional costs to train the engineers for this purpose. Thus, object detection frameworks are demanded to achieve automatic ethane (or gas) leak detection from the surveillance IR cameras. With advances in the internet of things (IoT), modern industries install visual surveillance systems to monitor industrial facilities through numerous surveillance (or fixed) cameras. These surveillance cameras continuously upload videos to the headquarters. Then, the operators can watch the streaming videos to know if abnormal events occur. However, as the numbers of surveillance videos increase, the human labor required to monitor them becomes costly and problematic to manage. An automatic visual surveillance (AVS) system is demanded to monitor and detect abnormal activities from surveillance cameras. Recent AVS employs advanced computer vision algorithms, such as background subtraction and object detection, to successfully and automatically monitor traffic, human activities and abnormal events. Therefore, researchers and engineers also introduce these computer vision techniques to achieve AVS for ethane or gas leak detection in petrochemical industries. Compared with manual scanning with portable OGI, automatic ethane leak detection assists field engineers in early intervention, preventing leaks from becoming severe disasters. Recent studies have used background subtraction (BGS) to detect the foregrounds based on the motion between IR video frames. The regions of potential gas leaks can be roughly localized in the extracted foregrounds. After BGS, statistical methods are applied to refine the ultimate regions of gas leaks. Although these empirical BGS-based frameworks are effective for gas surveillance systems with a minor chance of missing leaks, the BGS may bring numerous ambient noises due to camera jitters and unexpected disturbances. Over the past few years, computer vision techniques have been widely adopted to perform detection tasks. Recent research integrates IR imaging and a conventional computer vision technique, namely a faster region-based neural network (Faster RCNN), to achieve automatic leak detection from a single IR image under industrial scenarios. Moreover, Zhou et al., “Explore spatio-temporal aggregation for insubstantial object detection: Benchmark dataset and baseline,” in 2022 IEEE/CVF Conference on Computer Vision and Pattern Recognition (CVPR). IEEE, jun 2022, employs a temporal enhancement and aggregation (TEA) network to detect gas leaks by adding motion information from IR video frames, which is inspired by both BGS and image-based object detection.

However, IR imaging only reflects the ambient temperature of objects without semantic information such as texture and colors. The missing semantic information makes it difficult for the algorithms to distinguish ethane leaks from image backgrounds, which causes numerous false detections after deployment. Thus, with such a uni-modal framework it is still challenging to achieve satisfactory detection accuracy with surveillance IR cameras. To compensate for the disadvantage of the uni-modal framework, Wang et al., “Machine vision for natural gas methane emissions detection using an infrared camera,” Applied Energy, vol. 257, p. 113998, January 2020, employs a background subtraction (BGS) technique, in this case a Gaussian Mixture Model (GMM), to enhance detection quality through deriving the motion information (or moving foregrounds) between consecutive IR video frames. However, the conventional BGS is challenging to adapt in complex outdoor environments, which also degrades the sensitivity in perceiving ethane leaks from pipelines. And, the conventional BGS framework classifies the leak according to the derived motion information without original information from IR images. The lack of original IR information may also cause false detection. Therefore, there is still room to evolve the current motion-aware AVS for ethane leak detection. Moreover, the motion information fully addresses the challenge of insufficient semantic information. Thus, another modality or information source is desired to enrich the semantic knowledge for precise ethane or gas leak detection.

Object detection is still an emerging technique to achieve automatic visual surveillance of ethane leaks with few published articles. The relevant research and applications have been rapidly growing for decades. Therefore, the contemporary development of object detection for visual surveillance is discussed, even where not used for leak detection. According to the nature of these frameworks, they can be categorized into three groups: 1) background subtraction-based object detection (BGSOD); 2) image-based object detection (IMOD); and 3) hybrid motion-aware object detection (MAOD). Specifically, the BGSOD consists of two main components, i.e. background subtraction (BGS) and classification. The BGS aims to compare the background frame and input frame to unveil the motion (or difference) between them. Then, the moving foregrounds can be estimated. Finally, the regions of foregrounds are cropped to be classified if the foreground is the wanted object. Unlike BGSOD, the IMOD can directly detect the wanted objects from a single image, which also simplifies the framework. According to the structure of the framework, BGSOD and IMOD have their own advantages and disadvantages. Since BGSOD takes more video frames for calculation frames' motion, the BGSOD is generally sensitive to moving objects even without sufficient training datasets. Therefore, BGSOD is widely used in many industrial applications such as traffic monitoring and visual surveillance of human activities. However, BGSOD may also cause numerous false detections without proper settings. In contrast, IMOD is usually more precise than BGSOD empowered by deep learning techniques. However, IMOD usually requires numerous training datasets to reach a satisfactory detection performance. Meanwhile, some empirical reports indicate the lack of generalization of IMOD. Thus, several recent studies start integrating BGSOD and IMOD as a motion-aware object detection (MAOD), which combines their advantages to achieve balanced performance.

BGS is an intuitive way to refine the foregrounds according to the differences between consecutive video frames, which also reflects the object motion in frames. According to the nature of algorithms, BGS methods can be categorized into three groups: statistical models, robust subspace, and deep learning.

The statistical models adopt several statistical concepts to accurately separate backgrounds and foregrounds, such as clustering and support vector machines (SVM). For example, C. Stauffer and W. Grimson, “Adaptive background mixture models for real-time tracking,” in Proceedings. 1999 IEEE Computer Society Conference on Computer Vision and Pattern Recognition (Cat. No PR00149), Fort Collins, CO, USA, June 1999 employs a Gaussian Mixture Model (GMM) to accurately estimate the foregrounds. Then, J. Wang, G. Bebis, and R. Miller, “Robust video-based surveillance by integrating target detection with tracking,” in 2006 Conference on Computer Vision and Pattern Recognition Workshop (CVPRW '06), 2006, pp. 137-137 further introduced the support vector machine (SVM) to enhance the quality of estimating foregrounds. Inspired by previous works [Stauffer and Wang], ViBE is proposed to dynamically substitute the background pixels based on the propagation of neighborhood foreground pixels [O. Barnich and M. V. Droogenbroeck, “ViBe: A universal background subtraction algorithm for video sequences,” IEEE Transactions on Image Processing, vol. 20, no. 6, pp. 1709-1724, June 2011]. Then, M. Hofmann, P. Tiefenbacher, and G. Rigoll, “Background segmentation with feedback: The pixel-based adaptive segmenter,” in 2012 IEEE Computer Society Conference on Computer Vision and Pattern Recognition Workshops, Providence, RI, June 2012, pp. 38-43 evolves the ViBE with learning parameters to decrease the false detection rate. Moreover, SuBSENSE [P.-L. St-Charles, G.-A. Bilodeau, and R. Bergevin, “SuBSENSE: A universal change detection method with local adaptive sensitivity,” IEEE Transactions on Image Processing, vol. 24, no. 1, pp. 359-373, January 2015] and WeSamBE [S. Jiang and X. Lu, “WeSamBE: A weight-sample-based method for background subtraction,” IEEE Transactions on Circuits and Systems for Video Technology, vol. 28, no. 9, pp. 2105-2115, September 2018] are proposed to further improve the accuracy by adding more learnable parameters to dynamically adjust the background and foreground pixels.

Robust subspace methods aim to decompose foreground and background from the image as the matrix or high dimensional tensor through convex or stochastic optimization. Compared with statistical models, robust subspace methods are more convenient to adapt to different environments by modifying objective functions. For example, stable principal component pursuit (SPCP) includes an [symbol] ₁ norm and nuclear norm for robust performance in the presence of a dynamic background. However, SPCP requires updating the background in a batch manner, which makes it inefficient for video streaming. Thus, the Grassmannian Robust Adaptive Subspace Tracking Algorithm (GRASTA) was proposed [Jun He and Laura Balzano and John C. S. Lui, “Online Robust Subspace Tracking from Partial Information”, arXiv preprint arXiv:1109.3827, 2011] to pursue asub-optimal solution that allows decomposition to be achieved in an online manner. J. Feng et al employs an online stochastic optimization method that can better trace the solution for accurate foregrounds. Meanwhile, robust subspace methods are flexible to fit into different kinds of signals and computer vision algorithms. For example, OSTD [A. Sobral, S. Javed, S. K. Jung, T. Bouwmans, and E. hadi Zahzah, “Online stochastic tensor decomposition for background subtraction in multispectral video sequences,” in 2015 IEEE International Conference on Computer Vision Workshop (ICCVW), Santiago, December 2015, pp. 946-953] extends the work of Feng et al [Feng, H. Xu, and S. Yan, “Online robust pca via stochastic optimization,” in Advances in Neural Information Processing Systems 26, 2013, pp. 404-412] to fit for multispectral videos. GraphBGS [J. H. Giraldo, S. Javed, and T. Bouwmans, “Graph moving object segmentation,” IEEE Transactions on Pattern Analysis and Machine Intelligence, vol. 44, no. 5, pp. 2485-2503, 2022] combines graph signal processing, robust subspace and various computer vision techniques to maximize the performance of BGS in complex scenes.

Recent advances also apply deep learning methods under supervised training schemes in BGS. Although the supervised deep learning methods show their novelty even in complex scenarios, these supervised methods are too scene-specific to adapt in different environments after extensive reviews and experiments. For addressing the problem of generalization, unsupervised deep learning models have been developed using BGS. Besides, recent publication M. O. Tezcan, P. Ishwar, and J. Konrad, “BSUV-net: A fully-convolutional neural network for background subtraction of unseen videos,” in 2020 IEEE Winter Conference on Applications of Computer Vision (WACV), March 2020 includes the Jaccard index to train a generalized UNet model for unseen videos. However, comparative studies still indicate that the robustness deep learning methods have room to improve in BGS applications.

BGS can unveil the regions of wanted objects, the next step is classifying the objects to detect. Therefore, a classifier is demanded to recognize the types of objects in perceived regions of images. At the early development of classifiers, handcrafted feature extraction techniques were required to describe the object such as Scale-Invariant Feature Transform (SIFT) and Histograms of Oriented Gradients (HOG). Then, the extracted features are fed into classifiers for final detection. The conventional classifiers include support vector machine (SVM), random forest (RF), and AdaBoost. However, these classifiers rely on the quality of extracted hand-crafted features. If the feature engineering is not well conducted, the classification robustness can be significantly damaged, resulting in poor detection performance. In this regard, a deep neural network (DNN) is introduced to learn the complex representations directly from the image, which significantly improves the robustness compared with conventional classifiers. A convolution neural network (CNN) is a type of DNN that fits high dimensional signals such as images and matrices. A CNN can be regarded as a parameterized convolution filter comprising many layers. And, each layer contains feature maps to describe the objects. A deeper CNN that has more layers increases the capacity of classification. For example, AlexNet is the first landmark design of CNN that won the championship in ILSVRC-2012 competition. Then, ResNet added a skip connection to form a very deep CNN to improve the classification performance. However, some features may be redundant in a CNN. Inspired by humans' vision attention, recent studies apply such mechanism to enable CNNs to effectively concentrate on the salient regions, which improves the classification accuracy. J. Wang, L. P. Tchapmi, A. P. Ravikumar, M. McGuire, C. S. Bell, D. Zimmerle, S. Savarese, and A. R. Brandt, “Machine vision for natural gas methane emissions detection using an infrared camera,” Applied Energy, vol. 257, p. 113998, January 2020 combine GMM as BGS and a custom-designed CNN to detect gas leaks in petrochemical industries.

Image-based object detection (IMOD) is a data-driven technique to detect objects from surveillance cameras. Unlike BGSOD, IMOD is capable of localizing and classifying objects directly from a single image. In this regard, IMOD does not rely on the motion information between video frames but prior knowledge learned from large-scale dataset. After entering the era of deep learning, recent IMOD frameworks are typically developed based on DNNs due to their superiority of detection performance. According to the nature of IMOD, IMOD detectors can be categorized into two groups, i.e. one-stage and two-stage detectors as illustrated in FIG. 18.

The two-stage detector is comprised of a backbone, a region proposal network (RPN), a region of interest (ROI) pooling layer and a small DNN as head. The backbone or primary neural network extracts the abstracted features from the input frame. Then, the extracted features are conveyed to the RPN to generate coarse proposals (or anchors) to roughly localize the possible ROI with objects. Then, ROI pooling layer crops the features in the proposals. Finally, the head will localize and classify the objects from the features. R. Girshick, “Fast r-cnn,” in 2015 IEEE International Conference on Computer Vision (ICCV), 2015, pp. 1440-1448 proposed the first landmark two-stage detector, namely Fast RCNN. Compared with the best traditional object detection framework, deformable part model (DPM), Fast RCNN significantly increases scores of average precision from 33.7 to 70.0 in the PASCAL Visual Object Classes Challenge 2007 (VOC 2007) test set. However, Fast RCNN employs a selective search algorithm to generate proposals that also severely reduce the computational speed. Then, S. Ren, K. He, R. Girshick, and J. Sun, “Faster r-cnn: Towards real-time object detection with region proposal networks,” IEEE Transactions on Pattern Analysis and Machine Intelligence, vol. 39, no. 6, pp. 1137-1149, 2017 proposed a Faster RCNN to achieve near-real-time object detection from a single image. The main contribution of Faster RCNN is replacing the slow selective search algorithm by a specific design of DNN, i.e. a region proposal network (RPN). However, if the objects are either small or large enough, the Faster RCNN may miss the detection because it runs on a single-scale feature map at the last layer of the backbone. In this regard, T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017 proposed a feature pyramid network (FPN) that enables the original Faster RCNN to leverage features of various scales. The FPN detector achieved great advances in famous public COCO dataset. The FPN detector became the fundamental framework for many variations of the two-stage detectors. And, it has been applied to detect objects such as pedestrians, vehicles, and gas leaks (J. Shi, Y. Chang, C. Xu, F. Khan, G. Chen, and C. Li, “Real-time leak detection using an infrared camera and faster R-CNN technique,” Computers & Chemical Engineering, vol. 135, p. 106780, 2020.).

The two-stage detectors follow the coarse-to-fine process, which can indeed gain the possibility of detecting objects. Nonetheless, it also reduces computational efficiency. Thus, the one-stage detectors remove the RPN but directly detect the objects from the extracted features from the backbone. J. Redmon, S. Divvala, R. Girshick, and A. Farhadi, “You only look once: Unified, real-time object detection,” in 2016 IEEE Conference on Computer Vision and Pattern Recognition (CVPR), 2016, pp. 779-788 proposed a one-stage detector, i.e. YOLO, that can run over 100 frames per second (FPS). Although YOLO is indeed the fastest detector, the detection performance id much degraded especially for small objects [Z. Zou, K. Chen, Z. Shi, Y. Guo, and J. Ye, “Object detection in 20 years: A survey,” Proceedings of the IEEE, vol. 111, no. 3, pp. 257-276, 2023]. Thus, a single-shot multibox detector (SSD) was proposed to introduce multiscale detection techniques, which greatly improves the detection accuracy in small objects [W. Liu, D. Anguelov, D. Erhan, C. Szegedy, S. Reed, C.-Y. Fu, and A. C. Berg, “SSD: Single shot MultiBox detector,” in Computer Vision—ECCV 2016. Springer International Publishing, 2016, pp. 21-37]. Inspired by SSD, T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017 further proposes a landmark multi-scale detector, i.e. RetinaNet, which achieves balance detection accuracy and inference speed. Specifically, the RetinaNet introduces a new loss function, namely focal loss, to balance the foreground and background in the training process. Despite the great success of IMOD in computer vision tasks, an IMOD framework needs to be fully trained from a large-scale annotated dataset before deployment. If an IMOD framework is not fully trained, it lacks generalization to detect critical objects or events in fields. Besides, the annotated dataset is usually limited with respect to petrochemical industries. Thus, few studies have implemented IMOD to detect ethane or natural gas leaks.

Thus, BGSOD is generalized and sensitive to detect objects based on motion between video frames, while IMOD can have precise detection empowered by sufficient training datasets. The integration of BGSOD and IMOD has become an emerging solution to detect objects from surveillance cameras. C. Kim, J. Lee, T. Han, and Y.-M. Kim, “A hybrid framework combining background subtraction and deep neural networks for rapid person detection,” Journal of Big Data, vol. 5, no. 1, July 2018 directly combine BGS as a proposal generator and YOLO as a fine object detector for person detection from surveillance cameras. Compared with pure YOLO solution, the integration can achieve improved detection accuracy. Moreover, Z. Fu, Y. Chen, H. Yong, R. Jiang, L. Zhang, and X. Hua, “Foreground gating and background refining network for surveillance object detection,” IEEE Transactions on Image Processing, vol. 28, no. 12, pp. 6077-6090, December 2019 introduces a two-stage detector, FBGR, to better integrate the motion information and image features from BGS and backbones. Specifically, it employs two individual backbones to extract features from background-subtracted frames of BGS and the original frame through a new foreground gated network. The experimental results demonstrate its novelty in the well-known UA-DETRAC benchmark for traffic monitoring from surveillance cameras. Moreover, H. Perreault, G.-A. Bilodeau, N. Saunier, and M. Heritier, “SpotNet: Self-attention multi-task network for object detection,” in 2020 17^{th} Conference on Computer and Robot Vision (CRV), May 2020 proposed a faster solution based on the one-stage detector and a background subtraction algorithm known as Pixel-based Adaptive Word Consensus Segmenter (PAWCS). This also achieved comparable performance in the UA-DETRAC benchmark. However, a direct combination of BGSOD and IMOD is not efficient in both the training and inference phases. Thus, few studies embed the BGS to IMOD frameworks by comparing extracted features from backbones. S. Beery, G. Wu, V. Rathod, R. Votel, and J. Huang, “Context r-cnn: Long term temporal context for per-camera object detection,” in 2020 IEEE/CVF Conference on Computer Vision and Pattern Recognition (CVPR), 2020, pp. 13072-13082 proposed a complicated context RCNN to achieve BGS in Faster RCNN by applying a non-local network. To improve computational efficiency, L. Wang, Z. Tong, B. Ji, and G. Wu, “TDN: Temporal difference networks for efficient action recognition,” in 2021 IEEE/CVF Conference on Computer Vision and Pattern Recognition (CVPR). IEEE, June 2021 proposed a temporal difference network (TDN) that directly subtracts the features of video frames. For ethane leak detection, K. Zhou, Y. Wang, T. Lv, Y. Li, L. Chen, Q. Shen, and X. Cao, “Explore spatio-temporal aggregation for insubstantial object detection: Benchmark dataset and baseline,” in 2022 IEEE/CVF Conference on Computer Vision and Pattern Recognition (CVPR). IEEE, June 2022 proposed the first motion-aware object detection framework, namely IOD, which is inspired by temporal enhancement and the aggregation (TEA) network. Beyond IOD, there are no relevant studies conducted on the application of ethane or gas leak detection.

With the rapid development in sensory technologies, recent visual surveillance devices have started combining more optical sensors such as VI and IR cameras to achieve robust perception under challenging illumination conditions. For example, Palmero et al., “Multi-modal rgb-depth-thermal human body segmentation,” International Journal of Computer Vision, vol. 118, no. 2, pp. 217-239, 2016, integrates visible (VI) and IR fixed cameras to monitor human activities. Meanwhile, several computer vision algorithms are developed to achieve AVS from such multimodal imaging devices. For example, Sobral et al., “Online stochastic tensor decomposition for background subtraction in multispectral video sequences,” in 2015 IEEE International Conference on Computer Vision Workshop (ICCVW), Santiago, December 2015, pp. 946-953, proposed a BGS method to detect moving objects from multimodal imaging devices. In the petrochemical industries, surveillance multimodal imaging cameras, including VI and IR cameras, are deployed to let engineers manually monitor if there are intrusive objects, such as humans and animals, around ethane pipelines or other facilities. However, there is no study on using multimodal imaging for ethane leak detection. Turning to ethane leaks in VI imaging, ethane is colorless, and therefore, VI cameras cannot directly visualize the ethane leaks as an object as in IR images. However, ethane is converted into liquid form under a low temperature and high-pressure environment for transportation and storage. When an ethane leak occurs, as shown in FIG. 3, the liquefied ethane rapidly gasifies and escapes from the pipelines or facilities. The cold ethane contacts with warmer air resulting in moist vapors condensing as mist around the cold sources, as shown in FIG. 3. The mist can be perceived by VI cameras, and VI cameras can distinguish it from background objects due to the rich semantic information of VI imagery. However, pure VI-based ethane leak detection is unreliable, especially in outdoor environments. The mist is too similar to fog, snow, and other climate phenomena. Without the additional temperature information from IR imaging, pure VI-based surveillance cannot explicitly determine whether a leak is occurring. In this regard, multimodal imaging is favorable for perceiving the ethane as a mixture of vapor and cold sources, as shown in FIG. 3. The information fusion from VI and IR imaging can contribute to the precision of ethane leak detection. Nonetheless, no studies have yet been attempted on information fusion techniques to achieve AVS for ethane leak detection from multimodal surveillance cameras.

Meanwhile, the VI and IR surveillance cameras are usually unaligned at the pixel level due to different physical characteristics, while advanced VI-IR fusion techniques require pre-aligned image pairs. The registration or alignment of the VI-IR images is typically a prerequisite to information fusion, while it is also an emerging topic in multimodal surveillance imaging. In the event that the VI and IR images are already aligned, a further registration step is not required. With aligned VI-IR image pairs, the information fusion techniques can be implemented to fuse the VI and IR information for final object detection from surveillance multimodal imaging devices.

VI and IR cameras can be aligned at pixel level through manual hardware calibration. Nonetheless, multimodal imaging may be unaligned by camera jitters. The image registration algorithms are required to re-align VI and IR images to maintain the systematic functions after camera jitters.

Registration algorithms can be categorized into three groups, i.e. 1) feature-based registration, 2) intensity-based registration, and 3) transform-based registration. In multimodal imaging with infrared cameras, there are two groups of the technology, i.e. Near-infrared (NIR) and thermal (long-wavelength infrared or mid-wavelength infrared) as shown in FIG. 18. The electromagnetic spectrum of NIR images typically ranges from 0.75 μm to 1.4 μm while of thermal ranges beyond 3 μm. The NIR is not capable of visualizing the ethane leaks. Unlike the NIR, thermal imaging can perceive the radiation from objects that reflects the ambient temperatures, which can also be implemented to visualize ethane leaks. Compared with NIR, multimodal imaging has much less chance to miss objects such as human and vehicles during challenging illumination conditions with the thermal modality. In contrast to NIR, the similarity between VI-T images textures are much less than VI-NIR images which limits the full alignment. In this regard, The VI-T imaging devices are usually pre-calibrated with a checkerboard before deployment at hardware-level, which is a time-consuming process. Meanwhile, due to device jitters or alternation, the VI-T images can be misaligned again in practical scenarios. Therefore, registration methods in software-level are required to align the VI-T images in an efficient and convenient manner without hardware recalibration. The software-level methods can be categorized into three groups, i.e. feature-based, intensity-based and transform-based registration.

Feature-based methods extract and match the semantic structures of similar features such as corner points and lines between VI-T images. Thus, a homography matrix can be derived based on the found matches. Conventional handcrafted features such as Scale-Invariant Feature Transform (SIFT) and Oriented FAST and Rotated BRIEF (ORB) are successfully implemented to the images registration under visible domain. Turning to VI-T images, features-based methods suffer from finding the matched patterns due to modality difference. To align the VI-T images, Zhao et al. and Zeng et al. apply the detectors on edge maps which improves the registration quality. With advances in machine learning, learning-based features are thriving in the research community. Sarlin et al. adopt a graph neural network to find matched points. Sun et al. evolved the framework of Sarlin et al. through implementing a Local Feature Transformer (LoFTR). The LoFTR sets a new state-of-the-art even on multimodal images. Despite the success of learning-based techniques, such methods requires a long pre-training process on numerous images to achieve the acceptable performance, which prevents them from deploying on practical scenarios.

Intensity-based methods focus on designing a suitable objective function to quantify the difference (or gradient difference) between images to solve the affine parameters through minimizing or maximizing the function. Compared with feature-based methods, intensity-based methods are generally implemented in practical scenarios due to their robustness and precision. Mutual Information (MI) and its variants are designed to register the VI-T images based on their joint entropy. In practical implementation, MI usually suffers from difficulty in convergence which limits the calculation of optimal affine parameters. Angular and linear distances have a smoother path in derivatives increasing the registration accuracy. The Normalized Total Gradient (NTG) and Normalized Cross Correlation (NCC) achieved success in registration of VI-T images and other types of multimodal images. For example, Ying et al. modifies the NTG to successfully align the hyperspectral images from satellites. A further method of registration, MOIR (discussed below) is inspired by the above methods, but it considers both angular and linear distance for better registration. The optimization process is also re-designed with the RSGD.

Transform-based methods aim to project VI-T images to a common representations or latent spaces which enables classical measurements such as sum of absolute difference (SAD) for multimodal image registration. For example, Kim et al. proposed a landmark framework, i.e. dense adaptive self-correlation, to project VI-T images on self-similarity domain for alignment. Entering to the era of deep learning, Jeong et al. proposed a cross-spectral correspondence network to learn the representations of VI-T images on a latent space through generative adversarial network. Another similar method is Neural Multimodal Adversarial Registration (NEMAR) which align VI-T images after bi-directional image translation between modalities. Although the CSCNet and NEMAR are promising in the multimodal image registration, the stability is a non-negligible concern due to the black-box modeling. Cao et al. unveils the instability of the CSCNet and proposes a SCB method which achieves balanced performance on multispectral images. Compared with these methods, the MOIR method discussed below simply transforms the original images to gradients for measurement, which is low-complexity and robust.

Once the VI and IR cameras are aligned, information fusion techniques can be applied to combine the information from different modalities for computer vision tasks such as salient object detection, vehicle detection and traffic monitoring. According to the nature of information fusion, the methods of information fusion can be categorized into three groups: 1) image-level fusion, 2) decision-level fusion, and 3) feature-level fusion, which are presented in FIG. 19.

Image-level fusion aims to combine the information from images of various modalities such as VI and IR, resulting in fused images with enhanced textures and colors. Before the introduction of deep learning methods, image fusion methods were established based on statistical analysis in the spatial or frequency domains. For example, K. He, J. Sun, and X. Tang, “Guided image filtering,” IEEE Transactions on Pattern Analysis and Machine Intelligence, vol. 35, no. 6, pp. 1397-1409, 2013 proposed a guided image filter to fuse different images through spatial and range kernels. S. Yu and X. Chen, “Infrared and visible image fusion based on a latent low-rank representation nested with multiscale geometric transform,” IEEE Access, vol. 8, pp. 110 214-110 226, 2020 utilize matrix factorization to fuse images by manipulating the extracted sub-bands in the spatial domain. Liu et al. proposed a dictionary learning method to fuse the factorized coefficients based on multi-scale transform. After entering the era of deep learning, many specific DNNs were proposed to fuse the different kinds of images. H. Li and X.-J. Wu, “Densefuse: A fusion approach to infrared and visible images,” IEEE Transactions on Image Processing, vol. 28, no. 5, pp. 2614-2623, 2019 integrates a famous DNN for feature extraction, i.e. G. Huang, Z. Liu, L. Van Der Maaten, and K. Q. Weinberger, “Densely connected convolutional networks,” in 2017 IEEE Conference on Computer Vision and Pattern Recognition (CVPR), 2017, pp. 2261-2269 and [symbol] ₁-norm to fuse the features for ultimate fusion, resulting in much improvement over traditional methods. Then, H. Xu, J. Ma, J. Jiang, X. Guo, and H. Ling, “U2fusion: A unified unsupervised image fusion network,” IEEE Transactions on Pattern Analysis and Machine Intelligence, vol. 44, no. 1, pp. 502-518, 2022 was proposed to evolve the DenseFuse with elastic weight consolidation and advanced information measurement. After the image fusion, the detector can be applied to the fused image to detect objects as illustrated in FIG. 19 part (a). Several studies indicate the improvement of detection performance brought by image-level fusion. For instance, S. Papson and R. M. Narayanan, “Multiple location sar/isar image fusion for enhanced characterization of targets,” in Radar Sensor Technology IX, R. N. Trebits and J. L. Kurtz, Eds. SPIE, may 2005 merge various images to enhance object detection via a DNN. Although image-level fusion can improve image quality, it makes the framework inflexible. If there are more training data, both detectors and fusion algorithm may need to be re-trained in order. Meanwhile, the visual quality of composite images after image fusion is not directly related to the detection performance. In this regard, image-level fusion became less popular in object detection applications from multimodal imaging devices.

Decision-level fusion combines the generated proposals from detectors of different domains, as presented in FIG. 19 part (b). Compared with image-level fusion, it has higher flexibility and modality. If a new modality is employed in the object detection framework, only the detector of the specific domain needs to be trained. Conventional decision-level fusion is achieved by mathematical operations such as weighted summation. Inspired by modern machine learning, several studies apply concepts of machine learning to achieve decision fusion. For example, A. Vilhelm, M. Limbert, C. Audebert, and T. Ceillier, “Ensemble learning techniques for object detection in high-resolution satellite images,” CORR, February 2022 introduce the concept of bagging from machine learning to combine the proposals from multiple small detectors. Y.-T. Chen, J. Shi, Z. Ye, C. Mertz, D. Ramanan, and S. Kong, “Multimodal object detection via probabilistic ensembling,” in Lecture Notes in Computer Science. Springer Nature Switzerland, 2022, pp. 139-158 further introduce the probabilistic modeling to integrate the proposals from VI and IR detectors. However, decision-level fusion suffers high computational costs due to the deployment of uni-modal detectors. Meanwhile, the detection performance is usually not comparable to feature-level fusion.

Feature-level fusion is a compromise between image-level and decision-level fusion. It combines features from different modalities for object detection, as shown in FIG. 19. Compared with the aforementioned two groups, feature-level fusion has flexibility in training and better detection performance, making itself the most prevalent way of fusion in applications of object detection. After entering the era of deep learning, CNNs have become the dominating method to fuse the features from VI, and IR images. For example, S. W. Jingjing Liu, Shaoting Zhang and D. Metaxas, “Multispectral deep neural networks for pedestrian detection,” in Proceedings of the British Machine Vision Conference (BMVC), September 2016, pp. 73.1-73.13 investigates different kinds of fusion architectures at the feature-level for pedestrian detection with VI and IR images. At this stage, the implemented fusion operator was still a simple convolution layer which has difficulty adaptively finding the crucial regions of features to fuse for improved detection performance. Inspired by human perception, vision attention mechanisms were adopted to fuse the semantic features dynamically and compute the weights between different modalities. L. Zhang, Z. Liu, S. Zhang, X. Yang, H. Qiao, K. Huang, and A. Hussain, “Cross-modality interactive attention network for multispectral pedestrian detection,” Information Fusion, vol. 50, pp. 20-29, October 2019 initially introduced an intuitive channel attention network to re-calibrate the weights between VI and IR features. Compared with conventional CNN-based methods, the improvement is significant on multi-modal pedestrian detection. L. Ding, Y. Wang, R. Lagani'ere, D. Huang, X. Luo, and H. Zhang, “A robust and fast multispectral pedestrian detection deep network,” Knowledge-Based Systems, vol. 227, p. 106990, September 2021 further introduce the selective kernel convolution to draw attention based on multiple kernels of different size, enhancing spatial axes' features. Furthermore, X. Wang, R. Girshick, A. Gupta, and K. He, “Non-local neural networks,” in 2018 IEEE/CVF Conference on Computer Vision and Pattern Recognition, June 2018 introduce the matrix multiplication to derive stronger attention in a global manner, resulting in an outstanding performance from surveillance multimodal devices. This kind of mechanism is called self-attention. Inspired by Wang, Dosovitsky et al. (A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22) used serial self-attention blocks to demonstrate the promising upper bounds of modeling in object classification. Similar to object classification, the self-attention (matrix production) methods contribute quality of information fusion in a global manner. L. Chi, G. Tian, Y. Mu, and Q. Tian, “Two-stream video classification with cross-modality attention,” in 2019 IEEE/CVF International Conference on Computer Vision Workshop (ICCVW), 2019, pp. 4511-4520 revise the non-local network (Wang) to draw attention from co-variate analysis between VI and IR features through matrix production. A. Prakash, K. Chitta, and A. Geiger, “Multi-modal fusion transformer for end-to-end autonomous driving,” in 2021 IEEE/CVF Conference on Computer Vision and Pattern Recognition (CVPR), June 2021, pp. 7073-7083 replace the non-local network with a combination of self-attention and MLP, which achieves astonishing object detection accuracy from LiDAR and VI information. F. Qingyun, H. Dapeng, and W. Zhaokui, “Cross-modality fusion transformer for multispectral object detection,” arXiv preprint arXiv:2111.00273, 2021 embeds the self-attention in an object detection framework, namely a cross-modality transformer, to fuse the VI and IR features for pedestrian detection, resulting in a promising detection accuracy on three public benchmarks. However, the large memory occupation of self-attention arouses concerns in industrial deployment. Meanwhile, there are no studies about applying information fusion techniques to ethane (or gas) leak detection.

Current leakage detection systems mainly employ gas sensory technology or visual surveillance. The gas sensors aim to extract the concentration of the ethane inside the pipeline. On the other hand, with advances in IR imaging technology, visual surveillance is becoming capable and less expensive to protect high-risk areas from leakage. Due to the self-radiation and spectrum characteristics of the natural gas, mid-wave infrared (MWIR) and long-wave infrared (LWIR) sensors can capture the region of leakage well. In contrast to gas sensors, engineers can intuitively perceive the ethane leakage by observing the video from an IR surveillance or fixed camera, which is also more convenient for engineers to check whether it is a false alarm. Recent visual surveillance frameworks usually consist of two major steps:
1. Background subtraction stage. Implementing Background Subtraction (BGS) algorithms to obtain the foreground regions of potential ethane leaks based on the motion information between video frames of an IR surveillance camera.
2. Leakage refinement stage. Classifying the regions of interest in the foreground image extracted by BGS to determine if ethane leakage occurs.

In the BGS stage, existing frameworks implement visual background extractor (ViBE) to extract the mask of ethane leakage in the stationary background, such as plain ground or clear sky [Wang, L. P. Tchapmi, A. P. Ravikumar, M. McGuire, C. S. Bell, D. Zimmerle, S. Savarese, and A. R. Brandt, “Machine vision for natural gas methane emissions detection using an infrared camera,” Applied Energy, vol. 257, p. 113998, January 2020, L. Huang and X. Zeng, “Gas leak detection in infrared video with background modeling,” in MIPPR 2017. Remote Sensing Image Processing, Geographic Information Systems, and Other Applications, Xiangyang, China, March 2018, S. Hong, Y. Hu, and H. Yu, “A VOCs gas detection algorithm based on infrared thermal imaging,” in 2019 Chinese Control And Decision Conference (CCDC), Nanchang, China, June 2019]. However, many ethane pipelines are located in rural areas, which have dynamic backgrounds such as grassland, forest, etc. The dynamic background can deteriorate the performance of BGS. There has been a lack of investigation to validate the feasibility of BGS for ethane leakage with such a dynamic background. When applying the recent advances of BGS in the rural area, the recent methods have two limitations for segmenting the ethane leakage. A comparison of labels and generated masks of O. Barnich and M. V. Droogenbroeck, “ViBe: A universal background subtraction algorithm for video sequences,” IEEE Transactions on Image Processing, vol. 20, no. 6, pp. 1709-1724, June 2011 at the t-th and (t+N)-th frames was considered when the leakage occurs at 20 meters. First, compared with the labels at the t-th frame, the mask of ViBE is too small to cover the whole area of leakage foreground. The result suggests that the recent BGS methods lack sensitivity to discover the intact gas leakage foreground. Second, to achieve good segmentation performance, the contemporary background models usually update the background along with video streaming. However, the update mechanism may also filter out the gas leakage foreground. ViBE can not perceive the leakage foreground after N frames while ethane is still emitting.

At the leakage refinement stage, contemporary frameworks of ethane leakage detection use pre-defined thresholds to classify the regions of leakage [Huang, Hong]. These pre-defined methods are designed based on the characteristics of connected components inside the foreground mask from BGS. However, these thresholding methods are not adaptive in complex environments such as rural areas. Inspired by advances in computer vision, J. Wang, L. P. Tchapmi, A. P. Ravikumar, M. McGuire, C. S. Bell, D. Zimmerle, S. Savarese, and A. R. Brandt, “Machine vision for natural gas methane emissions detection using an infrared camera,” Applied Energy, vol. 257, p. 113998, January 2020 proposed a leakage classification method, GasNet, to implement a Convolution Neural Network (CNN) for adaptive detection at this stage. However, BGS is generally sensitive to moving objects such as people and vehicles in industrial infrastructures. Pure classification on such extracted foregrounds increases the false detection rate even with deep classifiers. In this regard, J. Shi, Y. Chang, C. Xu, F. Khan, G. Chen, and C. Li, “Real-time leak detection using an infrared camera and faster r-cnn technique,” Computers & Chemical Engineering, vol. 135, p. 106780, 2020 introduced the landmark deep learning-based detector, namely Faster Region-based Neural Network (Faster RCNN) Z.-Q. Zhao, P. Zheng, S.-T. Xu, and X. Wu, “Object detection with deep learning: A review,” IEEE Transactions on Neural Networks and Learning Systems, vol. 30, no. 11, pp. 3212-3232, 2019, to precisely localize and classify natural gas leaks from original IR images without BGS. However, the sensitivity and robustness may be degraded without sufficient training datasets compared with conventional BGS-based frameworks. Therefore, an integrated framework of BGS and deep learning-based detectors is desired to achieve a balanced performance for ethane leak detection from fixed IR imaging devices. Nonetheless, such an integrated framework is still missing in visual surveillance for gas leaks in petrochemical industries.

Thus, an experimental environment is constructed to collect ethane leakage videos in rural area with respect to different distances between the camera and emitter.

### SUMMARY

There is disclosed a method of detecting leaks of a chilled or pressurized fluid in a potential leakage area based on a sequence of infrared (IR) images of the potential leakage area, and a sequence of visual (VI) images of the potential leakage area. For plural time steps of a sequence of time steps each corresponding to a respective IR image and a respective VI image, the following steps may be carried out: first, using an IR backbone neural network, extracting IR image-level features from the respective IR image, and likewise, using a VI backbone neural network, extracting VI image-level features from the respective VI image; second, comparing the IR image-level features with other IR image-level features extracted from one or more other IR images corresponding to different time steps of the sequence of time steps than the time step corresponding to the respective IR image and the respective VI image to obtain IR motion-enhanced features, and likewise comparing the VI image-level features with other VI image-level features extracted from one or more other VI images corresponding to the different time steps of the sequence of time steps to obtain VI motion-enhanced features; third, comparing the IR motion-enhanced features with the VI motion-enhanced features to obtain fused features; and fourth, generating a detection output indicating a presence and a location of a leak of the chilled or pressurized fluid based on the fused features.

The IR backbone neural network and the VI backbone neural network may each include multiple stages, the IR image-level features and the VI image-level features including outputs from plural of the multiple stages. The steps of comparing the IR image-level features to obtain IR motion-enhanced features, comparing the VI image-level features to obtain VI motion-enhanced VI features, and comparing the IR motion-enhanced features with the VI motion-enhanced features to obtain fused features may then be carried out on the outputs from the plural stages to obtain the fused features as stage-specific fused features for each of the plural stages, so that the step of generating the detection output indicating the presence and the location of the leak of the chilled or pressurized fluid based on the fused features may comprise comparing the stage-specific fused features from the plural stages. In embodiments with multiple stages, there may be included any one or more of the following features: comparing the stage-specific fused features may include obtaining stage-specific processed features based on the stage-specific fused features, the stage-specific processed features at a stage corresponding to more detailed features including upsampled information from another stage corresponding to less detailed features. In the step of generating the detection output, for each stage a respective initial detection output may be generated, and the detection output may be generated based on the respective initial detection outputs, or the detection output may be one of the respective initial detection outputs and may be based directly or indirectly on the other respective initial detection outputs. The respective initial detection outputs may be generated using a coarse proposal network to generate coarse proposals, and a refining network may be used to generate the initial detection outputs from features in the coarse proposals. The features in the coarse proposals may be extracted via an RoIAlign layer to provide input to the refining network. The respective initial detection outputs may be generated using a presence network to generate presence outputs indicating the presence of the leak, and a location network to generate location outputs indicating the location of the leak.

In any of the above embodiments, including embodiments without multiple stages, there may be included any one or more of the following features: the IR backbone neural network and the VI backbone neural network may have identical structure. The IR backbone neural network and the VI backbone neural network may have identical weights.

The step of comparing the IR image-level features with the other IR image-level features to obtain the IR motion-enhanced features may be carried out using an IR subtraction network to obtain IR motion-extracted features, and then applying a temporal aggregation IR network to the IR motion-extracted features to obtain the IR motion-enhanced features, and likewise the step of comparing the VI image-level features with the other VI image-level features to the obtain VI motion-enhanced features may be carried out using a VI subtraction network to obtain VI motion-extracted VI features, and then applying a temporal aggregation VI network to the VI motion-extracted features to obtain the VI motion-enhanced features. The IR subtraction network may include an IR attention mechanism to dynamically adjust contributions of different spatial IR features of the IR image-level features to the IR motion-extracted features, and likewise the VI subtraction network may include a VI attention mechanism to dynamically adjust contributions of different spatial VI features of the VI image-level features to the VI motion-extracted features. The temporal aggregation VI network may include a 2-dimensional VI convolution network, and likewise the temporal aggregation IR network may include a 2-dimension IR convolution network. The IR subtraction network may have identical structure to the VI subtraction network, and likewise the temporal aggregation IR network may have identical structure to the temporal aggregation VI network. The step of comparing the IR motion-enhanced features with the VI motion-enhanced features to obtain fused features may be carried out by a multimodal fusion network comprising a 2-dimensional convolution network. The step of comparing the IR motion-enhanced features with the VI motion-enhanced features to obtain fused features may be carried out by a multimodal fusion module that includes a discrete Fourier transform to generate frequency domain features, a neural network connected to receive the frequency domain features to generate frequency domain outputs, and an inverse Fourier transform applied to the frequency domain outputs. The architecture may be trained end-to-end. For example, the end-to-end training may include the IR backbone neural network, the VI backbone neural network, and every neural network used in the steps of comparing the IR image-level features with the other IR image-level features to obtain the IR motion-enhanced features, comparing the VI image-level features with the other VI image-level features to obtain the VI motion-enhanced features, comparing the motion-enhanced IR features with the motion-enhanced VI features to obtain the fused features, and generating the detection output indicating the presence and the location of the leak of the chilled or pressurized fluid based on the fused features. The chilled or pressurized fluid may comprise, for example, ethane, methane, propane, butane or CO₂. Before the steps of extracting the IR image level features and extracting the VI image-level features, the respective IR image and the respective VI image may be registered together to relatively align the respective IR image and the respective VI image.

There is disclosed a system for detecting leaks of a chilled or pressurized fluid, comprising a computer, an infrared camera oriented to view an area of potential leakage of the chilled or pressurized fluid, the infrared camera being wiredly or wirelessly connected to send infrared images to the computer, a visual camera oriented to view the area of potential leakage of the chilled or pressurized fluid, the visual camera being wiredly or wirelessly connected to send visual images to the computer, the computer including a memory containing instructions to cause the computer to carry out the steps of any one of the described method embodiments.

There is disclosed a method of training a model for detecting leaks of a chilled or pressurized fluid using video infrared (IR) and video visual (VI) data, the method comprising the steps of supplying an IR neural network, supplying a VI neural network, supplying a combined neural network, supplying the video IR data to the IR neural network to generate IR feature outputs, supplying the video VI data to the VI neural network to generate VI feature outputs, supplying IR and VI feature outputs to the combined neural networks to generate overall leak detection and localization outputs, and comparing the leak detection and localization outputs to desired leak detection and localization outputs for the video IR and video VI data to generate end-to-end feedback to train the IR neural network, the VI neural network and the combined neural network, the model comprising the IR neural network, the VI neural network and the combined neural network. The end-to-end feedback may for example use a loss function to quantify the difference between the prediction and the original value and an optimization function to modify the model to minimize the loss. The IR neural network may comprise an IR backbone neural network and an IR motion network, the IR backbone network being applied to plural individual frames of the video IR data to generate corresponding IR image-level features and the IR motion network being applied to the corresponding IR image-level features to generate the IR feature outputs; and the VI neural network may comprises a VI backbone neural network and a VI motion network, the VI backbone network being applied to plural individual frames of the video VI data to generate corresponding VI image-level features and the VI motion network being applied to the corresponding VI image-level features to generate the VI feature outputs. The IR backbone neural network and the IR motion neural network may each include multiple stages, the IR image-level features and the VI image-level features including outputs from plural of the multiple stages. The IR motion network and the VI motion network may in that case operate in parallel on the outputs of the plural stages to generate the IR feature outputs and the VI feature outputs as stage-specific feature outputs for each of the plural stages, and the combined neural network may comprise a multimodal fusion neural network operating in parallel on the stage-specific fused features for each of the plural stages to generate stage-specific fused features for each of the plural stages, and a detector that generates the overall leak detection and localization outputs based on the stage-specific fused features of the plural stages. There is also disclosed a method detecting of leak detection comprising supplying video IR and VI data to a model trained by the above method to generate overall leak detection and localization outputs.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a flow chart showing a method of detecting leaks of a chilled or pressurized fluid in a potential leakage area.

FIG. 2 is a schematic diagram illustrating an architecture for carrying out the method shown in FIG. 1.

FIG. 3 is a schematic diagram showing benefits of visual and infrared images of a leak.

FIG. 4 is a diagram showing an arrangement of images corresponding to current, previous and background images in infrared and visual.

FIG. 5 is a schematic diagram of an exemplary backbone network that may form part of the architecture of FIG. 2.

FIG. 6 is a schematic diagram of an exemplary motion enhancement module that may form part of the architecture shown in FIG. 2.

FIG. 7 is a schematic diagram of a subtraction network of the exemplary motion enhancement module of FIG. 6.

FIG. 8 is a schematic diagram of a temporal aggregation network of the exemplary motion enhancement module of FIG. 6.

FIG. 9 is a schematic diagram of an exemplary multimodal fusion module that may form part of the architecture shown in FIG. 2.

FIG. 10 is a schematic diagram of an exemplary alternative multimodal fusion module that may form part of the architecture shown in FIG. 2.

FIG. 11 is a schematic diagram showing an exemplary wave mixer that may form part of the multimodal fusion module shown in FIG. 10.

FIG. 12 is a schematic diagram showing an exemplary detector that may form part of the architecture shown in FIG. 2.

FIG. 13 is a schematic diagram showing a two-stage head that may be used in the exemplary detector shown in FIG. 12.

FIG. 14 is a schematic diagram showing a one-stage head that may be used in the exemplary detector shown in FIG. 12.

FIG. 15 is a schematic diagram illustrating a refinement process that may for example occur in the two-stage head shown in FIG. 13.

FIG. 16 is a schematic diagram showing two split strategies for selecting images for training and testing methods of detecting leaks from images.

FIG. 17 is a table of images showing a qualitative comparison of performance of an embodiment of the architecture of FIG. 2 using the multimodal fusion module of FIG. 10 and a prior art method.

FIG. 18 is a schematic diagram of two kinds of image-based object detection frameworks contrasting a two-stage detector and a one-stage detector.

FIG. 19 is a schematic diagram of different groups of information fusion techniques for object detection: (a) image-level fusion; (b) decision-level fusion; and (c) feature-level fusion.

FIG. 20 is a graph illustrating distance that normalized gradient measurement (NGM) measures wherein the dashed line indicates the distance to quantify.

FIG. 21 is a schematic diagram of the multiscale measurement in NGM wherein p represents the affine parameters while L indicates loss.

FIG. 22 is a schematic diagram illustrating the architecture of tensor-based background subtraction.

FIG. 23 is a schematic diagram of a finite-state-machine in which BG is background, DP denotes the dynamic pixel, CSP denotes the candidate static pixel, and SP denotes the static pixel.

FIG. 24 is a schematic diagram of architecture of a foreground fusion-based gas detection (FFBGD) with TBBS for background subtraction.

FIG. 25 is a schematic diagram of architecture of a deformable convolution network (DCN).

FIG. 26 is a schematic diagram of architecture of a foreground fusion network.

FIG. 27 is a schematic diagram of a design framework of multi-objective optimization-based image registration.

FIG. 28 is a schematic diagram of vision Fourier transformer-based ethane detection.

FIG. 29 is a schematic diagram of a vision Fourier transformer.

### DETAILED DESCRIPTION

Immaterial modifications may be made to the embodiments described here without departing from what is covered by the claims.

An enhanced leak detection framework for detecting a chilled or pressurized fluid, such as for example ethane, methane, propane, butane or CO₂, is proposed that extracts motion and fuses multimodal information from VI and IR surveillance cameras. A pressurized fluid can include a compressed gas or a liquid stabilized by pressure. An integrated framework is also provided in relation to the intra-modal motion information and cross-modal information to maximize the detection performance for fluid leaks, in an example tested particularly for ethane. It could also be used for other fluids such as methane, propane, butane or CO₂. Methane is the most commercially important gas and when pressurized or chilled (e.g. liquefied) the methods disclosed herein would be applicable to it.

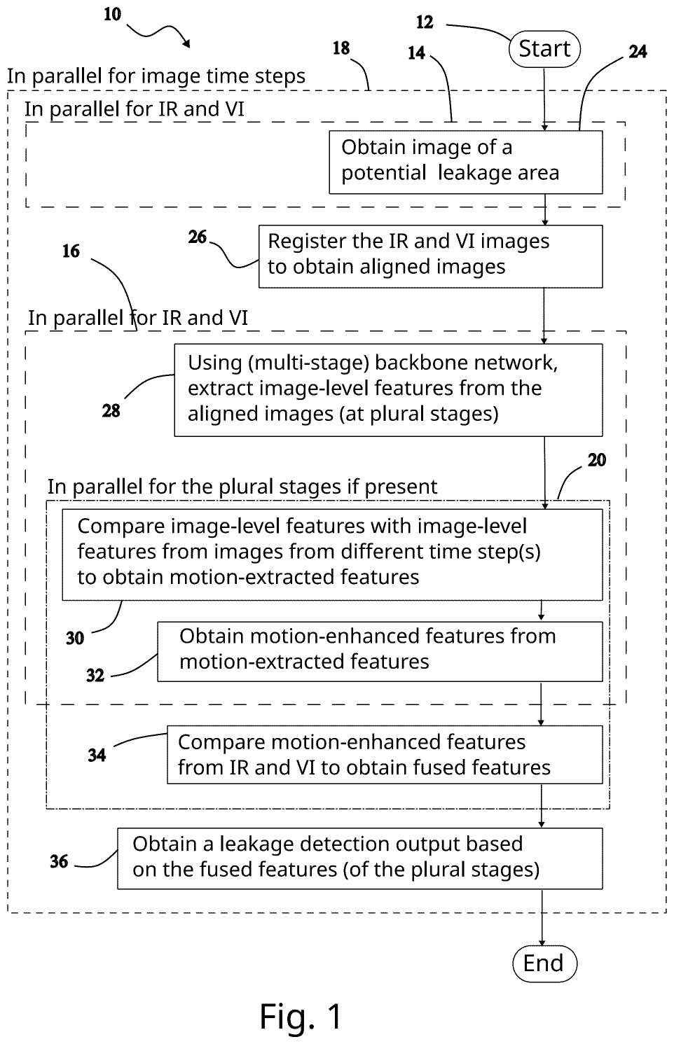

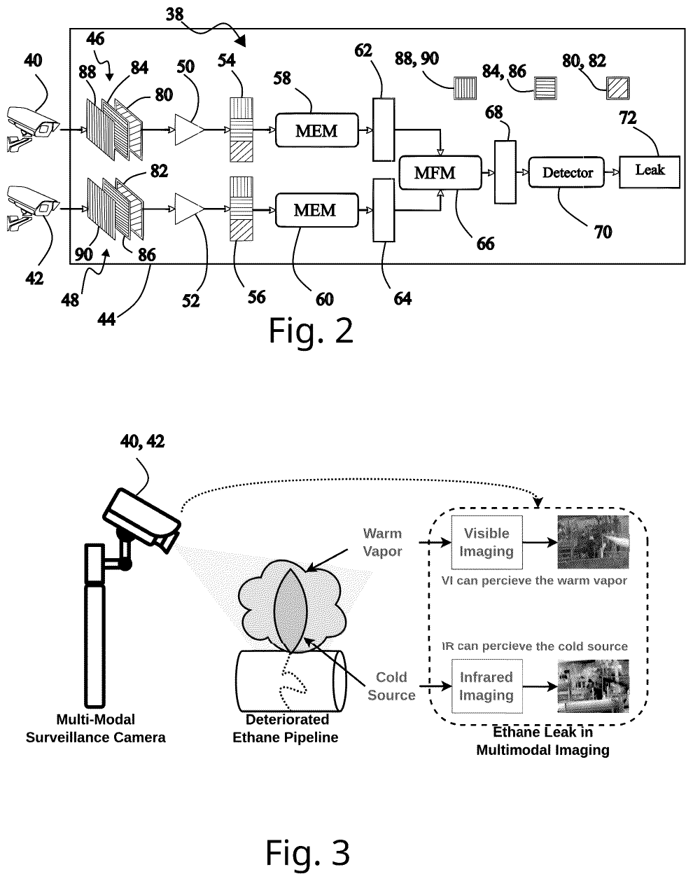

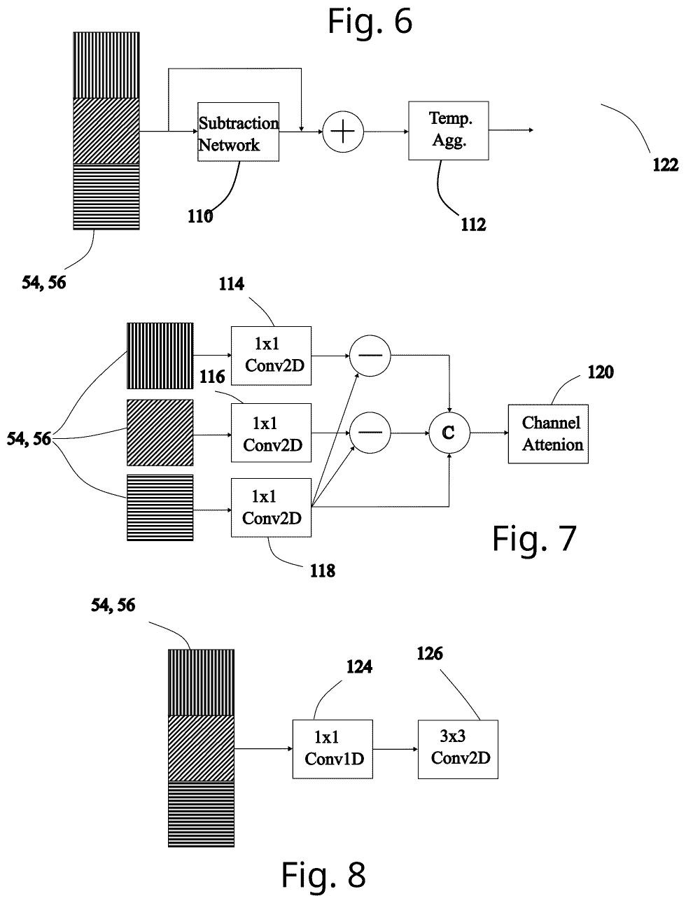

A method, generally indicated by reference numeral 10, of detecting leaks of a chilled or pressurized fluid in a potential leakage area is shown in FIG. 1. The method starts in step 12. Some steps may be carried out in parallel. Mentions of parallelism indicate that actions can be logically separated in this manner but do not necessarily indicate that the steps are carried out simultaneously. Dashed boxes 14 and 16 indicate steps that may be carried out in parallel for visual (VI) and infrared (IR) images. Dashed box 18 indicates steps that may be carried out in parallel for images from different time steps of a sequence of time steps. The time steps could, for example, correspond to a common frame rate of IR camera 40 and VI camera 42 as shown in FIG. 2, or selected frames could be taken for analysis, whether or not the cameras have synchronized frames. Dot-dash box 20 indicates steps that may be carried out in parallel for different stages 22 as discussed below. In step 24, images 46 in IR and images 48 in VI, shown in FIG. 2, are obtained of the potential leakage area using cameras 40 and 42 respectively. A respective VI image and respective IR image may be obtained for each of the time steps. Typically, substantially simultaneous VI and IR images would be desired for each time step would be desired, but some desynchronization may be acceptable if the time difference is small relative to the rate at which changes in the scene will occur. In step 26, the respective IR image and respective VI image are registered together relatively align the respective IR image and respective VI image. One or both of the respective IR image and respective VI image may be altered by the registration to obtain alignment. This may be carried out for each time step. This registration step may be omitted if the images are already sufficiently aligned. In step 28, an IR backbone neural network 50, shown in FIG. 2, may be used to extract IR image-level features 54 from the respective IR image of each time step, and a VI backbone neural network 52 may be used to extract VI image-level features 56 from the respective VI image of each time step. The VI backbone neural network and the IR backbone neural network may have identical structure. Further, they may have identical weights. The VI backbone neural network and the IR backbone neural network may each have multiple stages 22. The image-level features extracted using these networks may include outputs of plural of the multiple stages. Some further steps may be carried out in parallel on the outputs from the plural stages. In step 30, the IR image-level features may be compared with other IR image level features extracted from one or more other IR images from different time steps than the time step corresponding to the respective IR image and the respective VI image. From this, IR motion-enhanced features 62, shown in FIG. 2, may be obtained. In the embodiment shown, motion-extracted features 122 are obtained in step 30 as further illustrated in FIGS. 6-8, and motion-enhanced features 62 are obtained from the motion-extracted features 122 in an optional additional step 32 also further illustrated in FIGS. 6-8. Likewise, in step 30 the VI image-level features 54 may be compared with other VI image level features extracted from one or more other VI images from the different time steps, from which VI motion-enhanced features 64 may be obtained, and step 32 may likewise be applied to VI. In step 34, the motion-enhanced IR features may be compared with the motion-enhanced VI features to obtain fused features 68, shown in FIG. 2. In step 36, a detection output 72, shown in FIG. 2, may be generated indicating a presence and a location of a leak of the chilled or pressurized fluid in the detection area, based on the fused features of the plural stages. A new detection output may be generated at each of the plural time steps, for example for real-time leak detection.

FIG. 2 is a schematic diagram illustrating an exemplary architecture, generally indicated by reference numeral 38, for carrying out the method shown in FIG. 1. An IR camera 40 and VI camera 42 are shown separately, but may be combined into a single camera taking both types of images as shown in FIG. 3. These cameras carry out step 24 of the method 10 of FIG. 1. A computer 44 receives the images from both cameras and implements the architecture 38 to carry out the remaining steps. A computer 44 may be a single computer or be formed of multiple computers, and may be geographically collocated or distant relative to the cameras, and in the case of multiple computers, relative to each other. As shown in FIG. 2, the computer 44 receives IR images 46 and VI images 48. Step 28 of FIG. 1, the extraction of image level features 54 and 56, is carried out by IR backbone network 50 (shown as IR-Net in FIG. 2) and VI backbone network 52 (shown as VI-Net in FIG. 2). An IR motion-enhancement module 58 and VI motion-enhancement module 60 carry out step 30, and may also carry out step 32 if that step is present, for IR and VI respectively, to obtain IR motion-enhanced features 62 and VI motion-enhanced features 64. The IR motion-enhancement module 58 and the VI motion-enhancement module 60 may optionally have identical structure, or even identical weights. Step 34 is carried out by a multimodal fusion module 66, producing fused features 68. A detector 70, shown in the example architecture of FIG. 2 as FPN-based, carries out step 36 to generate detection output 72.

Details of example implementations of the above architecture and methods, as well as related matters in imaging, are described below.

A chilled fluid can be seen in infrared due to being initially cold, and a pressurized fluid can be seen in infrared when leaking if the leaking reduces the temperature due to expansion (e.g., if the pressurized fluid is a compressed gas) or evaporation (e.g., if the pressurized fluid is a liquid stabilized by pressure). In an example, the chilled or pressurized fluid may be a liquefied gas such as liquefied ethane.

### Motion-Aware Multi-Modal Ethane Leak Detection

A motion-aware framework can enhance the detection's precision, while a multimodal-based framework has higher recall (or sensitivity) to the leaks of the chilled or pressurized fluid such as ethane. Thus, an integrated framework is desired to combine their advantages in ethane leak detection. A unified framework, the Motion-aware Multimodal Ethane Leak Detection (MMELD), is proposed for this purpose, and is one example of an architecture 38 carrying out method 10. MMELD is comprised of a Motion Enhancement Module (MEM) 58, 60 and a Multimodal Fusion Module (MFM) 66 to aggregate motion information and imagery features from VI and IR images. The integrated framework greatly enhances the accuracy and robustness of ethane leak detection. Hence, the proposed MMELD will improve the quality of visual surveillance and facilitate the process of leak detection and repair.

### Methodology Details

FIG. 2 illustrates an exemplary version of architecture 38 as implemented in the proposed MMELD framework. To process each frame, in this exemplary embodiment the MMELD uses three images from each of the IR and VI fixed cameras for detection at each time step considered. These images may be referred to as a background image, previous image and current image. The corresponding two backbones (or primary network), i.e. IR-Net 50 and VI-Net 52, extract the corresponding features 54, 56 from the images. These image-level features 54, 56 are fed into the Motion Enhancement Module (MEM) 58, 60 to augment the features based on the motion information between the images in the same modality resulting in IR 62 and VI 64 motion-enhanced features. Then, these features 62, 64 are further integrated to form multimodal fused features 68 through the Multimodal Fusion Module (MFM) 66. Finally, the fused features are sent to a FPN-based detector 70 to localize and classify the ethane leak.

### Input Definitions

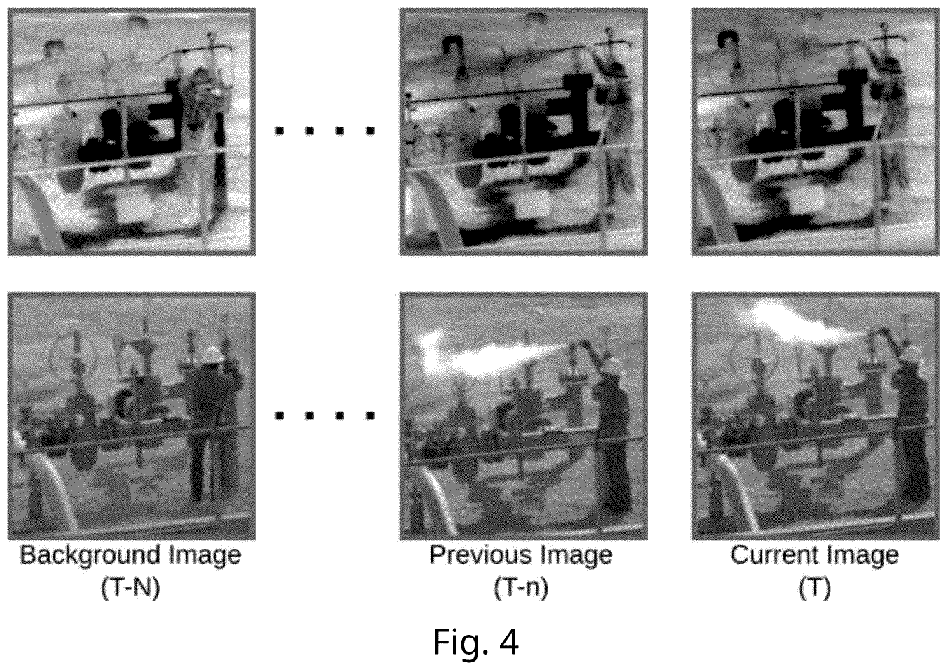

The proposed Tensor-based Background Subtraction (TBBS) described below combines long-range and short-range motion information through sampling video frames at different times. Similarly, in the exemplary architecture the inputs of MMELD considered at each time step and for each of the cameras also consist of a current image for the time step I_{c}, labeled with reference numeral 80 for IR and 82 for VI, previous image Iₚ, labeled with reference numeral 84 for IR and 86 for VI, and background image I_{b}, labeled with reference numeral 88 for IR and 90 for VI, to aggregate such motion information from both VI and IR cameras for MMELD as illustrated in FIG. 4. The definitions of these images are presented as follows:
Current Image: The current image 80, 82 is a frame taken at the T-th time. The current image is denoted as I_{c}.
Previous Image: The previous image 84, 86 is a key frame taken at the (T−n)-th time. The n is a short period within two seconds. The previous image is denoted as Iₚ.
Background Image: The background image 88, 90 is a key frame taken a longer time ago, at the (T−N)-th time, where N>>n such as thirty minutes. Thus, the image was usually before the leak occurrence. The background image is denoted as I_{b}. Collectively, images 80, 84 and 86 may make up IR images 46, and images 82, 86 and 90 may make up visual images 48.

### Backbone Network

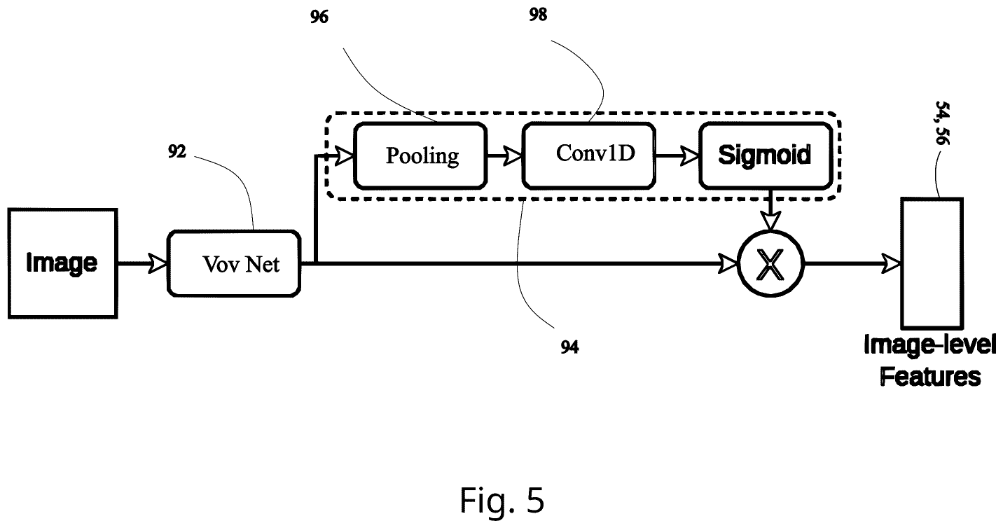

The proposed exemplary implementation of MMELD has two backbones, i.e. IR-Net 50 and VI-Net 52, to extract the image-level features each collected image. In an example, the same network is used for each backbone. An exemplary backbone 50, 52, is illustrated in FIG. 5 and takes an image 80, 82, 84, 86, 88, 90 to output image level features 54, 56. This example is developed according to VovNet-19 (V19) Y. Lee and J. Park, “Centermask: Real-time anchor-free instance segmentation,” in 2020 IEEE/CVF Conference on Computer Vision and Pattern Recognition (CVPR), 2020, pp. 13 903-13 912, which consists of serial convolution blocks and dense connectivity between these blocks as DenseNet, G. Huang, Z. Liu, L. Van Der Maaten, and K. Q. Weinberger, “Densely connected convolutional networks,” in 2017 IEEE Conference on Computer Vision and Pattern Recognition (CVPR), 2017, pp. 2261-2269. This network V19 is labeled with reference numeral 92 in FIG. 5. However, V19 only aggregates the information at the last layer of each block, which greatly increases the computational efficiency. At the end of the block, V19 adopts conventional channel attention to finally refine features from all convolution blocks. In the proposed MMELD, the original V19 is evolved to V19-ECA which replaces the original channel attention by advanced Efficient Channel Attention (ECA) (Q. Wang, B. Wu, P. Zhu, P. Li, W. Zuo, and Q. Hu, “ECA-Net: Efficient channel attention for deep convolutional neural networks,” in The IEEE Conference on Computer Vision and Pattern Recognition (CVPR), 2020), labeled by reference numeral 94 in FIG. 5. Compared with the original version, ECA 94 employs pooling 96 and a 1D Convolution Network (Conv1D) 98 to extract the attention across channels with batch normalization and an activation 100, which may be, for example ReLU, but shown as Sigmoid in FIG. 5. (Z. Liu, H. Mao, C.-Y. Wu, C. Feichtenhofer, T. Darrell, and S. Xie, “A convnet for the 2020s,” Proceedings of the IEEE/CVF Conference on Computer Vision and Pattern Recognition (CVPR), 2022) ECA mitigates the memory occupancy during calculation relative to the original channel attention. Thus, the original V19 and ECA is integrated to form V19-ECA as the backbone of MMELD in this example. The outputs of the backbone are denoted as {S₁, . . . , S₄} where the corresponding numbers of channels are {112, 256, 384, 512} at each stage as illustrated in Table 2. Each “Conv2D” indicates the combination of a 2D Convolution Network (Conv2D), a batch normalization layer and a ReLU unit as activation function in the examples in this document. Meanwhile, the term “stage concat” in Table 2 indicates the concatenation of features from the last layer of each stage for feature enhancement through ECA. Details of the V19 and ECA can be found in Y. Lee and J. Park, “Centermask: Real-time anchor-free instance segmentation,” in 2020 IEEE/CVF Conference on Computer Vision and Pattern Recognition (CVPR), 2020, pp. 13 903-13 912, Q. Wang, B. Wu, P. Zhu, P. Li, W. Zuo, and Q. Hu, “ECA-Net: Efficient channel attention for deep convolutional neural networks,” in The IEEE Conference on Computer Vision and Pattern Recognition (CVPR), 2020.

TABLE 2

| | Output | |
|---|---|---|
| Type | Stride | Network |
| Stem | 2 | [3 × 3. Conv2D, 64, stride = 2] × 1 |
| Stage 1 | 4 | [3 × 3 Conv2D, 64] × 3 |
| | | concat & 1 × 1, Conv2D, 112 |
| Stage 2 | 8 | [3 × 3 Conv2D, 80] × 3 |
| | | concat & 1 × 1, Cony2D, 256 |
| Stage 3 | 16 | [3 × 3 Conv2D. 96] × 3 |
| | | concat & 1 × 1, Conv2D, 384 |
| Stage 4 | 32 | [3 × 3 Conv2D. 112] × 3 |
| | | concat & 1 × 1, Conv2D, 512 |
| Refinement | — | stage concat & ECA |

### Motion Enhancement Module

The proposed motion enhancement module 58, 60 of FIG. 2 in an example is comprised of two parts, i.e. a subtraction network 110 to carry out step 30 of the method of FIG. 1 and temporal aggregation 112 to carry out step 32 of the method of FIG. 1, as illustrated in FIG. 6. The motion information can be extracted from comparing video frames from different times. Specifically, the proposed MEM aims to first measure the differences (step 30) among I_{b} 88, 90, Iₚ 84, 86 and I_{c} 80, 82 at feature-level through the subtraction network 110, shown in more detail in FIG. 7. The subtraction between I_{b} and I_{c} can estimate the long-range motion information while the subtraction between Iₚ and I_{c} can calculate the short-range motion information at the subtraction network. Afterward, a temporal aggregation (step 32) is designed to integrate the motion information and image features as a new feature, as illustrated in FIG. 8. The details of the subtraction network and temporal aggregation are introduced below.

I_{b}, Iₚ and I_{c}∈ [symbol] ^{3×H×W} are the background, previous and current images as inputs from either IR or VI cameras, where H and W are the height and width of the images. The corresponding image-level features 54, 56 for the times considered, F_{b}, Fₚ and F_{c}∈ [symbol] ^{C×H×W}, are extracted by the backbone, where C is the number of feature channels. Then motion information among these features are calculated as follows in the example subtraction network 110:

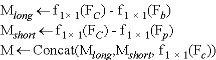

Where f_{1×1}(.), labeled in FIG. 7 with reference numerals 114, 116 118 as applied to background, previous and current image-level features respectively, is a Conv2D to reduce the number of feature channels from C to C/r with 1×1 kernel size; M∈R^{3C/r×H×W} is the channel-wise concatenation of the feature changes derived from long-range motion M_{long}, feature changes derived from short-range motion Mₛₕₒᵣₜ, and the current features f_{1×1}(F_{C}). In FIG. 7, the subtractions in the above equations are indicated using circles containing a minus sign, and the concatenation using a circle containing a C. Different channels of M have different concentrations of long-range, short-range, and static information related to the current image. It is beneficial to dynamically assign the weights to these channels to capture crucial motion information. Thus, a channel attention mechanism 120 (J. Hu, L. Shen, S. Albanie, G. Sun, and E. Wu, “Squeeze-and-excitation networks,” IEEE Transactions on Pattern Analysis and Machine Intelligence, vol. 42, no. 8, pp. 2011-2023, 2020) may be employed for this purpose. The formulation is described as follows:

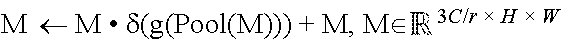

Where Pool(.) is a spatial pooling function; g(.) is a Conv1D; δ(.) is the Sigmoid function to generate the channel attention between 0 and 1. An additional skip connection, not shown, is employed to help the model's convergence. The subtraction network extracts and enhances the motion information in a channel-wise manner. The temporal aggregation step 32 is designed to spatial-temporally integrate the motion information in tensor M. At this step, the M is reshaped (reshaping step not shown) to [symbol] ^{3×C/r×H×W} where the additional axis represents the three time steps from F_{b}, Fₚ, F_{c}. These motion-extracted features are labeled by reference numeral 122 in FIG. 8. Then, as illustrated in FIG. 8, a Conv1D 124 is applied to the first axis of the reshaped M to aggregate the motion information in a temporal manner. Afterward, a Conv2D 126 is applied to spatially aggregate the motion information resulting in a final enhanced feature M 62, 64 as shown in FIG. 6. The process can be formulated as follows:

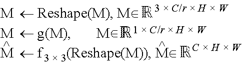

where g(.) is the Conv1D. The MEM shown above may be applied to the outputs corresponding to each stage of the backbone, which recall in an example were denoted {S₁, . . . , S₄}, the corresponding motion-enhanced feature outputs 62, 64 of the motion-enhancement module 58, 60 then being denoted as {\hat{M}₁, . . . , \hat{M}₄}, where the corresponding numbers of feature channels are {112, 256, 384, 512}.

### Multimodal Fusion Module

The MEM 58, 60 described above outputs motion-enhanced features IA 62, 64 that are enhanced by both current image features and motion information in different temporal ranges from either IR or VI cameras. Thus, an MFM 66 is required to further integrate the features from different modalities (ie. IR and VI in the embodiment shown).

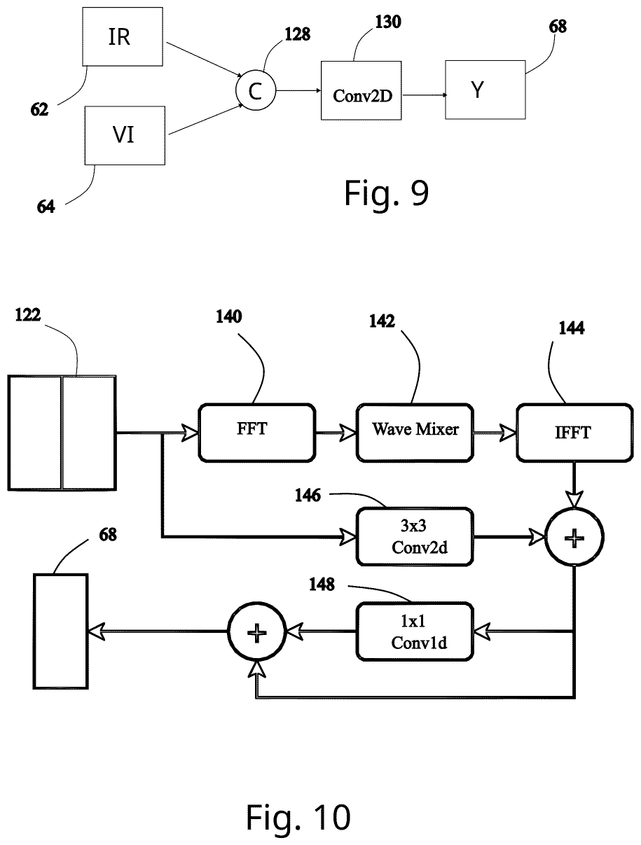

In an embodiment of the MFM 66, shown in FIG. 9, first, the VI and IR motion-enhanced features 64, 62 are concatenated as X in concatenation step (C) 128. Then, the Conv2D 130 is applied to fuse the cross-modal information as fused features Y 68. Specifically, the process can be formulated as follows:

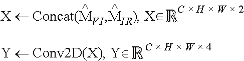

An alternate embodiment of the proposed MFM is designed to employ FFT to effectively fuse the \hat{M} from VI and IR inspired by previous studies [J. Lee-Thorp, J. Ainslie, I. Eckstein, and S. Onta\tilde{ }n'on, “Fnet: Mixing tokens with fourier transforms,” CoRR, vol. abs/2105.03824, 2021. [Online] Available: https://arxiv.org/abs/2105.03824, M. Shao, Y. Qiao, D. Meng, and W. Zuo, “Uncertainty-guided hierarchical frequency domain transformer for image restoration,” Knowledge-Based Systems, vol. 263, p. 110306, mar 2023, Y. Rao, W. Zhao, Z. Zhu, J. Lu, and J. Zhou, “Global filter networks for image classification,” in Advances in Neural Information Processing Systems (NeurIPS), 2021] and the VFTED proposed below. The architecture of this alternate MFM is illustrated in FIG. 10.

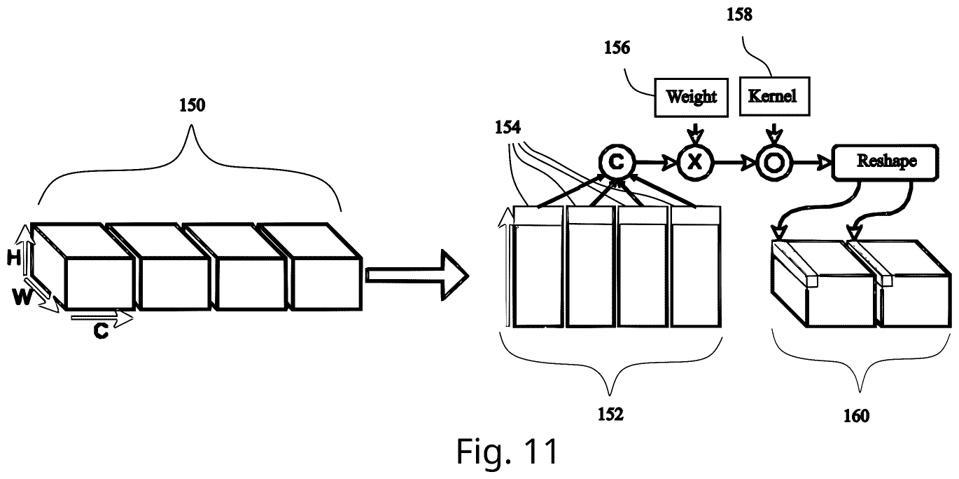

As shown in FIG. 10, this alternate MFM 66 takes the IR motion enhanced features 62 and VI motion enhanced features 64, and applies a discrete Fourier transform 140, for example a Fast Fourier transform (FFT) to generate frequency domain features 150, shown in FIG. 11. A further neural network, for example wave mixer 142 as described below, may be connected to receive the frequency domain features 150 to generate frequency domain outputs 160, shown in FIG. 11. An inverse Fourier transform 144, for example an Inverse Fast Fourier transform (IFFT), may be applied to the frequency domain outputs. The MFM 66 may also include one or more 2-dimensional convolution networks 146, 148 as described below, and finally outputs fused features 68.

First, the VI and IR motion-enhanced features 62, 66 are concatenated as X. Then, the 2D FFT 140 is applied to calculate the concatenated features Z in the frequency domain, which can be formulated as follows:

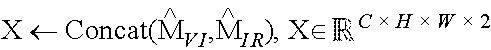

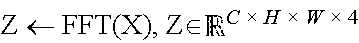

where the fourth dimension of Z is double to store real parts and imaginary parts of complex numbers. Then, the frequency features Z are manipulated by a proposed wave mixer 142 to fuse the multimodal features. FIG. 11 presents the process of the wave mixer 142. First, the frequency features tensor Z 150 is unfolded along width and height directions to generate transposed frequency features 152 as [symbol] ^{HW×C×4}. Then, a sliding window 154 moves in the HW direction of Z to integrate the VI and IR features. Each sliding window captures a vector z∈ [symbol] ^{C×4}. Then, each vector in the sliding window is processed for feature fusion with a weight W and a kernel K. The processed vector will be re-concatenated and reshaped as fused frequency features 160 Z. The general process can be formulated as follows:

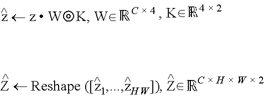

Where ⋅ is the element-wise product and O is matrix product. Then, Z is converted into the spatial domain through the Inverse Fast Fourier Transform (IFFT) 144. Meanwhile, a skip connection is also applied after IFFT with a Conv2D 146 of 3×3 kernel as presented in FIG. 9. Finally, the MFM employs Conv2D 148 of 1×1 kernel to refine the multimodal fused features Yin the channel direction. The process can be formulated as below:

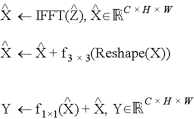

This alternate MFM 66 is also applied to every output of MEMs 58, 60, resulting in serial outputs denoted as {Y₁, . . . , Y₄}. The corresponding numbers of output channels are {112, 256, 384, 512}.

### FPN Detector

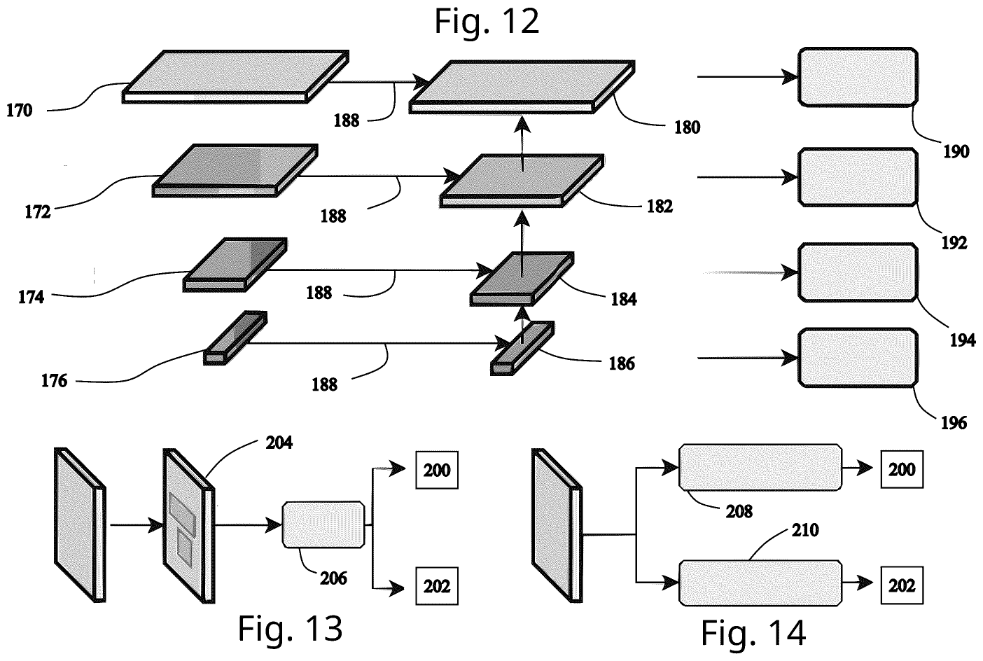

As shown in FIG. 2, a detector 70 may generate a detection output indicating a presence and location of a leak of the chilled or pressurized fluid such as ethane. In an exemplary embodiment, as illustrated in FIG. 12, the detector 70 is a two-stage FPN detector employed to detect the ethane leak from the multimodal fused features 68 comprising stage-specific fused features {Y₁, . . . , Y₄}, labeled with reference numerals 170, 172, 174, 176 respectively. The implemented FPN detector compares the stage-specific fused features {Y₁, . . . , Y₄} to generate the detection output. The detector 70 may compare the stage-specific fused features from the plural stages. In an example, the FPN may obtain stage specific processed features {P₁, . . . , P₄}, labeled with reference numerals 180, 182, 184, 186 respectively. Finally, these outputs are processed by detector heads 190, 192, 194, 196 which are small neural networks to generate localization and recognition results of the ethane leaks on images.

### FPN-Based Detector for Final Leak Detection

The Feature Pyramid Network (FPN) embodiment of detector 70 as shown in FIG. 12 is a top-down structure that enhances image features by aggregating multi-scale information as shown in FIG. 12. For stage-specific fused features {Y₁, . . . , Y₄}, the FPN can be formulated as

$${P}_{i} = \{ \begin{matrix}Conv ( {Y}_{i} ) & i = 4 \\ UP ( {Y}_{i + 1} ) + Conv ( {Y}_{i} ) & i = 1 , 2 , 3\end{matrix}$$

where Conv(.) is a CNN with 1×1 kernel; UP(.) is the twice bilinear upsampling function. This upsampling is represented by arrows 188 in FIG. 12. Thus, in this embodiment, the stage-specific processed features at a stage corresponding to more detailed features include upsampled information from another stage corresponding to less detailed features. The outputs of FPN before processing by the heads are denoted as {P₁, P₂, P₃, P₄} where in this exemplary embodiment the numbers of channels are set to {256, 256, 256, 256}. Finally, these features are fed into detection heads in order to localize and classify the ethane on different scales. In an embodiment, each detection head takes stage specific processed features, of processed features 180-186 and produces a leak detection output 200 and a leak location output 202 as shown in FIGS. 13 and 14. According to the nature of the detector, the FPN-based detection head can be categorized into one-stage and two-stage. Each may generate a respective initial detection output for a respective stage, and the final detection output may be generated based on the respective initial detection outputs. A two stage head is shown schematically in FIG. 13 and a one-stage head is shown schematically in FIG. 14. The two and one-stage heads are described as follows:

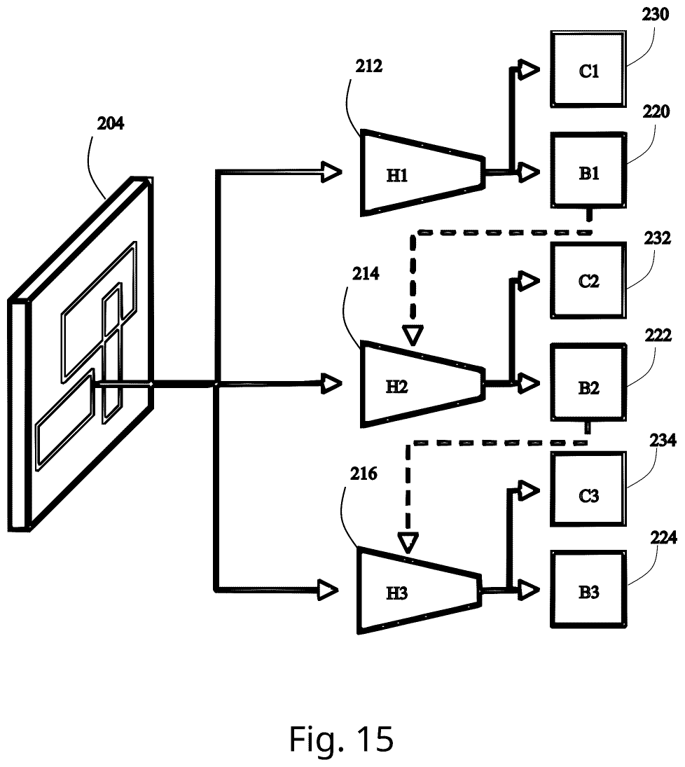

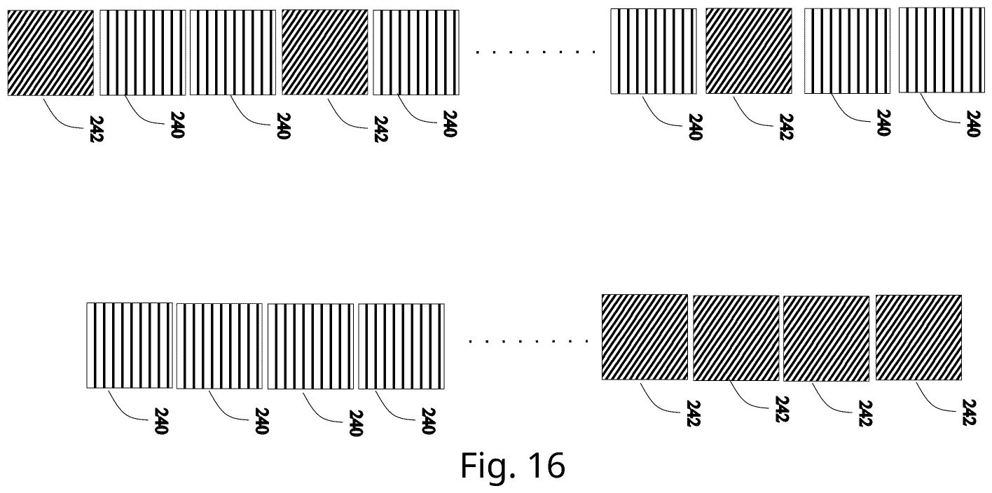

Two-stage Head. In the two-stage head, the respective initial detection output is generated using a coarse proposal network 204 to generate a coarse proposal, and a refining network 206 to generate the initial detection outputs from a feature in the coarse proposal. An exemplary embodiment shown in FIG. 13, and may be, for example, based on Faster RCNN [B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490]. The example two-stage head shown in FIG. 13 first employs a Region Proposal Network (RPN) as the coarse proposal network 200 to process the fused features from the FPN. The RPN is a specific network to generate a set of coarse anchor boxes on where the ethane leak occurs. Then, the features inside the anchor boxes are extracted to refine the final positions of the ethane leaks via ROI align, as further shown in FIG. 15, and an MLP classifier which acts as the refining network 202.

One-stage Head. In the one-stage head, the respective initial detection output may be generated using a presence network 208 to generate a presence output 200 indicating the presence of a leak, and a location network 210 to generate a location output 202 indicating the location of the leak. An exemplary embodiment shown in FIG. 14 may be constructed, for example based on RetinaNet [T.-Y. Lin, P. Goyal, R. Girshick, K. He, and P. Doll'ar, “Focal loss for dense object detection,” IEEE Transactions on Pattern Analysis and Machine Intelligence, vol. 42, no. 2, pp. 318-327, 2020] which employs two identical networks, i.e. class subnet and box subnet, to directly distinguish and localize the ethane leaks from the fused features after FPN. The process excludes the RPN, reducing the computational loads. Thus, the one-stage head usually has a fast inference speed after deployment.

Empirical studies [Z.-Q. Zhao, P. Zheng, S.-T. Xu, and X. Wu, “Object detection with deep learning: A review,” IEEE Transactions on Neural Networks and Learning Systems, vol. 30, no. 11, pp. 3212-3232, 2019] report that the two-stage head can maximize the chances of finding objects, which is crucial to safety-critical applications such as ethane detection. Thus, the two-stage FPN-based detector is set as the default detector in the experiments reported below.

### RPN and Cascade ROI Head

FIG. 15 shows an example implementation of details of the two stage head of FIG. 13. A region proposal network (RPN) [T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017] acts as coarse proposal network 204 to roughly search regions of interest (ROIs) for emission of the chilled or pressurized fluid such as liquefied natural gas. The coarse proposals from the coarse proposal network 204 are here represented with respect to multiple stages, which may be processed, for example, in a common refining network 206, or using a respective refining network 206 for that stage as shown in FIG. 15. Both the RPN 204 and the cascade ROI head shown in FIG. 15 process the features of each stage in FPN with anchors of different sizes. Then, the features and proposals from RPN are fed into the ROI head for the final prediction of gas location and classification. The standard ROI head is trained using a single intersection of union (IoU) threshold value u=0.5 for each ROI head, which is quite a loose requirement and thus likely to cause false detection. To mitigate this, in an example the cascade ROI head is constructed by integrating three ROI heads 212, 214, 216 {H₁, H₂, H₃} trained with IOU thresholds {0.5, 0.6, 0.7} as shown in FIG. 15. The three consecutive ROI heads iteratively refine the proposals from RPN with increasing IoU thresholds. Therefore, the generated bounding boxes 220, 222, 224 from the cascade ROI head are more tight to the regions of ethane. Meanwhile, the precisely localized bounding boxes also improve the classification accuracy from classifications 230, 232, 234. Thus, the cascade ROI head can improve the quality of natural gas emission detection. The last classification and bounding box of the cascade (234, 224) may be used as the detection output.

### Performance Evaluation

The performance of a proposed embodiment of the architecture of FIG. 2 and various alternatives is evaluated by precision (PR), recall (RE) and F-measurement (FM). The detection of ethane is identified as correct when the matching intersection of union (IoU) with ground truth is above 0.5. These evaluation metrics are listed as follows:

$$PR = \frac{TP}{TP + FP}$$

$$RE = \frac{TP}{TP + FN}$$

$$FM = 2 \cdot \frac{PR \cdot RE}{PR + RE}$$

where TP, FP and FN are true positive, false positive and false negative respectively. For safety-critical ethane detection, both the accuracy and robustness of the detection framework should be considered and evaluated. Therefore, two dataset split strategies, random split and chronological split, are implemented as shown in FIG. 16. The collection of VI and IR image pairs is randomly divided into a training set (70%) of training images 240, and a testing set (30%) of testing images 242, which follows the conventional procedure in object detection. The training and testing set may have similar pairs after the random split. A gas leak dataset and a liquid leak dataset were considered; the gas leak dataset was the dataset primarily used for training and testing. The overall results are concluded by a weighted sum of evaluation metrics between random split (30%) and chronological split (70%).

### Experimental Results

Tables 3, 4 and 5 compare the various methods in MEM 58, 60, MFM 62, 64 and backbones 50, 52 towards making an integrated framework. Table 3 shows the results of an experiment with different motion-aware modules 58,60, Table 4 shows the results of an experiment using different multimodal fusion modules 62, 64, and Table 5 shows the results of an experiment using different backbones 50, 52. According to these experimental results, an exemplary embodiment of the architecture of an integrated framework uses TEA as a motion-enhancement module, Conv2D as multimodal fusion module and V19 as backbone. The general detection framework is developed based on Faster RCNN with FPN as aforementioned contents.

TABLE 3

| Backbone | Motion | Multimodal | PR | RE | FM |
|---|---|---|---|---|---|
| V19 | Addition | Addition | 12.0 | 31.1 | 17.3 |
| V19 | Subtraction | Addition | 58.4 | 76.7 | 66.3 |
| V19 | Conv2D | Addition | 51.9 | 86.7 | 64.9 |
| V19 | Conv3D | Addition | 46.6 | 64.7 | 54.2 |
| V19 | TDN | Addition | 22.7 | 48.6 | 30.9 |
| V19 | TEA | Addition | 65.0 | 89.6 | 75.4 |
| V19 | FFN | Addition | 50.9 | 75.2 | 60.7 |
| V19 | MViT | Addition | 55.8 | 76.9 | 64.7 |
| V19 | InfDet | Addition | 46.4 | 67.1 | 54.9 |

TABLE 4

| Backbone | Motion | Multimodal | PR | RE | FM |
|---|---|---|---|---|---|
| V19 | TEA | Addition | 65.03 | 89.60 | 75.37 |
| V19 | TEA | Conv2D | 69.49 | 91.10 | 78.84 |
| V19 | TEA | FT | 51.63 | 85.20 | 64.30 |
| V19 | TEA | ViT | 58.47 | 58.50 | 58.48 |
| V19 | TEA | VFT | 64.19 | 85.30 | 73.25 |
| V19 | TEA | XCiT | 64.50 | 86.20 | 73.79 |
| V19 | TEA | Transfusor | 41.26 | 73.80 | 52.93 |
| V19 | TEA | Channel Attettion | 57.59 | 84.20 | 68.40 |
| V19 | TEA | Spatial Attettion | 60.72 | 91.80 | 73.09 |
| V19 | TEA | CBAM | 54.27 | 87.10 | 66.87 |
| V19 | TEA | PVT | 55.51 | 84.10 | 66.88 |

TABLE 5

| Backbone | Motion | Multimodal | PR | RE | FM |
|---|---|---|---|---|---|
| V19 | TEA | Conv2D | 69.49 | 91.10 | 78.84 |
| R18 | TEA | Conv2D | 62.20 | 79.10 | 69.64 |
| MV3 | TEA | Com:2D | 60.40 | 81.05 | 69.21 |
| Swin-S | TEA | Conv2D | 64.95 | 81.35 | 72.23 |
| fbnetv2 | TEA | Conv2D | 61.45 | 85.73 | 71.58 |

### Experimental Results Relating to an Alternative Embodiment

Experimental VI and IR image pairs were collected from an industrial petrochemical refinery for training and validating the proposed MMELD as discussed above using the alternative MFM embodiment illustrated in FIGS. 10 and 11. The evaluation metrics are consistent to the previous studies with Precision (PR), Recall (RE) and F-Measure (FM) when the matching is determined according to Intersection of Union (IoU) between the ground truth and the predicted bounding box being above 0.5. However, since individual motion-based and multimodal-based frameworks have satisfied performance in conventional shuffled and random splits (70% training and 30% testing sets), the MMELD's performance was validated on more challenging splits of training and testing sets, i.e. chronological split. The chronological split results in balanced training (50%) and testing (50%) sets according to the scenarios of the images. Specifically, if there are images from 8 scenarios as illustrated in Table 6, each group of four scenarios in the training and testing set won't be correlated, which aims to better verify the generalization and stability of ethane leak detectors on where frameworks have not seen before. Thus, we mainly evaluate the frameworks' performance based on the experiments under chronological split.

TABLE 6

| Scenarios | 1 | 2 | 3 | 4 | 5 | 6 | 7 | 8 |
|---|---|---|---|---|---|---|---|---|
| Training | Y | Y | Y | Y | N | N | N | N |
| Test | N | N | N | N | Y | Y | Y | Y |

The proposed MMELD was trained by the “AdamW” method (I. Loshchilov and F. Hutter, “Decoupled weight decay regularization,” in International Conference on Learning Representations, 2019) with an initial learning rate of 0.0001. The weight was caused to decay ten times after 30000 iterations with 0.9 momenta for stable convergence during training. The batch size was set as four during training. Meanwhile, the predictive threshold is set to 0.5 across all the compared methods. All baseline methods were trained and tested on a cloud computing node configured with an NVIDIA Tesla P100 GPU card.

### Validation on Random Split

TABLE 7

| Methods | Motion | Multimodal | PR↑ | RE↑ | FM↑ |
|---|---|---|---|---|---|
| FFBGD (Chp. 3) | ✓ | — | 88.31 | 81.02 | 84.51 |
| VFTED (Chp. 4) | — | ✓ | 93.50 | 95.00 | 94.20 |
| MMELD | ✓ | ✓ | 98.94 | 97.80 | 98.37 |

Before presenting the full comparative studies using chronological split, Table 7 illustrates the performance evaluations of this alternative embodiment of the MMELD with the above discussed motion-aware FFBGD and multimodal-based VFTED under random splits. The MMELD combines the advantages of both motion-aware and multimodal-based frameworks to achieve almost optimal performance in ethane leak detection. Compared with the FFBGD and VFTED, MMELD can achieve around 5% improvement on PR, RE, and FM. However, tests of FFBGD and VFTED reflect a severe degradation of accuracy and sensitivity (lower RE) under chronological split. These results discussed above suggest an improvement of robustness and generalization is still demanded in ethane leak detection frameworks. In this regard, the following experiments are conducted purely on the chronological split to focus on developing a stable framework against unseen scenarios.

### Ablation Studies

TABLE 8

| Current | Previous | Background | | | |
|---|---|---|---|---|---|
| Image I_{c} | Image Iₚ | Image I_{b} | PR↑ | RE↑ | FM↑ |
| ✓ | — | — | 41.26 | 67.10 | 51.10 |
| ✓ | ✓ | — | 53.10 | 71.25 | 60.85 |
| ✓ | — | ✓ | 58.39 | 76.70 | 66.30 |
| ✓ | ✓ | ✓ | 64.19 | 85.30 | 73.25 |

There are various inputs at the motion enhancement module (MEM) to enhance the image features with short-range and long-range motion information brought by the previous image (Iₚ) and background image I_{b}. Thus, an ablation study was first carried out to verify the effectiveness of each input as shown in Table 8. Without additional Iₚ and I_{b}, the MMELD purely relies on the I_{c} from the VI and IR cameras with 41.26, 67.10, 51.10 as PR, RE and FM. Then, the combination of I_{c} and Iₚ enables the MEM to extract short-range motion information, resulting in 19% improvement of FM. Meanwhile, the long-range motion information brought by I_{c} and I_{b} can further boost the FM from 60.85 to 66.30. Besides, the RE impressively increases from 71.25 to 76.70, implying the improved sensitivity brought by the long-range motion information. Finally, the integrated inputs (I_{c}, Iₚ and I_{b}) can leverage both short-range and long-range motion information to maximize the leak detection performance through MEM as illustrated in Table 8.

Another ablation study is presented to validate the effectiveness of components in multimodal fusion module (MFM) at Table 9. The fusion of VI and IR features in the frequency domain can significantly improve the detection quality through a conventional Conv2D. Besides, the RE significantly increases from 57.80 to 82.48, indicating a remarkable sensitivity to ethane leaks. If the conventional Conv2D is replaced by the proposed wave mixer, the detection performance is further improved. From this point of view, the results suggest the proposed wave mixer can efficiently fuse the VI and IR features.

TABLE 9

| IR | VI | Conv2D | Wave Mixer | PR↑ | RE↑ | FM↑ |
|---|---|---|---|---|---|---|
| ✓ | — | — | — | 45.76 | 57.80 | 51.08 |
| — | ✓ | — | — | 51.30 | 44.81 | 47.84 |
| ✓ | ✓ | ✓ | — | 60.08 | 82.48 | 69.52 |
| ✓ | ✓ | — | ✓ | 64.19 | 85.30 | 73.25 |

### Comparison of Various Backbones

As aforementioned, the backbone is the primary network to extract image-level features of I_{c}, Iₚ and I_{b} from VI and IR cameras in MMELD, which can greatly influence the framework's performance in ethane leak detection. Therefore, five advanced lightweight backbones, ResNet-18 (R18), MobibleNetV3 (MV3), small variant of Swin Transformer (Swin-T), vanilla Vovnet-19 (V19) and FBNetV2 were selected to compare with our modified V19-ECA. The results are shown in Table 10. Compared with the selected alternative backbones, the proposed V19-ECA has the second-highest PR and competitive RE, leading to the highest FM. Compared with the original V19, the V19-ECA can achieve higher PR and similar RE. The results suggest that the implemented V19-ECA is a suitable backbone in MMELD due to its comprehensive good performance.

TABLE 10

| Backbones | V19 | R18 | MV3 | Swin-T | FBNetV2 | V19-ECA (ours) |
|---|---|---|---|---|---|---|
| PR↑ | 62.84 | 63.09 | 59.57 | 65.10 | 60.42 | 64.19 |
| RE↑ | 85.41 | 80.24 | 81.27 | 82.29 | 85.43 | 85.30 |
| FM↑ | 72.41 | 70.64 | 68.75 | 72.69 | 70.78 | 73.25 |

### Comparison of Motion-Aware Methods

Seven methods, i.e. Subtraction (T. Minematsu, A. Shimada, H. Uchiyama, and R. ichiro Taniguchi, “Analytics of deep neural network-based background subtraction,” Journal of Imaging, vol. 4, no. 6, p. 78, jun 2018.), C3D, TDN, FFN (discussed below), MViT and an alternative implementation of TEA, labeled as TEA below and in Table 11 and described in K. Zhou, Y. Wang, T. Lv, Y. Li, L. Chen, Q. Shen, and X. Cao, “Explore spatio-temporal aggregation for insubstantial object detection: Benchmark dataset and baseline,” in 2022 IEEE/CVF Conference on Computer Vision and Pattern Recognition (CVPR). IEEE, jun 2022, were selected to compare with the proposed TEA-based MEM in MMELD. Table 11 presents comparative results in ethane leak detection. Within the alternative motion-aware methods other than the proposed MEM, the TEA is much better than the other methods with a great margin in FM and PR. However, the RE of TEA is much less than C3D. In comparison, the proposed MEM can achieve competitive RE and PR to TEA and C3D, resulting in the highest FM. Thus, the MEM is considered the best motion-aware method to assist MMELD in achieving a balanced performance in ethane leak detection.

TABLE 11

| | | | | | | | MEM |
|---|---|---|---|---|---|---|---|
| Methods | Subtraction | C3D | TDN | FFN | MViT | TEA | (ours) |
| PR↑ | 58.39 | 51.89 | 55.80 | 50.89 | 46.41 | 64.85 | 64.19 |
| RE↑ | 76.70 | 86.70 | 76.90 | 75.20 | 67.10 | 80.79 | 85.30 |
| FM↑ | 66.30 | 64.92 | 64.67 | 60.70 | 54.87 | 71.95 | 73.25 |

### Comparison of Multimodal Feature Fusion Methods

In this study, seven alternative methods, i.e. CMIAN, AF, CNL, CEN, Transfusor, addition and the alternative MFM embodiment VFT (presented above), were implemented to fuse multimodal features in MMELD. The embodiment using Conv2D was not considered in this earlier test. Table 12 presents the experimental results of this comparison. Within the alternative methods, the VFT and Transfusor have better performance than other baselines. The VFT is more favorable with a relatively higher RE, indicating a higher sensitivity to ethane leak. Turning to the proposed MEM, all evaluations are significantly improved using the VFT compared with the alternatives as shown in Table 12. It is notable that both VFT and MEM are developed based on feature fusion in the frequency domain via FFT and IFFT. However, the MEM first uses an additional kernel to directly combine complex feature matrices of VI and IR, making the fusion process more compact. Second, the MEM has a skip connection to help the framework's convergence during training with a Conv2D, which also contributes to the performance in ethane leak detection. Thus, the proposed MEM is considered the best of the tested methods to fuse motion-enhance features of VI and IR in MMELD.

TABLE 12

| Methods | CMIAN | AF | CNL | CEN | Transfusor | Addition | VFT | MFM (ours) |
|---|---|---|---|---|---|---|---|---|
| PR↑ | 53.27 | 51.63 | 57.59 | 55.51 | 63.42 | [symbol] | 62.78 | 64.19 |
| RE↑ | [symbol] | 85.25 | [symbol] | [symbol] | [symbol] | 73.94 | [symbol] | 85.30 |
| FM↑ | [symbol] | 64.30 | 68.40 | 67.12 | 70.70 | 60.55 | 70.84 | 73.25 |

[symbol]

indicates data missing or illegible when filed

### Comparison Between Gas Leak Detection Frameworks

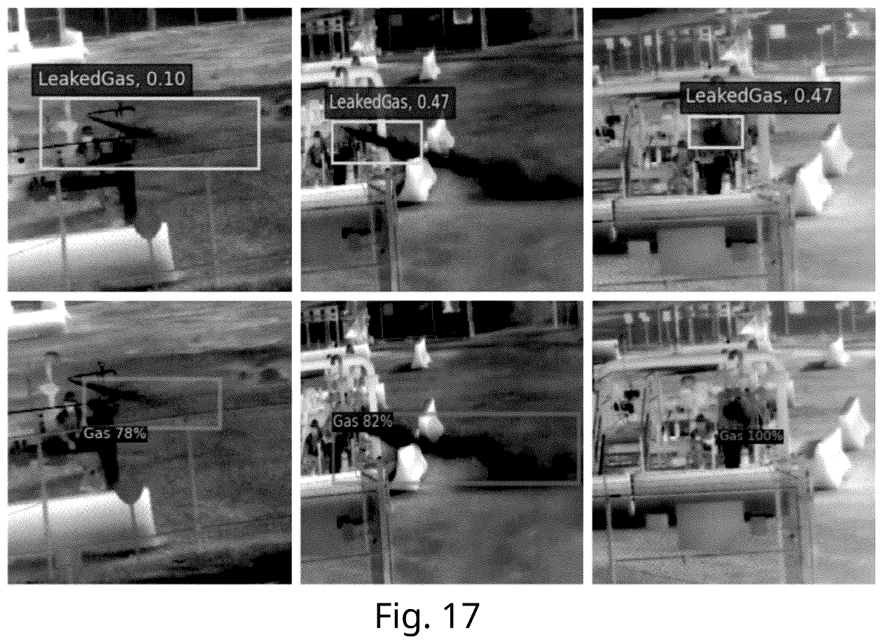

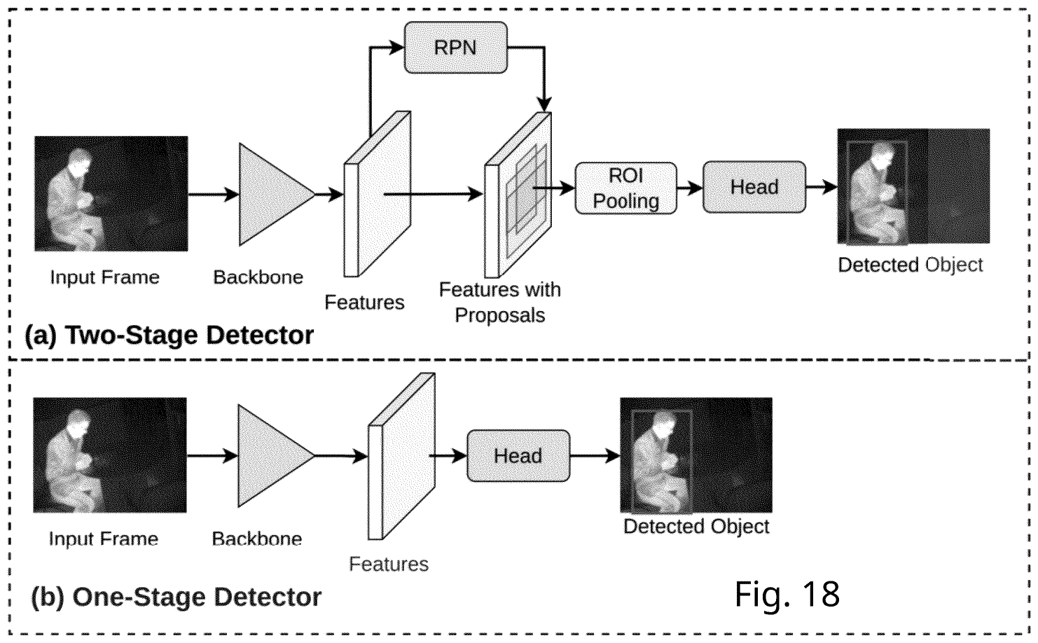

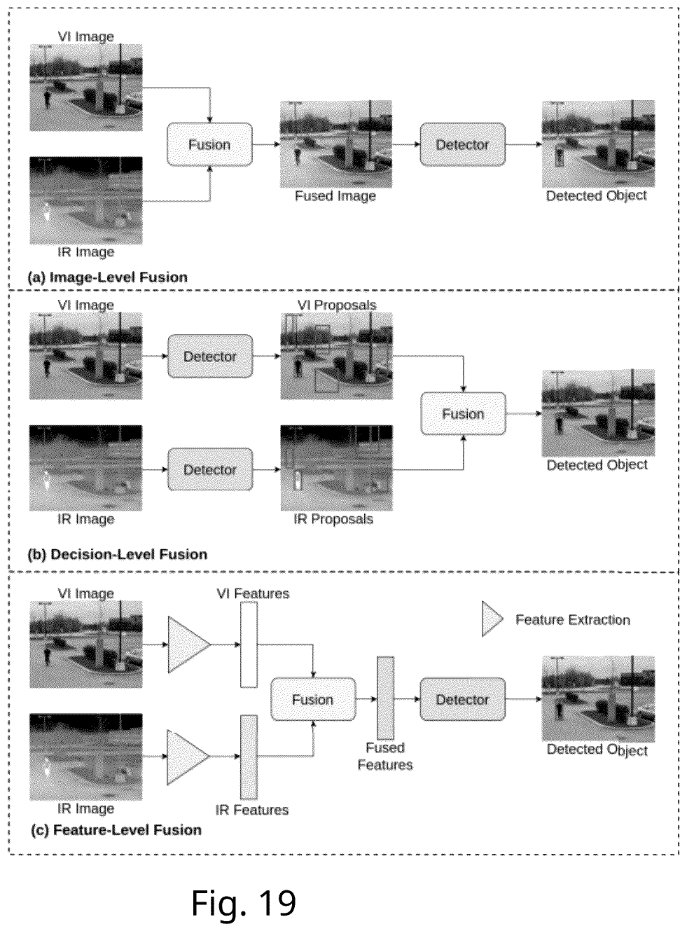

After comparative studies of components in MMELD, Table 13 presents the experimental results in terms of entire frameworks in ethane and related gas leak detection. Specifically, five frameworks were implemented for this purpose, i.e. FFBGD (discussed below), TBLD, GasNet, IOD and VFTED (presented below). Compared with contemporary frameworks, the MMELD can utilize advantages from motion-aware and multimodal-based frameworks to achieve remarkable performance in ethane leak detection. Specifically, the MMELD (in this alternative embodiment considered in these tests) can bring at least 33% improvement in FM over other frameworks. Meanwhile, FIG. 17 illustrates the some qualitative examples of detection from the proposed alternative MMELD and IOD which is the second-best method. The IOD can perceive the ethane leak in each scenario from IR imaging based on motion information. However, the detected bounding boxes do not tightly cover the ethane leaks. In contrast, the MMELD implementation tested can precisely localize the ethane leak with additional VI information, resulting in tight bounding boxes. A comparison of computational efficiency was also carried out in terms of frame per second as shown in Table 14. The MMELD can achieve moderate inference speed compared with the alternative frameworks considered, while this alternative MMELD is the most accurate framework tested in this initial experiment that did not include a later superior embodiment as discussed above. The results demonstrate the effectiveness of the integration of motion-aware and multimodal modules as an MMELD.

TABLE 13

| | | | | | | MMELD |
|---|---|---|---|---|---|---|
| Frameworks | FFBGD | TBLD | GasNet | IOD | VFTED | (ours) |
| Motion | ✓ | ✓ | ✓ | ✓ | — | ✓ |
| Multimodal | — | — | — | — | ✓ | ✓ |
| PR↑ | 64.38 | 34.19 | 29.03 | 47.38 | 48.73 | 64.19 |
| RE↑ | 32.90 | 52.05 | 45.01 | 65.66 | 56.30 | 85.66 |
| FM↑ | 43.55 | 41.27 | 41.55 | [symbol] | 52.24 | 73.28 |

[symbol]

indicates data missing or illegible when filed

TABLE 14

| Methods | VFTED | FFBGD | TBLD | GasNet | IOD | MMELD (ours) |
|---|---|---|---|---|---|---|
| FPS | 25.32 | 12.81 | 3.33 | 17.85 | 15.79 | 12.93 |

### Multi-Objective Optimization-Based Image Registration

As discussed above, sufficiently aligned images are required for some methods. Any suitable method may be used. A particular method, Multi-Objective Optimization-Based Image Registration (MOIR) is discussed here.

Assuming there is a floating image A∈ [symbol] ^{H×W} and a fixed image B∈ [symbol] ^{H×W}, the objective of the image registration aims to estimate the affine parameters p by solving

$${arg min}_{p} ℒ ( A ◦ p , B )$$

where L(.) is the objective function that measures the difference of inputs in pixels; ∘ is the image warping function. Therefore, the optimal affine parameters p are carried out when the difference between warped floating image A∘p and fixed image B is minimal. The optimal affine parameters can be arranged as a matrix p having 6 parameters to transform the floating image, which is defined as

$$p = [ \begin{matrix}{a}_{1} & {a}_{2} & {t}_{x} \\ {a}_{3} & {a}_{4} & {t}_{y}\end{matrix} ]$$

where a₁, a₂, a₃, a₄ are the elements for linear transformation; tₓ and t_{y} are the translation elements in x-axis and y-axis. As aforementioned, the visible and thermal (VI-T) images have distinct textures due to the different imaging characteristics. Nonetheless, the image structure of the VI-T pairs are similar. In this regard, the VI-T pairs can be fully aligned when the structural difference reduces to a minimum. In image processing, the image gradient can well reflect the structural information of an image. Therefore, the proposed Multi-objective Optimization-based Image Registration (MOIR) first implements a new objective function, i.e. Normalized Gradient Measurement (NGM), to measure the gradient difference between floating and fixed images as an objective function [symbol] (.). Then, Regularized Stochastic Gradient Descent (RSGD) is applied as the optimizer that dynamically changes the p until the NGM is minimized after N iterations. Additionally, the MOIR can take either visible or thermal images as floating images.

### Normalized Gradient Measurement as Objective Function

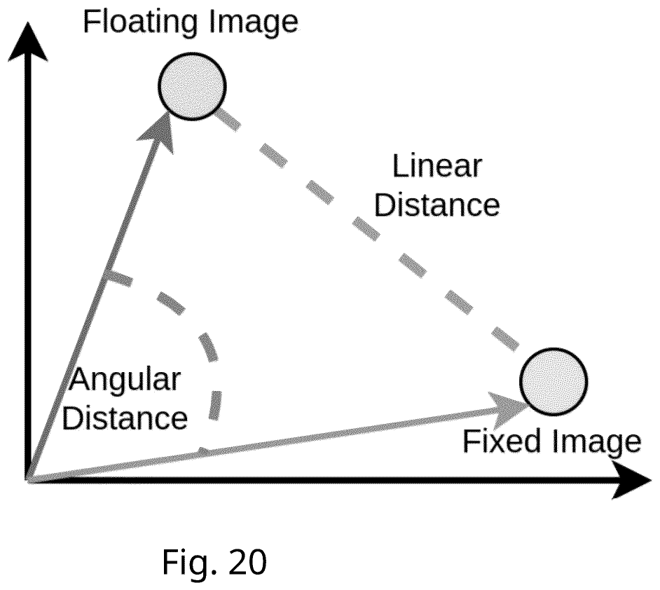

The proposed NGM aims to quantify the distance as [symbol] (.) between the floating image A and fixed image B in two aspects, i.e. linear and angular distances as shown in FIG. 20. Specifically, the linear distance measures the direct difference between A and B. Meanwhile, angular distance aims to quantify the cosine values of the rotation between A and B using the inner product. Their formulations are illustrated as below:

$${ℒ}_{AD} ( A , B ) = 1 - \frac{A \cdot B}{‖ A ‖ ‖ B ‖} , {ℒ}_{AD} ∈ [ - 1 , 1 ]$$

$${ℒ}_{LD} ( A , B ) = {‖ A - B ‖}_{1} , {ℒ}_{LD} ∈ [ 0 , + ∞ )$$

where [symbol] _{AD}(.) is the angular distance function; [symbol] _{L1}(.) is the L1 distance function; . is the dot production; and ∥.∥₁ is the L1 norm. The current forms of the two distances have different ranges which needs to be normalized for alignment. Accordingly, the normalized angular distance and L1 distance can be re-written as follows:

$${ℒ}_{AD} ( A , B ) = 1 - \frac{( A - \overline{A} ) \cdot ( B - \overline{B} )}{‖ A - \overline{A} ‖ ‖ B - \overline{B} ‖} , {ℒ}_{AD} ∈ [ 0 , 1 ]$$

$${ℒ}_{LD} ( A , B ) = 1 - \frac{{‖ A - B ‖}_{1}}{{‖ A ‖}_{1} + {‖ B ‖}_{1}} , {ℒ}_{L 1} ∈ [ 0 , 1 ]$$

where Ā and B̅ are the mean values of the entire A and B respectively.

Due to the domain difference between visible and thermal (VI-T) imaging, direct measurement can severely damage the registration quality. However, the image structures are similar between pairs of VI-T images, which is reflected on the image gradients and edges. The image gradient function G(.) is applied to A and B to calculate the gradient difference with affine parameters p as below:

$$\begin{matrix}{ℒ}_{GD} ( A , B ; p ) = λ {ℒ}_{AD} ( G ( A ◦ p ) \text{?} G ( B ) ) \\ + ( 1 - λ ) {ℒ}_{LD} ( G ( A ◦ p ) , G ( B ) )\end{matrix}$$

$$\text{?} \text{indicates text missing or illegible when filed}$$

where G(.) uses the Sobel operator to derive the image gradient; [symbol] _{GD}(.) is the gradient difference function; the λ∈[0,1] is the weight between the two normalized distances. Minimizing the above equation will typically make A∘p find suitable affine parameters for registration at the end of the iterations. Nonetheless, it may also generate an unexpected displacement to the floating image. Therefore, a Gradient Smoothness Regularization (GSR) may be employed to smooth the displacement by adding L2 penalty on the generated affine grid:

$${ℒ}_{GSR} ( p ) = \frac{β}{2} {‖ {G ( U ( p ) )}^{2} ‖}_{2}^{2}$$

where U(.) is the function to generate a sampling grid from p; β is the weight for GSR. Details can be found in G. Balakrishnan, A. Zhao, M. R. Sabuncu, J. Guttag, and A. V. Dalca, “Voxelmorph: A learning framework for deformable medical image registration,” IEEE Transactions on Medical Imaging, vol. 38, no. 8, pp. 1788-1800, 2019. Therefore, the NGM ( [symbol] (.)) can be regarded as the integration of the two functions:

$$ℒ ( A , B ; p ) = {ℒ}_{GD} ( A , B ; p ) + {ℒ}_{GSR} ( p )$$

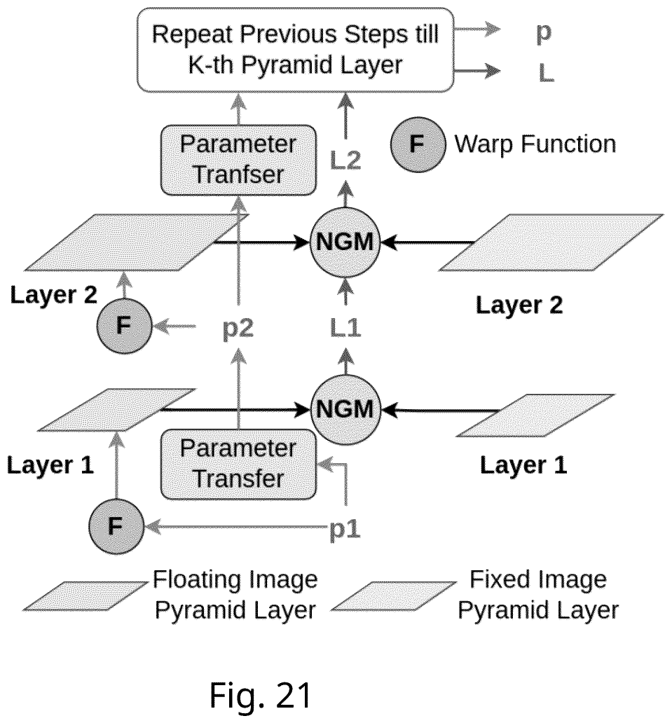

In order to enhance the registration precision, a multiscale measurement is designed through an image pyramid. FIG. 21 visualizes the pipeline of an example multiscale measurement with the proposed NGM. For both A and B, the Gaussian image pyramid is applied to generate sequential K image pairs through downsampling and Gaussian blurs. The collections of A and B are denoted as A=[A₁, . . . , A_{K}] and B=[B₁, . . . , B_{K}]. The first layer of the pyramid features the lowest resolution while the final K-th layer features the original resolution of the image. The corresponding collection of affine parameters is derived as P=[p₁, . . . , p_{K}] through parameter transfer. The parameter transfer aims to adjust the affine parameter in a coarse-to-fine manner. The formulation is shown as below:

$${p}_{j} = {p}_{j - 1} * [ \begin{matrix}1 & 1 & D + {θ}_{x} \\ 1 & 1 & D + {θ}_{y}\end{matrix} ] s . t . j \geq 2$$

where D is the downsampling rate of image pyramid; * is element-wise multiplication; and θₓ and θ_{y} are two learnable offsets to stabilize the vertical and horizontal translation during iteration. For a pyramid of K layers, the final NGM can be re-formulated with P as

$$ℒ ( 𝒜 , ℬ : 𝒫 ) = \frac{1}{K} {\sum }_{j = 1}^{K} ( {ℒ}_{GD} ( {A}_{j} , {B}_{j} : {p}_{i} ) + {ℒ}_{GSR} ( {p}_{i} ) )$$

### Optimizer for Solving Affine Parameters for Registration

In the optimization phase, the proposed Multi-objective Optimization-based Image Registration (MOIR) initially employs the conventional Stochastic Gradient Descent (SGD) to solve the affine parameters p. During the implementation, there are two challenges with SGD as an optimizer. First, although SGD has guaranteed convergence, the SGD needs to take numerous iterations for the optimal affine parameters. Second, the learning curve of SGD severely fluctuates, which may lead to sub-optimal affine parameters. The Regularized Stochastic Gradient Descent (RSGD) is designed to employ three techniques, i.e. L2 regularization, momentum and Variance Rectification Term (VRT), to accelerate and smooth convergence during optimization.

The additional L2 regularization can lead to smaller affine parameters contributing to the precision of registration. The L2 regularization in SGD can be formulated as follows:

$$ℒ = ℒ + \frac{ω}{2} {‖ p ‖}_{2}^{2}$$

$${∇}_{p} ( ℒ ) = {∇}_{p} ( ℒ ) + ω p$$

where ω is the weight of L2 regularization; ∇ₚ(.) is the partial differential function with respect to the affine parameters. The latter equation represents the derivative form of the objective function with additional L2 regularization.

Momentum is a technique to smooth the optimization path of SGD and mitigate the oscillations resulting in faster convergence. The momentum aims to take the simple exponential moving average to smooth the convergence as dynamic signals. The proposed RSGD takes the first-order and second-order momentum into account as follows:

$${m}_{t} = {τ}_{1} {m}_{t - 1} + ( 1 - {τ}_{1} ) {∇}_{p} ( ℒ )$$

$${v}_{t} = {τ}_{2} {m}_{t - 1} + ( 1 - {τ}_{2} ) {∇}_{p} {( ℒ )}^{2}$$

$${p}_{t} = {p}_{t - 1} - γ \frac{{m}_{t}}{\sqrt{{v}_{t} + ε}}$$

where m and v are the first-order and second-order momentum with corresponding weights τ₁ and τ₂; γ is the learning rate. The current mₜ and vₜ are updated by weighted summation of the previous mₜ₋₁, vₜ₋₁ and corresponding first-order and second-order gradient ∇ₚ( [symbol] ) and ∇ₚ( [symbol] ) at the time step t. The process can be regarded as the weighted average of previous and current optimizations steps to relieve oscillations which help the MOIR achieve faster convergence. Finally, both momentum vectors are used to update affine parameters p as shown in the last equation above.

At the beginning of optimization, the variance of the second-order momentum Var(vₜ) can be considerably large which damages the convergence. Assuming t→∞, the Var(v_{∞}) gradually decreases to a constant. An intuitive strategy is assigning an adaptive weight rₜ to the second-order momentum according to its variance. If the Var(vₜ) and Var(v_{∞}) are known, the adaptive weight or variance rectification term (VRT) can simply described as

$${r}_{t} = \sqrt{\frac{Var ( {v}_{∞} )}{Var ( {v}_{t} )}}$$

When variance of vₜ is high, the rₜ decreases to assign less weight for the vₜ during optimization. From the above equation for pₜ, the second-order momentum influences the affine parameter as 1/√1 (vₜ+ε) which is subject to the scaled inverse chi-squared distribution, i.e. Scale-inv-χ²(1, 1/σ²). An embodiment of MOIR adopts an approximated solution to calculate the variance as

$$Var ( {v}_{t} ) \approx \frac{{ρ}_{t}}{2 ( {ρ}_{t} - 2 ) ( {ρ}_{t} - 4 ) {σ}^{2}}$$

$${r}_{t} = \sqrt{\frac{( {ρ}_{t} - 4 ) ( {ρ}_{t} - 2 ) {ρ}_{∞}}{( {ρ}_{∞} - 4 ) ( {ρ}_{∞} - 2 ) {ρ}_{t}}}$$

where ρ is the degree of freedom (DoF). The maximum DoF ρ_{∞} and the current DoF ρₜ can be derived by

$${ρ}_{∞} = \frac{2}{1 - {τ}_{2}} - 1$$

Finally, the above equation for pₜ can be simply re-written to consider VRT during parameters update as

$${p}_{t} = {p}_{t - 1} - γ {r}_{t} \frac{{m}_{t}}{\sqrt{{v}_{t} + ε}}$$

### Solving Affine Parameters

Algorithm 1 illustrates the algorithmic steps of MOIR with NGM and RSGD for deriving affine parameters. In the process, the MOIR employs a warmup strategy to apply simple SGD when ρₜ is less than 6. The warmup strategy aims to help the optimizer adapt to the image distribution, which also prevents the algorithm from early over-fitting. Meanwhile, the learning rate decay is applied to enhance the convergence at the end of every iteration. It is noticed that the derived pₜ is for the first layer of the A. Therefore, pₜ needs to be upsampled to

$${p}_{t}^{*}$$

or meeting the resolution of original floating image A. The upsampling process is formulated as below:

$${p}_{t}^{*} = {p}_{t} * [ \begin{matrix}1 & 1 & ( K - 1 ) D + {θ}_{x} \\ 1 & 1 & ( K - 1 ) D + {θ}_{y}\end{matrix} ]$$

| | Algorithm 1 |
|---|---|
| | Require: Floating and fixed image pyarmids A, B |
| | Learning rate γ |
| | Momentum weights τ₁, τ₂ |
| | L2 weight ω |
| | Normalized gradient measurement [symbol] (·) |
| 1 | $Initialize affine parameters {p}_{0} = [ \begin{matrix}1 & 0 & 0 \\ 0 & 1 & 0\end{matrix} ]$ |
| 2 | Make image pyramid [symbol] , [symbol] from A, B |
| 3 | Initialize first momentum m [symbol] , second moment v₀ |
| 4 | Initialize translation offsets θ [symbol] ← 0, θ_{y} ← 0 |
| 5 | Maximum DoF ρ [symbol] ← 2/(1 − τ₂) − 1 |
| 6 | for t ← 1 to Iterations by 1 do |
| 7 | \| Parameter transfer to p [symbol] for [symbol] [symbol] with θ [symbol] and θ [symbol] |
| 8 | \| L [symbol] ← [symbol] ( [symbol] , [symbol] : [symbol] [symbol] ) // Calculate Loss |
| 9 | \| // RSGD starts here |
| 10 | \| g [symbol] ← ∇ₚ(L [symbol] ) // Calculate loss derivative |
| 11 | \| g [symbol] ← g [symbol] + ω · p [symbol] // L2 regularization |
| 12 | \| m [symbol] ← τ₁m [symbol] + (1 −τ₁)g [symbol] |
| 13 | $\vert v \text{?} ← {τ}_{2} v \text{?} + ( 1 - {τ}_{2} ) g \text{?}$ |
| 14 | $\vert ρ \text{?} ← ρ \text{?} - 2 t \text{?} / ( 1 - \text{?} ) // Current DoF$ |
| 15 | \| if ρ [symbol] > 4 then |
| 16 | $\vert \vert r \text{?} ← \sqrt{\frac{( ρ \text{?} - 4 ) ( ρ \text{?} - 2 ) ρ \text{?}}{( ρ \text{?} - 4 ) ( ρ \text{?} - 2 ) ρ \text{?}}}$ |
| 17 | \| \| v [symbol] ← \sqrt{1/(v + ε)} |
| 18 | \| \| // Parameter update with rectification term |
| 19 | \| \| p [symbol] ← p [symbol] − γ · r [symbol] · m [symbol] · v [symbol] |
| 20 | \| else |
| 21 | \| └ p [symbol] ← p [symbol] − γ · g [symbol] // Warmup with SGD |
| 22 | \| // Update translation offsets |
| 23 | \| θₓ ← θ [symbol] −γ∇ [symbol] (L [symbol] ) |
| 24 | \| θ [symbol] ← θ_{y} −γ∇ [symbol] (L [symbol] ) |
| 25 | └ γ ← 0.999 · γ // learning rate decay |
| 26 | $Obtain p \text{?} by Eq . ( A \text{.23} ) with θ \text{?} and {θ}_{y}$ |
| 27 | $return p \text{?}$ |

[symbol]

indicates data missing or illegible when filed

### Experimental Results of MOIR on Public Datasets

Two group of datasets, i.e. controlled and real-world datasets, were constructed to validate the registration performance of MOIR and recent baselines. The descriptions of the experimental datasets are described as follows. First, the controlled dataset contains 9 pixel-level aligned pairs of visible and thermal images from public datasets [A. Toet, “The TNO multiband image data collection,” Data in Brief, vol. 15, pp. 249-251, dec 2017., X. Jia, C. Zhu, M. Li, W. Tang, and W. Zhou, “Livip: A visible-infrared paired dataset for low-light vision,” in Proceedings of the IEEE/CVF International Conference on Computer Vision, 2021, pp. 3496-3504]. In this study, four levels of pre-defined affine transformation are imposed to these pairs for validation of the proposed MOIR. Specifically, the four affine parameters are listed as follows:

$$\begin{matrix}A 1 = [ 0.99 , 0.05 , - 2 , 0.05 , 0.99 , - 2 ] \\ A 2 = [ 1.02 , 0.03 , - 4 , - 0.03 , 0.98 , - 4 ] \\ A 3 = [ 0.98 , 0.03 , - 8 , - 0.03 , 1.01 , - 8 ] \\ A 4 = [ 0.97 , 0.04 , - 10 , - 0.04 , 0.97 , - 10 ]\end{matrix}$$

where the A=[a₁,a₂, tₓ,a₃,aₜ, t_{y}]. All the levels of deformation in this test were applied to the visible images as the floating image while the corresponding thermal images are selected as the fixed image. Beyond the controlled dataset, there is a real-world dataset that contains random selective VI-T images from unaligned CVC14 [A. Gonz'alez, Z. Fang, Y. Socarras, J. Serrat, D. V'azquez, J. Xu, and A. L'opez, “Pedestrian detection at day/night time with visible and FIR cameras: A comparison,” Sensors, vol. 16, no. 6, p. 820, jun 2016], CVC15 [F. Barrera, F. Lumbreras, and A. D. Sappa, “Multispectral piecewise planar stereo using manhattan-world assumption,” Pattern Recognition Letters, vol. 34, no. 1, pp. 52-61, jan 2013] and FLIR [FLIR Systems Inc, “Flir thermal dataset for algorithm training,” https://www.flir.ca/oem/adas/adas-dataset-form/, 2020, (Accessed: Apr. 9, 2021)] datasets in order to verify the generalization of the proposed MOIR. The true deformations of these samples are manually labeled resulting in different affine matrices. In addition, the visible images are resized to 640×512 to match the resolution of thermal images in FLIR. In this study, the controlled dataset is initially used to find the suitable hyper-parameters for the proposed MOIR. Then, the comparative studies of baselines and MOIR are conducted on both controlled and real-world datasets. The statistics of the experimental data are presented in Table 15. In addition, the “Manual Label” deformation indicates that the true affine parameters are derived by manual annotations.

TABLE 15

| Group | Sub-Group | Deformation | # of Pairs | Size |
|---|---|---|---|---|
| Controlled | Controlled | A1 | 9 | 620 × 450 |
| | | A2 | 9 | 620 × 450 |
| | | A3 | 9 | 620 × 450 |
| | | A4 | 9 | 620 × 450 |
| Real-world | CVC14 | Manual Label | 100 | 640 × 471 |
| | CVC15 | Manual Label | 100 | 506 × 408 |
| | FLIR | Manual Label | 50 | 640 × 512 |

Three metrics were employed to evaluate the accuracy of registration in pixel-level, i.e. normalized root mean square error (NRMSE), structure similarity (SSIM) and peak signal-to-noise ration (PSNR). Specifically, NRMSE aims to measure the difference between the registered floating image \hat{Z}=A∘p and the corresponding ground truth Z. The smaller NRMSE reflects the better registration performance. The NRMSE can be formulated as

$$NRMSE ( \hat{Z} , Z ) = \sqrt{\frac{{\sum }_{i = 1}^{N} {( {\hat{Z}}_{i} - {Z}_{i} )}^{2}}{{\sum }_{i = 1}^{N} {Z}^{2}}}$$

where N are the numbers of pixels in an image. Meanwhile, the SSIM and PSNR aim to measure the similarity between \hat{Z} and Z in terms of image structure and signal quality. The higher values of SSIM and PSNR indicates the better registration performance. Their formulations are listed below:

$$SSIM ( \hat{Z} , Z ) = \frac{( 2 {μ}_{\hat{Z}} {μ}_{Z} + {c}_{1} ) ( 2 {σ}_{\hat{Z} Z} + {c}_{2} )}{( {μ}_{\hat{Z}}^{2} + {μ}_{Z}^{2} + {c}_{1} ) ) ( {σ}_{\hat{Z}}^{2} + {σ}_{Z}^{2} + {c}_{2} )}$$

$$PSNR ( \hat{Z} , Z ) = 10 {log}_{10} ( \frac{N \times {MAX}_{i}}{{\sum }_{i = 1}^{N} {( {\hat{Z}}_{i} - {Z}_{i} )}^{2}} )$$

where μ and σ are the mean and standard deviation; c1 and c2 are the empirical constant that can be found in Z. Wang and A. C. Bovik, “Mean squared error: Love it or leave it? a new look at signal fidelity measures,” IEEE Signal Processing Magazine, vol. 26, no. 1, pp. 98-117, 2009; MAX is the maximum pixel values of Z. More details of the evaluations can be found in Z. Wang and A. C. Bovik, “Mean squared error: Love it or leave it? a new look at signal fidelity measures,” IEEE Signal Processing Magazine, vol. 26, no. 1, pp. 98-117, 2009.

### Experimental Setup

Six alternative registration method, NTG [S.-J. Chen, H.-L. Shen, C. Li, and J. H. Xin, “Normalized total gradient: A new measure for multispectral image registration,” IEEE Transactions on Image Processing, vol. 27, no. 3, pp. 1297-1310, March 2018], SCB [S.-Y. Cao, H.-L. Shen, S.-J. Chen, and C. Li, “Boosting structure consistency for multispectral and multimodal image registration,” IEEE Transactions on Image Processing, vol. 29, pp. 5147-5162, 2020], MI [Y. D. Chenna, P. Ghassemi, T. Pfefer, J. Casamento, and Q. Wang, “Free-form deformation approach for registration of visible and infrared facial images in fever screening,” Sensors, vol. 18, no. 2, p. 125, January 2018], LoFTR [J. Sun, Z. Shen, Y. Wang, H. Bao, and X. Zhou, “Loftr: Detector-free local feature matching with transformers,” in 2021 IEEE/CVF Conference on Computer Vision and Pattern Recognition (CVPR), 2021, pp. 8918-8927], ORB [E. Rublee, V. Rabaud, K. Konolige, and G. Bradski, “ORB: An efficient alternative to SIFT or SURF,” in 2011 International Conference on Computer Vision, November 2011, pp. 2564-2571], CSIFT [Q. Zeng, J. Adu, J. Liu, J. Yang, Y. Xu, and M. Gong, “Real-time adaptive visible and infrared image registration based on morphological gradient and c SIFT,” Journal of Real-Time Image Processing, vol. 17, no. 5, pp. 1103-1115, March 2019] and NEMAR [M. Arar, Y. Ginger, D. Danon, A. H. Bermano, and D. Cohen-Or, “Unsupervised multi-modal image registration via geometry preserving image-to-image translation,” in 2020 IEEE/CVF Conference on Computer Vision and Pattern Recognition (CVPR), June 2020, pp. 1-10.], were selected to compare with the proposed MOIR. Specifically, the NTG and SCB are implemented based on the provided source codes (www.ivlab.org/publications) in MATLAB. The implementation of MI is scratched according to the original article MI. ORB and CSIFT were reproduced with the OpenCV package (2docs.opencv.org/4.x/dl/d89/tutorial py orb.html). Unlike the aforementioned methods, both LoFTR and NEMAR were developed based on deep learning which requires model training before implementation. In this study, NEMAR was directly trained on the original unaligned VI-T image pairs in experimental dataset under unsupervised manner. The network architecture of NEMAR is set as “affine stn” with default configurations in source codes (www.github.com/moabarar/nemar). In contrast to NEMAR, LoFTR requires supervised training to determine the matched points. Specifically, LoFTR offers two models pre-trained by largescale indoor (ScanNet (www.scan-net.org/)) and outdoor (MegaDepth (www.cs.cornell.edu/projects/megadepth)) datasets. Therefore, both indoor and outdoor variants of LoFTR are adopted and denoted as LoFTR-In and LoFTR-Out accordingly (kornia.readthedocs.io). For fair comparison, both variants are transferred to the adapt the VI-T pairs on the experimental datasets. Table 16 summarizes the compared alternative registration techniques.

TABLE 16

| Methods | Ref. | Category | Pre-Trained |
|---|---|---|---|
| LoFTR-In | [11] | Feature-based | ✓ |
| LoFTR-Out | [11] | Feature-based | ✓ |
| ORB | [112] | Feature-based | — |
| CSIFT | [111] | Feature-based | — |
| NTG | [9] | Intensity-based | — |
| MI | [8] | Intensity-based | — |
| SCB | [10] | Transform-based | — |
| NEMAR | [12] | Transform-based | ✓ |

Turning now to MOIR, in this example it was implemented in Pytorch as an auto-differential framework without any neural network module. The maximum iterations of MOIR and learning rate is set as 700 and 0.0012 accordingly. Meanwhile, the weights of first-order and second-order momentum τ₁ and τ₂ are 0.75 and 0.99 respectively. The weight of L2 regularization ω is 0.01. Both MOIR and baselines are tested on a workstation configured by Intel Xeon CPU, 32 GB RAM and Tesla GTX 3060 GPU.

### Algorithm Implementation on Controlled Dataset

Extensive experiments were conducted to investigate how MOIR components, i.e. NGM and RSGD, influence the registration performance of VI-T images in the controlled dataset. Meanwhile, the impacts of hyper-parameters (λ and β) and configurations of image pyramid were also investigated.

### Ablation Studies in NGM

Table 17 shows the ablation studies of the NGM module in MOIR with fixed hyper-parameters (λ=0.5, β=0.01). The initial observation is that the overall registration performance is similar between Angular Distance (AD) and Linear Distance (LD). Another interesting finding is that they performs differently on A1 and A2. The results confirm the aforementioned assumption that the two objective functions have distinct advantages on different kinds of image deformations. The integration of AD and LD can well balance their advantages resulting in improved registration quality over all deformations as shown in Table 17. Besides, additional GSR can further enhance the registration accuracy with lower NRMSE, higher SSIM and PSNR.

TABLE 17

| NGM | AD | ✓ | — | ✓ | ✓ |
|---|---|---|---|---|---|
| | LD | — | ✓ | ✓ | ✓ |
| | GSR | — | — | — | ✓ |
| A1 | NRMSE ↓ | 0.332 | 0.299 | 0.288 | 0.277 |
| | SSIM ↑ | 0.583 | 0.604 | 0.631 | 0.671 |
| | PSNR ↑ | 19.088 | 19.678 | 19.784 | 20.350 |
| A2 | NRMSE ↓ | 0.314 | 0.355 | 0.332 | 0.307 |
| | SSIM ↑ | 0.646 | 0.568 | 0.634 | 0.669 |
| | PSNR ↑ | 18.727 | 17.860 | 18.627 | 18.820 |
| A3 | NRMSE ↓ | 0.354 | 0.360 | 0.322 | 0.319 |
| | SSIM ↑ | 0.602 | 0.565 | 0.680 | 0.682 |
| | PSNR ↑ | 18.030 | 17.624 | 18.840 | 18.830 |
| A4 | NRMSE ↓ | 0.401 | 0.411 | 0.350 | 0.351 |
| | SSIM ↑ | 0.592 | 0.552 | 0.624 | 0.648 |
| | PSNR ↑ | 17.045 | 16.400 | 18.013 | 18.399 |
| Mean | NRMSE ↓ | 0.350 | 0.356 | 0.323 | 0.314 |
| | SSIM ↑ | 0.606 | 0.572 | 0.642 | 0.668 |
| | PSNR ↑ | 18.223 | 17.891 | 18.816 | 19.100 |

### Ablation Studies in RSGD

The evolution of NGM with different configurations of RSGD was considered. The first observation is that the vanilla SGD is struggling to converge with intensive oscillations before 1500 iterations. Additional momentum and L2 regularization can greatly accelerate and smooth the convergence before 500 iterations. However, the oscillation is still strong around 500th iteration, which needs to be smooth for stable solutions. Although the convergence is slower at first few iterations with VRT than without VRT, the loss rapidly decreases to reach the optimal point at the same iteration as SGD with momentum and L2 regularization. The additional VRT can reduce the fluctuation which help MOIR generate guaranteed affine parameters.

Impacts from Hyper-Parameters

TABLE 18

| λ | 0.1 | 0.2 | 0.3 | 0.4 | 0.5 | 0.6 | 0.7 | 0.8 | 0.9 |
|---|---|---|---|---|---|---|---|---|---|
| NRMSE ↓ | 0.338 | 0.329 | 0.327 | 0.324 | 0.314 | 0.318 | 0.320 | 0.317 | 0.337 |
| SSIM ↑ | 0.615 | 0.630 | 0.634 | 0.649 | 0.668 | 0.631 | 0.630 | 0.615 | 0.601 |
| PSNR ↑ | 18.473 | 18.608 | 18.583 | 18.706 | 19.100 | 18.787 | 18.639 | 18.635 | 18.237 |

Table 18 presents the comparative studies of registration evaluations on different measurement weights λ∈[0.1,0.9]. The results indicate that the proposed method achieves the best results when λ=0.5. It is reasonable to balance the impacts from AD and LD through equal weight assignment. Meanwhile, imbalanced measurement weight such as 0.1 and 0.9 slightly improves the registration performance. It indicates that the imbalanced weight cannot well integrate the advantages of AD and LD. Therefore, λ is set as 0.5 to equally weight the AD and LD for better integration. To derive the suitable β for GSR, this study also conducts extensive experiments through tuning the β. The NGM's evolution with various β was considered. Adding GSR with small β∈(0,1] can accelerate and stabilize NGM's convergence especially between 70th and 150th iteration. Based on these observations, in a test β was set as 0.01 due to its smooth convergence process.

### Comparative Results on Controlled Dataset

TABLE 19

| Method | | NTG | SCB | MI | LoFTR-In | LoFTR-Out | ORB | CSIFT | NEMAR | MOIR |
|---|---|---|---|---|---|---|---|---|---|---|
| A1 | NRMSE ↓ | 0.291 | 0.317 | 0.780 | 0.632 | 0.315 | 0.779 | 0.654 | 0.414 | 0.277 |
| | SSIM ↑ | 0.669 | 0.631 | 0.203 | 0.318 | 0.598 | 0.271 | 0.334 | 0.452 | 0.671 |
| | PSNR ↑ | 20.166 | 19.542 | 11.714 | 13.370 | 18.750 | 11.32 | 12.768 | 16.340 | 20.35 |
| A2 | NRMSE ↓ | 0.356 | 0.361 | 0.878 | 0.668 | 0.366 | 0.691 | 0.699 | 0.412 | 0.307 |
| | SSIM ↑ | 0.674 | 0.669 | 0.148 | 0.326 | 0.587 | 0.391 | 0.343 | 0.391 | 0.671 |
| | PSNR ↑ | 17.980 | 17.610 | 9.800 | 12.510 | 17.252 | 12.086 | 12.072 | 16.330 | 18.825 |
| A3 | NRMSE ↓ | 0.396 | 0.369 | 0.876 | 0.635 | 0.363 | 0.741 | 0.643 | 0.410 | 0.319 |
| | SSIM ↑ | 0.637 | 0.632 | 0.156 | 0.377 | 0.607 | 0.391 | 0.342 | 0.397 | 0.682 |
| | PSNR ↑ | 16.800 | 17.393 | 9.750 | 12.804 | 17.420 | 11.302 | 12.510 | 16.370 | 18.830 |
| A4 | NRMSE ↓ | 0.426 | 0.440 | 0.950 | 0.696 | 0.412 | 0.940 | 0.724 | 0.519 | 0.351 |
| | SSIM ↑ | 0.630 | 0.545 | 0.068 | 0.265 | 0.573 | 0.323 | 0.273 | 0.321 | 0.648 |
| | PSNR ↑ | 16.180 | 15.707 | 8.780 | 12.060 | 16.195 | 9.723 | 11.440 | 14.321 | 18.399 |
| Mean | NRMSE ↓ | 0.367 | 0.372 | 0.871 | 0.658 | 0.364 | 0.788 | 0.680 | 0.439 | 0.314 |
| | SSIM ↑ | 0.653 | 0.619 | 0.144 | 0.321 | 0.591 | 0.344 | 0.323 | 0.390 | 0.668 |
| | PSNR ↑ | 17.782 | 17.563 | 10.011 | 12.686 | 17.404 | 11.108 | 12.198 | 15.840 | 19.101 |

Table 19 shows the comparative results with various alternatives on the controlled dataset from A1 to A4 deformation. It is observed that the MOIR achieves the lowest NRMSE, highest SSIM and PSNR in average registration performance across all deformations, while the SSIM of MOIR is slightly lower than NTG under A2 deformation. Within the alternatives, NTG, SCB and LoFTR-Out greatly outperform the other alternatives considered with similar values in evaluation metrics. Both NTG and SCB can well align the pairs of A1 and A3. Nonetheless, they cannot align the examples of A2 and A4 well due to poor illumination of the visible image. Besides, LoFTR-Out is capable of registering the image pairs of all deformation due to its extremely large model capacity. However, the aligned visible images still have minor shifts from the thermal images resulting in lower mean SSIMs and PSNR compared with NTG and SCB as shown in Table A19. On the contrary, MOIR can precisely align the image pairs under these deformations.

Meanwhile, compared with similar baselines such as NTG and MI, the NRMSEs of MOIR do not significantly increase along with levels of deformation suggesting the robustness of MOIR. Pairs of aligned VI-T images were considered to generate measurement maps of ML, NTG and NGM with a common Normalized Cross Correlation (NCC) [M. Irani and P. Anandan, “Robust multi-sensor image alignment,” in Sixth International Conference on Computer Vision (IEEE Cat. No.98CH36271), 1998, pp. 959-966] as reference. The implemented NCC is applied to the original images directly. In addition, all the deformations are applied to the visible image. In a considered pair, the NCC failed in measuring the distance between floating visible image and fixed thermal image. Meanwhile, the MI has gentle slopes on the measurement map which makes it difficult to solve the affine parameters during optimization. On the contrary, the NTG and NGM have skewed slopes to help optimizers find the optimal point during iterations on the corresponding measurement maps. However, the flat bottom of NTG's measurement map may lead the optimizer to a local optimal point instead of the global optimal point. The proposed NGM's measurement map has a sharp bottom to assist optimizer in approaching global optimal point. Therefore, the MOIR can align the visible and thermal pairs well under various deformation. The above quantitative and qualitative evaluations verify that MOIR outperforms the baselines on the controlled dataset.

### Results on Real-World Dataset

TABLE 20

| | CVC14 | | | CVC15 | | | FLIR | | | Mean | | |
|---|---|---|---|---|---|---|---|---|---|---|---|---|
| Method | NRMSE ↓ | SSIM ↑ | PSNR ↑ | NRMSE ↓ | SSIM ↑ | PSNR ↑ | NRMSE ↓ | SSIM ↑ | PSNR ↑ | NRMSE ↓ | SSIM ↑ | PSNR ↑ |
| NTG | 0.267 | 0.714 | 18.364 | 0.344 | 0.718 | 19.160 | 0.100 | 0.777 | 25.960 | 0.237 | 0.736 | 21.161 |
| SCB | 0.254 | [symbol] | 18.548 | 0.344 | 0.728 | 19.960 | 0.184 | 0.660 | 21.940 | 0.261 | 0.704 | 20.149 |
| MI | 0.562 | 0.450 | 12.486 | 0.502 | 0.450 | 14.823 | 0.634 | 0.336 | 8.867 | 0.593 | 0.412 | 12.059 |
| LoFTR-In | 0.424 | 0.584 | 14.101 | 0.503 | 0.562 | 15.684 | 0.558 | [symbol] | 8.599 | 0.495 | 0.504 | 12.795 |
| LoFTR-Out | 0.259 | 0.744 | 18.000 | 0.350 | 0.708 | [symbol] | 0.089 | 0.769 | 25.070 | 0.233 | 0.740 | 20.773 |
| ORB | 0.654 | 0.440 | 9.320 | 0.807 | 0.449 | 11.730 | 0.524 | 0.414 | 9.110 | 0.662 | 0.434 | 10.053 |
| CSIFT | 0.638 | 0.434 | 9.980 | 0.747 | 0.475 | 12.320 | 0.471 | 0.466 | 10.490 | 0.615 | 0.458 | 10.930 |
| NEMAR | 0.258 | 0.717 | 18.601 | 0.353 | [symbol] | 19.500 | 0.201 | 0.600 | 18.260 | 0.271 | 0.669 | 18.807 |
| MOIR | 0.228 | 0.756 | 19.660 | 0.250 | 0.814 | 21.080 | 0.079 | 0.788 | 26.970 | 0.186 | 0.786 | 22.870 |

[symbol]

indicates data missing or illegible when filed

Table 20 presents the experimental results on the real-world dataset. All experimental methods can achieve improved performance on FLIR samples. The reason is that the FLIR samples are collected by an advanced multimodal camera (flir.ca/products/adk/?vertical=lwir&segment=oem) which can generate clearer thermal images. Turning to numerical results in Table 20, the MOIR outperforms the baselines over all three groups of the VI-T images. Compared with the best baseline LoFTR-Out [J. Sun, Z. Shen, Y. Wang, H. Bao, and X. Zhou, “Loftr: Detector-free local feature matching with transformers,” in 2021 IEEE/CVF Conference on Computer Vision and Pattern Recognition (CVPR), 2021, pp. 8918-8927], the MOIR achieves 20.2%, 6.1% and 10.0% improvement on mean NRMSE, SSIM and PSNR. Therefore, the numerical results confirms the benefits of the proposed MOIR in relation to the real-world dataset. In order to verify the robustness of MOIR, distributions of NRMSE, SSIM and PSNR from various baselines (NTG, SCB, LoFTR-Out and NEMAR) and MOIR were considered on the real-world dataset. The observation is that the boxes of MOIR are smaller compared with the other baselines. This confirms that the MOIR has stable performance over various VI-T images. Another aspect of the observation is that there are less outliers around the boxes of MOIR. Meanwhile, the outliers concentrate near the boxes, which indicates that MOIR can achieve higher accuracy in hard cases of the real-world dataset. The observation also suggests the robustness of proposed MOIR.

In addition to quantitative results, the registered examples of CVC14, CVC15 and FLIR from top-ranked baselines and MOIR were considered qualitatively for selected pairs.. Three considered VI-T pairs (P1, P2, P3) have minor shifts For example, a vehicle and traffic light in a first pair (P1) were not aligned. NTG, SCB and NEMAR fail in registering the P1. Although LoFTR-Out can align the vehicle and traffic light in P1, there is still minor shift between visible and thermal images. In contrast, the MOIR can fully register these objects.

Compared with the unregistered examples of CVC14, the deformation of CVC15 is larger. Both MOIR and LoFTR-Out can well align the P1 and P2. However, the LoFTR-Out is not able to register the characters in P3 while the rest of methods can achieve great registration. The observation also suggests the LoFTR-Out is lack of stability in multimodal image registration. The finding is also consistent to the results in the distributions where many outliers are near the NRMSE's and SSIM's boxes of LoFTR-Out. In terms of the proposed MOIR, it can perfectly register all the VI-T pairs P1, P2, P3.

Label examples of FLIR were also considered. The deformation is larger than CVC14 and CVC15. It is observed that the comparative baselines fail in aligning all of a selected set of pairs, while MOIR can fully register all the pairs. For example, none of baselines can balance the registration in a first pair. Specifically, the registration tends to focus on either a first or a second object. In contrast, the MOIR can balance the registration on these objects.

Although MOIR achieves useful performance in experiments, there are also hard cases that MOIR has difficulty to register from the real-world dataset. In one example, the motion blurs in the visible image prevents the MOIR from aligning the VI-T pair. Meanwhile, the label of another hard case indicates that deformation of VI-T pairs may be subject to perspective transformation which requires additional parameters to achieve correct registration. Another interesting discovery is the LoFTR-Out achieves satisfied registration performance for VI-T image with perspective transformation, while it fails in several pairs under affine transformation. The main reason is the lack of generalization due to the nature of deep learning methods like LoFTR-Out.

Without sufficient and appropriate training datasets, the performance of LoFTROut is not stable for VI-T image registration. Meanwhile, Table 21 to compare the computational time between the proposed MOIR and the top three baselines, i.e. NTG, SCB and LoFTR-Out, in this study. Compared with the iterative methods such as NTG and SCB, the MOIR achieves a comparable lower running time. However, compared with data-driven solutions such as LoFTR-Out, all the iterative methods are slower. It is because the method has a model storing millions of parameters for calculation without iterative optimization. However, compared with iterative methods such as the proposed MOIR, the LoFTR-Out needs to be pre-trained on numerous images (around 600 GB), which significantly increases the capital cost in training for real-world applications. Thus, a possible approach is the integration of LoFTR as a feature extractor and MOIR as objective functions for a balanced VI-T alignment.

TABLE 21

| Method | MOIR | NTG [9] | SCB [10] | LoFTR-Out [11] |
|---|---|---|---|---|
| Time (s)↓ | 12.196 | 17.564 | 9.711 | 1.284 |

### Tensor-Based Background Subtraction (TBBS) and Foreground Fusion-Based Gas Detection (FFBGD)

A new background subtraction, i.e. Tensor-based Background Subtraction (TBBS), is proposed to maintain the sensitivity in perceiving regions of potential ethane leaks through online tensor factorization and a finite-state machine. The generated sparse tensor can describe the motion information well by making the moving foregrounds salient between IR video frames. On the other hand, to precisely localize and classify the ethane leaks, an FFBGD is proposed to take the sparse tensor from TBBS and the original IR video frames for a balance performance via integration of various neural networks such as Deformable Convolution Network (DCN), a Foreground Fusion Network (FFN) as further described below and cascade ROI heads. Compared with contemporary research, the FFBGD achieves the highest values across most of the evaluations in ethane leak detection with considerable inference speed. Hence, the proposed FFBGD can enable petrochemical engineers to automatically detect ethane leaks and timely repair the infrastructures without manually scanning.

Tensor-based Background Subtraction (TBBS): The IR video frames and corresponding gradient map are combined as a single tensor, which is inspired by advances in tensor factorization based on multispectral video [C. Palmero, A. Clapes, C. Bahnsen, A. Mogelmose, T. B. Moeslund, and S. Escalera, “Multi-modal rgb-depth-thermal human body segmentation,” International Journal of Computer Vision, vol. 118, no. 2, pp. 217-239, 2016.]. Enhanced by edge information from image gradients, the foreground mask becomes more intact to cover the whole leakage foreground through tensor decomposition. Moreover, the model simultaneously processes two tensors, i.e., a short-term tensor and a long-term tensor. The short-term tensor updates the model based on the last video frame while the long-term tensor updates the model based on the previous N-th frame. Then, a Finite-state Machine (FSM) is applied to fuse the sparse tensor from the short-term and long-term tensors, which significantly mitigates the problem of vanishing foregrounds [K. Lin, S.-C. Chen, C.-S. Chen, D.-T. Lin, and Y.-P. Hung, “Abandoned object detection via temporal consistency modeling and back-tracing verification for visual surveillance,” IEEE Transactions on Information Forensics and Security, vol. 10, no. 7, pp. 1359-1370, July 2015].

Foreground Fusion-based Gas Detection (FFBGD): After TBBS, the sparse tensor (a 3-channel image with refined foregrounds) is extracted from the TBBS, amplifying the regions of ethane based on motion between video frames. Then, FFBGD processes the original IR and sparse tensor using a custom neural network for ethane leak detection. Specifically, the proposed FFBGD adopts a Deformable Convolution Network (DCN) to extract features from sparse tensor and IR images respectively. After DCN, a specific neural network, i.e. Foreground Fusion Network (FFN), is proposed to integrate these features from DCN to generate more discriminating features for detecting a gas leak inspired by a vision attention mechanism [S. Woo, J. Park, J.-Y. Lee, and I. S. Kweon, “Cbam: Convolutional block attention module,” in Proceedings of the European Conference on Computer Vision (ECCV), September 2018]. Therefore, regions of interest are resolved based on imagery and motion features, which are improved relative to pure BGS-based or deep learning-based detectors. After FFN, a Feature Pyramid Network (FPN) is developed to aggregate multi-scale information from fused features. Finally, a cascade ROI head [Z. Cai and N. Vasconcelos, “Cascade R-CNN: Delving into high quality object detection,” in 2018 IEEE/CVF Conference on Computer Vision and Pattern Recognition, June 2018] is adopted to ensemble multiple predictive heads to output the detection results of ethane leaks. Compared with contemporary methods, experimental results demonstrate the superior performance of the proposed FFBGD by achieving significant improvement in monitoring ethane leaks.

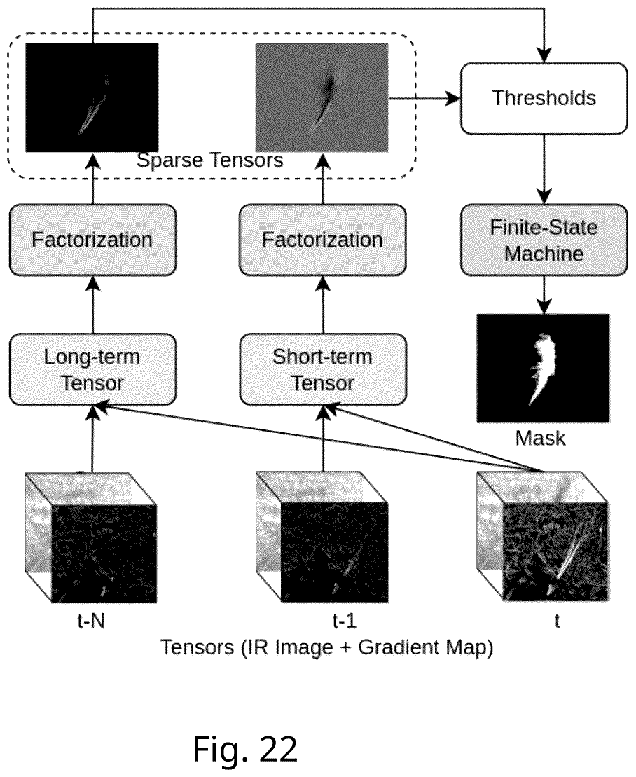

The proposed Tensor-based Background Subtraction (TBBS) is developed based on the tensor factorization with the image gradient [A. Sobral, S. Javed, S. K. Jung, T. Bouwmans, and E. hadi Zahzah, “Online stochastic tensor decomposition for background subtraction in multispectral video sequences,” in 2015 IEEE International Conference on Computer Vision Workshop (ICCVW), Santiago, December 2015, pp. 946-953]. Moreover, the proposed TBBS simultaneously factorizes a short-term tensor based on t and t−1 frames, and a long-term tensor based on t and t−N frames. Then, thresholds are applied to extract the mask of the ethane leak from sparse tensors. Finally, a Finite-state Machine (FSM) is designed to generate the ultimate masks from both the short-term and long-term tensors as shown in FIG. 22.

Tensor Factorization with Gradient Map

For an IR image I∈ [symbol] ^{H} as a gray image, it has a corresponding gradient map along with x-axis Gₓ and y-axis G_{y}, which can be derived through a convolution operation ⊙ using the Sobel operators defined as follows:

$$\begin{matrix}{G}_{x} = [ \begin{matrix}1 & 0 & - 1 \\ 2 & 0 & - 2 \\ 1 & 0 & - 1\end{matrix} ] ⊙ I & {G}_{y} = [ \begin{matrix}1 & 2 & 1 \\ 0 & 0 & 0 \\ - 1 & - 2 & - 1\end{matrix} ]\end{matrix} ⊙ I .$$

Therefore, a tensor Y can be formulated via concatenation as

$${\begin{matrix}Y = [ I , {G}_{x} , {G}_{y} ] & Y ∈\end{matrix}}^{W \times H \times 3}$$

where W and H are the width and height of the image.

Assuming a video contains ethane gas leakage foregrounds [symbol] in pixel-level, the tensor Y can be defined as a combination of low-rank tensor (background) [symbol] and the sparse tensor (foregrounds) [symbol] , i.e. [symbol] = [symbol] + [symbol] . Therefore, the general objective aims to derive the [symbol] from [symbol] as follows [A. Sobral, S. Javed, S. K. Jung, T. Bouwmans, and E. hadi Zahzah, “Online stochastic tensor decomposition for background subtraction in multispectral video sequences,” in 2015 IEEE International Conference on Computer Vision Workshop (ICCVW), Santiago, December 2015, pp. 946-953, J. Feng, H. Xu, and S. Yan, “Online robust pca via stochastic optimization,” in Advances in Neural Information Processing Systems 26, 2013, pp. 404-412]:

$${min}_{𝒳 , ℰ} \frac{1}{2} {‖ 𝒴 - 𝒳 - ℰ ‖}_{F}^{2} + {λ}_{1} {‖ 𝒳 ‖}_{*} + {λ}_{2} {‖ ℰ ‖}_{1}$$

where ∥⋅∥_{*} denotes the nuclear norm;

$${‖ \cdot ‖}_{F}^{2}$$

denotes the Frobenius norm; ∥⋅∥₁ denotes the [symbol] norm; λ₁ and λ₂ are weights assigned to the nuclear norm and [symbol] ₁ norm respectively. The values

$${λ}_{1} = \frac{1}{√ max ( size ( Y ) )}$$

and λ₂=λ₁ are used based on empirical study [34].

Equation (3.3) is only suitable for batch optimization, while the process of streaming video requires an online update mechanism. Nonetheless, the optimization of the nuclear norm is not convex in an online manner according to the proofs in A. Sobral, S. Javed, S. K. Jung, T. Bouwmans, and E. hadi Zahzah, “Online stochastic tensor ecomposition for background subtraction in multispectral video sequences,” in 2015 IEEE International Conference on Computer Vision Workshop (ICCVW), Santiago, December 2015, pp. 946-953, J. Feng, H. Xu, and S. Yan, “Online robust pca via stochastic optimization,” in Advances in Neural Information Processing Systems 26, 2013, pp. 404-412. To address the optimization problem, the [symbol] needs to be further decomposed as:

$${min}_{x , e} \frac{1}{3} {\sum }_{i = 1}^{3} ( \frac{1}{2} {‖ {y}_{i} - {L}_{i} {r}_{i} - {e}_{i} ‖}_{F}^{2} + {λ}_{i} ( {‖ {L}_{i} ‖}_{F}^{2} + {‖ {r}_{i} ‖}_{F}^{2} ) + {λ}_{2} {‖ {e}_{i} ‖}_{1} ) s . t . {x}_{i} = {L}_{i} {r}_{i}$$

where they yᵢ, xᵢ, eᵢ and rᵢ are the vectorized representation of [symbol] and Rᵢ in i-th model unfolding respectively [A. Sobral, S. Javed, S. K. Jung, T. Bouwmans, and E. hadi Zahzah, “Online stochastic tensor ecomposition for background subtraction in multispectral video sequences,” in 2015 IEEE International Conference on Computer Vision Workshop (ICCVW), Santiago, December 2015, pp. 946-953, J. Feng, H. Xu, and S. Yan, “Online robust pca via stochastic optimization,” in Advances in Neural Information Processing Systems 26, 2013, pp. 404-412]. The reformulated objective function (3.5) can be solved through online stochastic optimization without convex problem. More theoretical details can be found in J. Feng, H. Xu, and S. Yan, “Online robust pca via stochastic optimization,” in Advances in Neural Information Processing Systems 26, 2013, pp. 404-412.

In BGS, a tensor [symbol] ^{t} is processed at time tin an online manner. The coefficient vector

$${r}_{i}^{t} ,$$

sparse vector

$${e}_{i}^{t} ,$$

and basis matrix

$${L}_{i}^{t}$$

are optimized based on the tensor [symbol] ^{t} in terms of i-th mode unfolding. Firstly, the

$${r}_{i}^{t}$$

is updated by fixing

$${e}_{i}^{t} and {L}_{i}^{t}$$

$${r}_{i}^{t} = {( {( {L}_{i}^{( t - N )} )}^{⊤} {L}_{i}^{( t - N )} + {λ}_{1} I )}^{- 1} {( {L}_{i}^{( t - N )} )}^{⊤} ( {y}_{i}^{t} - {e}_{i}^{( t - N )} )$$

where I is the identity matrix;

$${e}_{i}^{( t - N )}$$

is the sparse vector in N frames ago with respect to i-th mode unfolding. After updating the

$${r}_{i}^{t} , {e}_{i}^{t}$$

is also updated based on

$${r}_{i}^{t}$$

as shown in in 3.5):

$${e}_{i}^{t} = sign ( {z}_{i}^{t} ) {( \vert {z}_{i}^{t} \vert - {λ}_{2} )}_{+}$$

where

$${z}_{i}^{t} = {y}_{i}^{t} - {L}_{i}^{( t - N )} {r}_{i}^{t}$$

is the solution for the [symbol] ₁-norm. Then, for deriving the updated basis matrix

$${L}_{i}^{t} ,$$

the block-coordinate descent is adopted to update the column of the basis matrix while locks the rest of the columns [A. Sobral, S. Javed, S. K. Jung, T. Bouwmans, and E. hadi Zahzah, “Online stochastic tensor decomposition for background subtraction in multispectral video sequences,” in 2015 IEEE International Conference on Computer Vision Workshop (ICCVW), Santiago, December 2015, pp. 946-953]. Assuming that there are two supporting metrics

$${A}_{i}^{( t - N )} and {B}_{i}^{( t - N )} ,$$

these metrics can be respectively updated by

$$\text{?} ← {A}_{i}^{( t - N )} \text{?} {( \text{?} )}^{T}$$

$$\text{?} ← {B}_{i}^{( t - N )} + ( \text{?} - \text{?} ) {( \text{?} )}^{T} .$$

$$\text{?} \text{indicates text missing or illegible when filed}$$

Algorithm 2 shows the process for updating the basis matrix L with

$${A}_{i}^{( t )} and {B}_{i}^{( t )} .$$

Additionally, the updated A, B, L metrics will be saved for the incoming video frame.

| | Algorithm 2 |
|---|---|
| | Input: L = [l₁, ... lᵣₐₙₖ] ∈ [symbol] ^{p×rank}, A = [a₁, ... , aᵣₐₙₖ] ∈ [symbol] ^{rank×rank}, |
| | B = [b₁, ... , bᵣₐₙₖ] ∈ [symbol] ^{p×rank} |
| 1 | Ã ← A + λ [symbol] I |
| 2 | for j = 1 : rank do |
| 3 | $⌊ \text{?} ← \frac{\text{?}}{\text{?}} ( {b}_{j} - L \text{?} ) + \text{?}$ |
| 4 | return L |

[symbol]

indicates data missing or illegible when filed

In this study, the implemented tensor [symbol] ^{t} has three dimensions. Therefore, a sparse tensor

$${ε}^{( t )} = [ {E}_{1}^{( t )} , {E}_{2}^{( t )} , {E}_{3}^{( t )} ]$$

can be obtained through reshaping and folding the corresponding sparse vector

$${e}_{i}^{( t )}$$

in three modes. Then, the sparse tensor

$$E = \frac{1}{3} {\sum }_{i = 1}^{3} ε$$

is an average of these three modes. Finally, the mask F can be derived via the hard threshold function as:

$$F = \{ \begin{matrix}1 & if ( 0.5 {E}^{2} > β ) \\ 0 & others\end{matrix}$$

where β=0.5σ(E)², and σ(.) denotes the standard deviation.

### Finite-State Machine

Recalling the overview of the background stage of the proposed TBBS as shown in FIG. 22, an FSM is designed to assemble the mask of short-term and long-term tensors, which is inspired by the abandoned object detection [K. Lin, S.-C. Chen, C.-S. Chen, D.-T. Lin, and Y.-P. Hung, “Abandoned object detection via temporal consistency modeling and back-tracing verification for visual surveillance,” IEEE Transactions on Information Forensics and Security, vol. 10, no. 7, pp. 1359-1370, July 2015]. A pixel of the mask of gas leakage may be represented as a two-bit code GLₖ, the GLₖ=F_{L}(k)F_{S}(k) can be regarded as concatenating masks from short-term tensor F_{S}(k) and long-term tensor F_{L}(k). Specifically, the F_{S}(k) represents the mask by factorizing [symbol] ^{(t-1)} while F_{S}(k) is derived by factorizing [symbol] ^{(t-N)}.

In the FSM, there are four states expressed as follows:
1. State 0 (background) indicates that the pixel belongs to the background.
2. State 1 (dynamic pixel) indicates that the pixel belongs to foreground due to the object movement, which may be the dynamic parts of the ethane leakage such as the tail of the gas leakage.
3. State 2 (candidate static pixel) indicates that the pixel may be a static foreground pixel.
4. State 3 (static pixel) means the pixel belongs to static foreground, which may be stationary parts of ethane gas leakage such as the body of the emission.

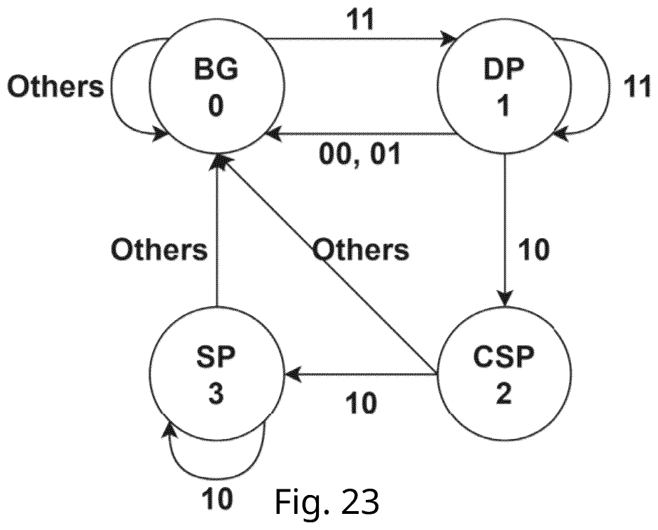

FIG. 23 shows the transition among states based on GLₖ. State 0 (background) may be considered the default state. The system is triggered when GLₖ=11, indicating that the ethane may have started leaking from the pipeline. The pixel is regarded as state 1, dynamic pixel (DP) if GLₖ=11. At DP state, if GLₖ=10, it indicates that the short-term tensor absorbs the k-th pixel to background while the long-term tensor still regards the k-th pixel as foreground. Therefore, the pixel state becomes state 2, candidate static pixel (CSP), indicating the pixel may be the object's stationary part. If the state continues as GLₖ=10, the pixel is regarded as a static pixel (SP) of the foreground, which is unveiled on the mask. The rest of the GLₖ values will turn the pixel back to the background (BG).

### Experimental Data Using Background Subtraction

In natural gas industries, ethane pipelines are usually exposed to the outdoor environment. Therefore, we constructed an experimental environment with a thermal surveillance camera and an ethane emitter at a grassland. A dynamic background is caused for example by a strong wind. To discover the impact of leakage distance to detection, we have taken three videos from 10 meters to 30 meters, as shown in Table 22. Each video is recorded for 1 minute, with approximately 30 seconds of leakage occurrence. Therefore, each video has 600 frames because the camera's frame rate is 10 frames per second. The statistics of the three videos are shown in Table 22. Finally, we labeled the region of leakage for further experiments in BGS and leakage detection. Both quantitative and qualitative evaluations are included to validate the feasibility of contemporary BGS methods concerning different distances. On the other hand, since ethane leakage is hazardous for the environment, BGS is best used not only to detect leakage but also to localize all potential regions of the ethane leakage from the image. Therefore, we choose Recall (RE) and F-Measure (FM) to evaluate the performance of BGS at the pixel-level [P.-L. St-Charles, G.-A. Bilodeau, and R. Bergevin, “SuBSENSE: A universal change detection method with local adaptive sensitivity,” IEEE Transactions on Image Processing, vol. 24, no. 1, pp. 359-373, January 2015].

TABLE 22

| Distance | Total Frames | Image Size | # of Leak Objects |
|---|---|---|---|
| 10 Meters | 600 | 640 × 512 | 313 |
| 20 Meters | 600 | 640 × 512 | 302 |
| 30 Meters | 600 | 640 × 512 | 300 |

### Experimental Results—Ablation Studies

TABLE 23

| Proposed Modules | | | | | | | | | |
|---|---|---|---|---|---|---|---|---|---|
| Image | | 10 Meters | | 20 Meters | | 30 Meters | | Average | |
| Gradient | FSM | RE | FM | RE | FM | RE | FM | RE | FM |
| — | — | 42.64 | 51.02 | 8.89 | 14.81 | 0.000 | 0.000 | 17.18 | 21.94 |
| Y | — | 72.08 | 61.98 | 57.61 | 41.70 | 9.780 | 12.78 | 46.49 | 38.82 |
| — | Y | 77.15 | 70.24 | 56.46 | 68.52 | 0.000 | 0.000 | 44.54 | 46.25 |
| Y | Y | 84.48 | 57.83 | 88.09 | 43.43 | 72.44 | 60.09 | 81.67 | 53.78 |

Table 23 presents the results of an ablation study to investigate the effectiveness of the image gradient and FSM. “Y” indicates that the corresponding module is implemented during experiment in both Table 23. The bold font indicates the best result in each column. With only thermal images, the proposed TBBS reaches 42.64% in RE and 71.24% in FM at 10 meters, as shown in Table 23. Although the BGS results are promising at 10 meters, the segmentation results severely deteriorate with increasing distance, as shown in Table 23.

After adding the image gradient during tensor factorization, the performance of BGS is significantly improved, as shown in Table 23. Specifically, the image gradient enables the proposed TBBS to discover the leakage foreground beyond 10 meters. The gradient foreground contains more details around the object edges. Therefore, the intact leakage foreground is more distinguishable from the background via tensor factorization. Although the sensitivity of the proposed TBBS is improved by adding image gradient maps, the performance is still poor at 30 meters due to the vanishing foreground.

Through observing Table 23, the proposed TBBS has significant improvement in RE and FM for leakage at 10 and 20 meters with FSM. Even if the leak is still emitting at the time, the mask from the short term sensor may not cover the intact region of the leakage. With complimentary information from the long-term tensor, the FSM generates a complete mask to cover the complete region of ethane leakage. However, the numerical results as shown in Table 23 suggest that the model can gain sensitivity with the addition of the image gradient.

Finally, both image gradient and FSM are added to form the proposed TBBS. Table 23 shows that the combination significantly improves the values of RE. Compared with purely using FSM, the combination has lower FM values at 10 meters and 20 meters. It is too risky and hazardous for industrial applications to miss any possible ethane leakage from the pipeline. Therefore, the combination of image gradient and FSM is preferred due to its ability to discover potential leakage. Moreover, the combination also enables the TBBS to achieve novel performance at 30 meters, resulting in higher values of RE and FM across different distances.

Comparison with Advanced Background Subtraction Methods

TABLE 24
The illustration of quantitative results in background subtraction

| | | 10 Meters | | 20 Meters | | 30 Meters | | Average | |
|---|---|---|---|---|---|---|---|---|---|
| Categories | Methods | RE | FM | RE | FM | RE | FM | RE | FM |
| Statistical | GMM | 51.11 | 51.64 | 22.78 | 17.73 | 10.85 | 8.530 | 28.25 | 25.97 |
| Models | ViBe | 19.74 | 32.76 | 5.290 | 10.00 | 0.000 | 0.000 | 8.340 | 14.25 |
| | KNN | 23.71 | 29.54 | 3.090 | 4.360 | 0.140 | 0.190 | 8.980 | 11.36 |
| | PBAS | 10.20 | 18.22 | 3.070 | 5.790 | 0.000 | 0.000 | 4.420 | 8.000 |
| | PAWCS | 0.650 | 1.290 | 3.070 | 5.790 | 0.000 | 0.000 | 1.240 | 2.360 |
| | SuBSENSE | 5.530 | 10.48 | 0.130 | 0.250 | 0.000 | 0.000 | 1.890 | 3.580 |
| | WeSamBE | 67.62 | 60.51 | 33.45 | 27.46 | 21.92 | 14.34 | 40.99 | 34.10 |
| Robust | ORPCA | 33.09 | 37.34 | 8.810 | 7.900 | 0.000 | 0.000 | 13.97 | 15.08 |
| Subspace | GRASTA | 44.47 | 50.15 | 22.80 | 22.61 | 0.910 | 1.350 | 22.73 | 24.70 |
| | RPCA | 33.49 | 44.35 | 4.180 | 7.460 | 1.900 | 3.580 | 13.19 | 18.46 |
| | SPCP | 10.46 | 18.30 | 0.000 | 0.000 | 0.000 | 0.000 | 3.490 | 6.100 |
| | OMoGMF | 33.59 | 44.74 | 26.01 | 21.75 | 25.54 | 17.26 | 28.38 | 27.91 |
| | GraphBGS | 25.60 | 30.34 | 14.27 | 11.87 | 1.610 | 1.630 | 13.83 | 14.61 |
| Deep | DNMF | 44.02 | 43.22 | 34.51 | 23.93 | 42.40 | 19.15 | 40.31 | 28.77 |
| Learning | DeepPBM | 6.870 | 7.190 | 14.91 | 2.090 | 57.42 | 6.570 | 26.40 | 5.280 |
| | BSUV-net | 24.09 | 33.87 | 9.380 | 13.10 | 40.12 | 29.89 | 24.53 | 25.62 |
| Proposed | TBBS | 84.48 | 57.83 | 88.09 | 43.43 | 72.44 | 60.09 | 81.67 | 53.78 |
| Method | | | | | | | | | |

The proposed TBBS is compared in Table 24 with existing methods, which are derived from three categories, i.e., statistical modeling, robust subspace and deep learning. WeSamBE has the best performance among the statistical models. Nonetheless, the performance of WeSamBE severely degraded along with increasing distance between camera and the leakage. Similar to the methods in robust subspace, recent advances such as OMoGMF and GraphBGS are not sufficiently sensitive to perceive the foreground of the leakage beyond 20 meters. In contrast, the deep learning methods have better scores of RE and FM in extracting leakage foreground from IR images. DNMF especially has stable performance with leak distance. Nonetheless, the average RE of DNMF only reaches 40.31, which is difficult to satisfy the industrial requirement. Compared with the baselines in Table 24, the proposed TBBS has 16.86%, 62.07% and 69.74% improvement of RE scores for distances of 10 to 30 meters. Moreover, the average FM scores of the TBBS is 53.78%, which indicates the robustness of TBBS in terms of background subtraction.

For better validating the effectiveness of comparative models, segmentation results were determined with respect to leak distance and time, specifically at time t representing the time of leak occurrence and t+100 which indicates the next frame after 100 frames. In the experiment, WeSamBE [S. Jiang and X. Lu, “WeSamBE: A weight-sample-based method for background subtraction,” IEEE Transactions on Circuits and Systems for Video Technology, vol. 28, no. 9, pp. 2105-2115, September 2018], OMoGMF [H. Yong, D. Meng, W. Zuo, and L. Zhang, “Robust online matrix factorization for dynamic background subtraction,” IEEE Transactions on Pattern Analysis and Machine Intelligence, vol. 40, no. 7, pp. 1726-1740, July 2018] and DNMF [G. Trigeorgis, K. Bousmalis, S. Zafeiriou, and B. W. Schuller, “A deep matrix factorization method for learning attribute representations,” IEEE Transactions on Pattern Analysis and Machine Intelligence, vol. 39, no. 3, pp. 417-429, March 2017] were selected for a qualitative comparison as to which are the best methods with respect to the distances and times shown. For an example leak at 10 and 20 meters, all baseline methods and proposed TBBS can accurately separate the leak foreground at the beginning of the emission. However, parts of the foregrounds are absorbed into the background due to model updating. Besides, the baseline method cannot segment the full foreground when the pipeline starts emitting at 30 meters. The proposed TBBS is sensitive to locate the leakage foreground beyond 20 meters. The proposed TBBS can also sustain the foregrounds throughout the video streaming.

### Application Limitation of TBBS

The proposed TBBS has demonstrated its effectiveness in ethane leak detection in rural areas over various contemporary baselines. If the TBBS is directly deployed to monitor ethane leaks in petrochemical industries, the sensitivity is indeed improved the chances of the perception of leaks. However, it can also bring numerous false alarms without proper manipulation in the leakage refinement stage. After the TBBS, the generated masks are derived from the factorized sparse tensors with a pre-defined threshold as aforementioned. From this point of view, the masks cover many false pixels outside the regions of the ethane leaks. These false alarms are caused by various factors such as cloud cover, camera jitters and so on. Therefore, it is desired to better refine the regions of leaks from the extracted sparse tensor.

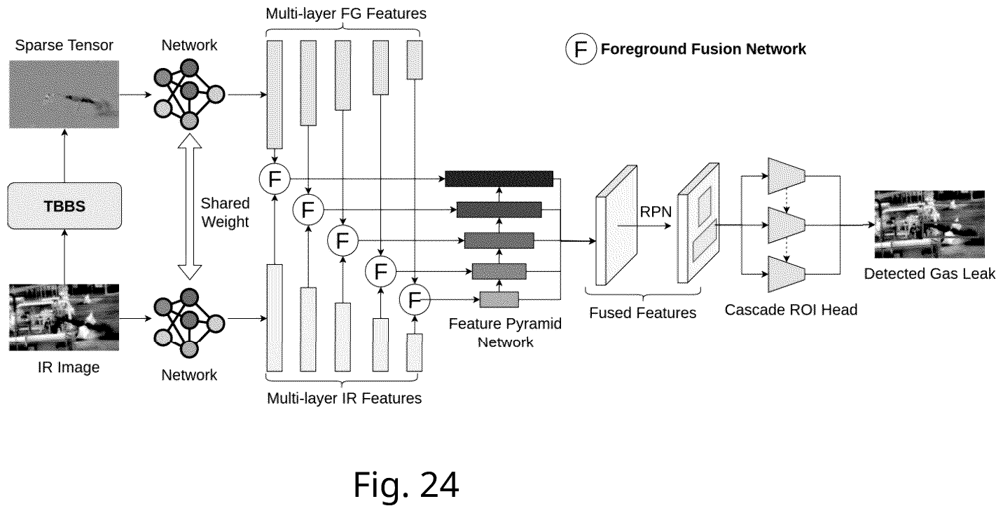

The TBBS proposed above can generate a sparse tensor emphasizing the regions of leaks based on the motion information among video frames, while the ultimate location of leaks still needs to be determined. Meanwhile, the information from the original IR frames should also be considered to enhance detection accuracy. In this regard, a Foreground Fusion-based Gas Detection (FFBGD) framework is developed and described below. An architecture of this framework is presented in FIG. 24. This motion-aware multimodal ethane leak detection (MMELD) takes an IR image and the sparse tensor from TBBS as inputs. Specifically, a Deformable Convolution Network (DCN) is implemented to extract multi-layer features from both IR images and sparse tensors. Then, the Foreground Fusion Network (FFN) is designed to fuse these multi-layer features inspired by a visual attention mechanism [S. Woo, J. Park, J.-Y. Lee, and I. S. Kweon, “Cbam: Convolutional block attention module,” in Proceedings of the European Conference on Computer Vision (ECCV), September 2018]. After FFN, the fused information is fed into a feature pyramid network to aggregate the multi-scale features [T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017]. These features will be used in a Region Proposal Network (RPN) for rough localization of the ethane leak. Finally, a cascade Region of Interest (ROI) head is developed to refine these proposals to output a final region of the ethane leak.

### Deformable Convolution Network

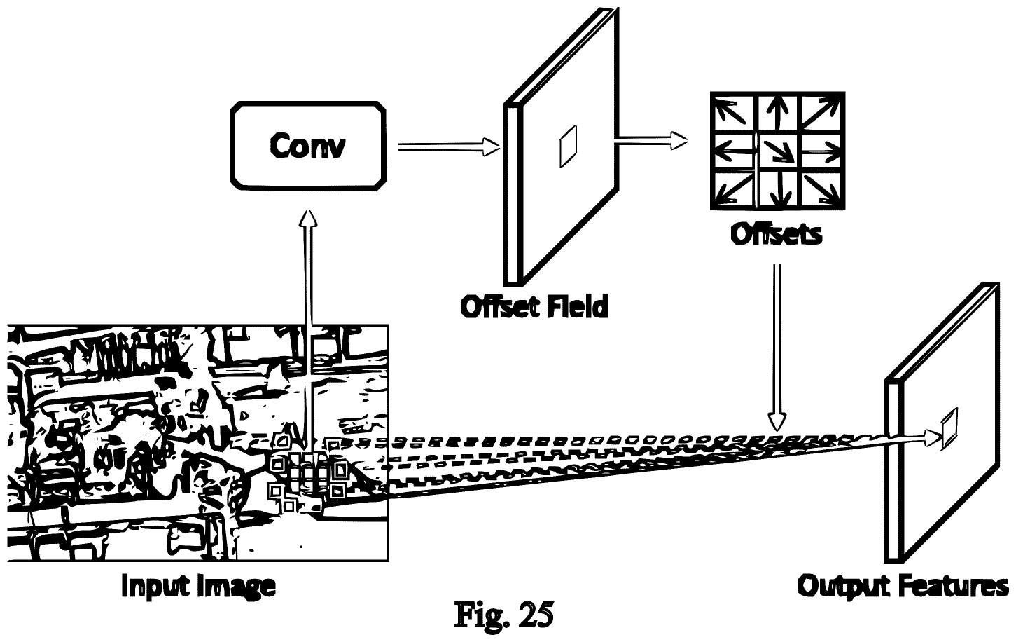

After TBBS, a Deformable Convolution Network (DCN) is developed to extract the IR and foreground (FG) features from IR images and sparse tensors, accordingly. Since the sparse tensors are derived from the IR images, the parameters of DCN for FG images may be as same as for the IR images, which is indicated as “shared weight” in FIG. 24. The shared-weight design can also reduce the computational cost during training and inference. The architecture of the implemented DCN is inspired by ResNet-50 [K. He, X. Zhang, S. Ren, and J. Sun, “Deep residual learning for image recognition,” in 2016 IEEE Conference on Computer Vision and Pattern Recognition (CVPR), June 2016] which is one of the most popular network designs for DNN-based object detection such as Faster RCNN and FPN [K. He, X. Zhang, S. Ren, and J. Sun, “Deep residual learning for image recognition,” in 2016 IEEE Conference on Computer Vision and Pattern Recognition (CVPR), June 2016, B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490]. Like ResNet-50, the example DCN as implemented also includes five residual blocks for processing images in the top-down pathway. The DCN outputs multilayer feature maps that are denoted as {C1, . . . , C5}. The numbers of channels are {64, 256, 512, 1024, 2048} in these feature maps. Both batch normalization (BN) and rectified linear units (ReLU) are implemented for all layers. The ethane objects have a strong shape variant which limits the classical convolution network such as ResNet-50 in gas leak detection. The problem is caused by the fixed sampling locations of convolution that are not flexible to adapt to the geometric transformation of non-rigid objects. To address the challenges, all standard convolution operators are replaced by the deformable convolution operators in residual blocks [X. Zhu, H. Hu, S. Lin, and J. Dai, “Deformable ConvNets v2: More deformable, better results,” in 2019 IEEE Conference on Computer Vision and Pattern Recognition (CVPR), June 2019]. Compared with standard convolution, the deformable convolution has learnable additional offset fields to automatically adjust the sampling locations during inference, as shown in FIG. 25. Given pₖ∈{(−1,−1), (−1,0), . . . , (1,1)} sampling locations of convolutional filters and features at location x(p) and weights of filters w, the formulation of the deformable convolution [X. Zhu, H. Hu, S. Lin, and J. Dai, “Deformable ConvNets v2: More deformable, better results,” in 2019 IEEE Conference on Computer Vision and Pattern Recognition (CVPR), June 2019] is

$${C}_{i} ( p ) = {\sum }_{k = 1}^{K} {w}_{k} \cdot X [ p + {p}_{k} \vert + Δ {p}_{k} ] \cdot Δ {m}_{k}$$

where K is the sampling locations of convolution filters; Δpₖ and Δmₖ are the offset field and the weights of sampling points, respectively; X[.] indicates the elements inside the image X. Compared with regular convolution network, the perceptive fields are dynamically changed through weighting the offsets, enabling the DNN to adapt to different gas shapes in IR images.

### Foreground Fusion Network

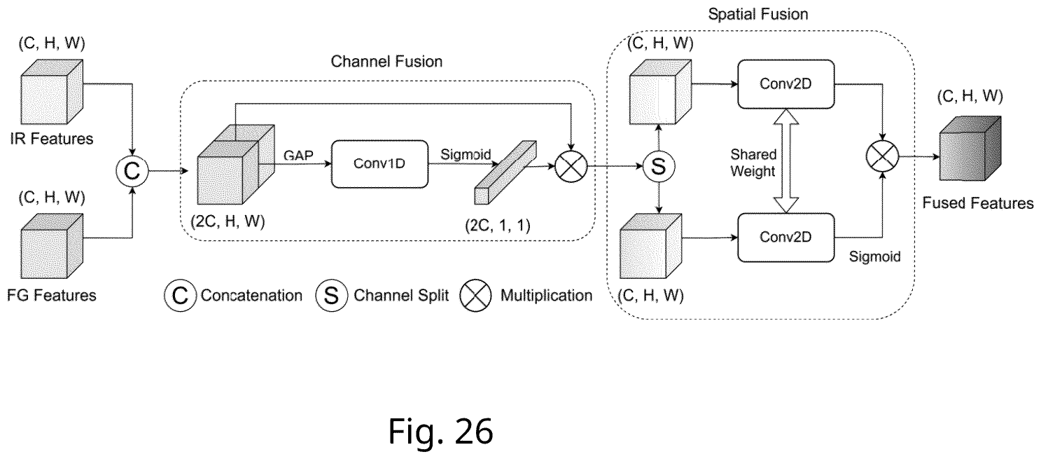

The sparse tensors, obtained by a background subtraction method such as TBBS have the regions of potential gas emission, while the original IR image has more context information for distinguishing these suspected regions. If the IR features and FG features (extracted from sparse tensors) are highly correlated in the same region, that region is highly likely to have a gas leak. The feature correlation can be derived through an attention mechanism [S. Woo, J. Park, J.-Y. Lee, and I. S. Kweon, “Cbam: Convolutional block attention module,” in Proceedings of the European Conference on Computer Vision (ECCV), September 2018][CBAM]. Inspired by recent advances such as Convolutional Block Attention Module (CBAM), the proposed FFN consists of two modules, channel fusion and spatial fusion, for obtaining feature correlation from different directions as shown in FIG. 26. Differing from the recent CBAM implementations, the proposed FFN focus on amplifying the IR features on correlated areas between IR and FG images.

For multi-layer IR features

$$\{ {C}_{1}^{IR} , … {C}_{5}^{IR} \}$$

and FG features

$$\{ {C}_{1}^{FG} , … , {C}_{5}^{FG} \} ,$$

the channel fusion of the i-th layer from IR features and FG features can be calculated by

$$\text{?} = Conv 1 D ( GAP ( [ {C}_{i}^{IR} , {C}_{i}^{FG} ] ) )$$

$${F}_{i}^{cha} = σ ( \text{?} ) \cdot [ {C}_{i}^{IR} , {C}_{i}^{FG} ]$$

$$\text{?} \text{indicates text missing or illegible when filed}$$

where

$${F}_{i}^{cha}$$

is the i-th layer feature map from after channel fusion; Conv1D is the one dimension standard convolution network with 3 as kernel size; GAP is global average pooling; [.] is concatenation; and

$$σ ( x ) = \frac{1}{1 + {e}^{- x}}$$

is the Sigmoid activation function. It is noticeable that the last two layers of features have over a thousand channels. The high dimensionality can damage the efficiency in drawing channel attention across two modalities with the original multi-layer perceptron (MLP) from S. Woo, J. Park, J.-Y. Lee, and I. S. Kweon, “Cbam: Convolutional block attention module,” in Proceedings of the European Conference on Computer Vision (ECCV), September 2018. Accordingly, the proposed FFN uses Conv1D to reduce the side effect of increasing numbers of channels.

After the channel fusion, the output multi-layer features

$$\{ {F}_{1}^{cha} , … , {F}_{5}^{cha} \} ,$$

are used for further spatial fusion. Since the FG images are refined from IR images, the proposed spatial fusion of FFN aims to use FG features to draw attention over IR feature maps other than all features in CBAM. The proposed spatial fusion first splits the concatenated features into IR and FG tensors, i.e.

$${S}_{i}^{IR} , {S}_{i}^{FG} .$$

Then, a shared weight 2D convolution is used to draw the invariant features from the two tensors. Finally, the FG tensor is constrained by Sigmoid and multiplied with IR tensor for final fused features Fi. The proposed spatial fusion is formulated as

$${S}_{i}^{IR} , {S}_{i}^{FG} = Split ( {F}_{i}^{cha} )$$

$${F}_{i} = Conv 2 D ( {S}_{i}^{IR} ) \cdot σ ( Conv 2 D ( {S}_{i}^{FG} ) )$$

where Conv2D is the two-dimensional convolution network with 3×3 as kernel size. The multi-layer fused features from the FFN are described as {F1, . . . , F5}.

### Feature Pyramid Network

A top-down structure with a lateral connection, such as FPN [Z. Cai and N. Vasconcelos, “Cascade R-CNN: Delving into high quality object detection,” in 2018 IEEE/CVF Conference on Computer Vision and Pattern Recognition, June 2018], can enhance the image features by aggregating information from different scales. The enhanced multi-scale features can better perceive the regions of liquefied natural gas. Therefore, an FPN is implemented after the FFN by the addition of upsampling features after 1×1 convolution layer from {F1, . . . , F5}. The implemented FPN can be formulated as

$${P}_{i} = \{ \begin{matrix}Conv 2 D ( {F}_{i} ) & i = 5 \\ UP ( {F}_{i + 1} ) + Conv 2 D ( {F}_{i} ) & i ∈ [ 1 , 4 ]\end{matrix}$$

where UP(.) is the 2× bilinear interpolation function. The outputs are denoted after the FPN as {P₁, . . . , P₅}.

### RPN and Cascade ROI Head

A region proposal network (RPN) [T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017] is developed to roughly search regions of interest (ROIs) for liquefied natural gas emission. Both RPN and cascade ROI head process the features of each stage in FPN with anchors of different sizes. The size of anchors is set as {322, 642, 1282, 2562, 5122} for corresponding outputs of {P1, P2, P3, P4, P5} from FPN. For RPN, the number of generated anchors is set as 1000 according to empirical reports [56, 93, 97]. Then, the features and proposals from RPN are fed into the ROI head for the final prediction of gas location and classification. As aforementioned, the geometric variants make the regions of gas indistinguishable from the image background. The standard ROI head uses a single intersection of union (IoU) threshold value u=0.5, which is quite a loose requirement and thus likely to cause false detection. To mitigate this, the cascade ROI head is constructed by integrating three ROI heads {H₁, H₂, H₃} trained with IOU thresholds {0.5, 0.6, 0.7} as shown in FIG. 15. The three consecutive ROI heads iteratively refine the proposals from RPN with increasing IoU thresholds. Therefore, the generated bounding boxes from the cascade ROI head are tight to the regions of ethane. Meanwhile, the precisely localized bounding boxes also improve the classification accuracy. Thus, the cascade ROI head can improve the quality of natural gas emission detection.

### Training Procedure for FFBGD

The loss function [symbol] of training the FFBGD consists of the loss of RPN [symbol] _{RPN} and the multi-head loss [symbol] _{MH} for cascaded ROI head of the prediction. Specifically, the [symbol] _{RPN} aims to train the RPN to generate coarse proposals that indicate where the objects belong to the image foreground. In this regard, the [symbol] _{RPN} consists of a classification loss [symbol] _{cls} and a regression loss [symbol] _{reg} for optimizing coarse proposals. These equations are formulated as shown below:

$${ℒ}_{cls} ( p , {p}^{*} ) = - {p}^{*} log ( p ) + ( {p}^{*} - 1 ) log ( 1 - p )$$

$${ℒ}_{reg} ( t , {t}^{*} ) = t - {t}^{*}$$

$${ℒ}_{RPN} = {ℒ}_{cls} ( p , {p}^{*} ) + {ℒ}_{reg} ( t , {t}^{*} )$$

where (p, t) and (p*, t*) are the predictive and true classification and location of foregrounds respectively.

Then, as aforementioned, the proposals will be further processed to have final bounding boxes through the cascade ROI head. The [symbol] _{MH} to progressively optimize each ROI head under different IOU thresholds u [Z. Cai and N. Vasconcelos, “Cascade R-CNN: Delving into high quality object detection,” in 2018 IEEE/CVF Conference on Computer Vision and Pattern Recognition, June 2018]. Like [symbol] _{RPN}, the [symbol] _{MH} also implements the conventional classification and regression losses during training phase. In addition, the [symbol] _{MH} calculates the losses from all the ROI heads. Specifically, for three IoU thresholds ui∈[0.5, 0.6, 0.7], the multi-head loss can be formulated as:

$${ℒ}_{MH} = {{\sum }_{i = 1}}^{3} {ℒ}_{cls} ( {D}_{i} ( {x}_{i} ) , {y}_{i} ) + [ {y}_{i} \leq 1 ] {ℒ}_{reg} ( {F}_{i} ( {x}_{i} , {b}_{i} ) , {y}_{i} )$$

where bᵢ=Fᵢ(xₜ₋₁,b^{t-1}) is the collection of proposals from the RPN or previous ROI head; [.] is the indicator function, and yᵢ is the label of xᵢ obeyed IOU threshold uᵢ. Thus, ROI heads are sequentially optimized during the training phase. Details of multi-head loss can be found in Z. Cai and N. Vasconcelos, “Cascade R-CNN: Delving into high quality object detection,” in 2018 IEEE/CVF Conference on Computer Vision and Pattern Recognition, June 2018.

Algorithm 3 illustrates an example training procedure of FFBGD which is similar to the general Cascade RCNN [Z. Cai and N. Vasconcelos, “Cascade R-CNN: Delving into high quality object detection,” in 2018 IEEE/CVF Conference on Computer Vision and Pattern Recognition, June 2018]. First, the sparse tensor is extracted by applying TBBS. Then, both IR images [symbol] and the sparse tensor FG are processed to generate fused features U. The RPN manipulates the fused features to generate coarse proposals. And, the [symbol] _{RPN} is used to calculate the loss between proposals and labels for optimizing RPN and networks of feature generation (DCN, FFN and FPN). Finally, the RPN is frozen to further train the cascade ROI head by applying [symbol] _{MH}. The losses of three ROI heads are summed to update their parameters jointly. Details of training cascade ROI head can be found in Z. Cai and N. Vasconcelos, “Cascade R-CNN: Delving into high quality object detection,” in 2018 IEEE/CVF Conference on Computer Vision and Pattern Recognition, June 2018.

Algorithm 3

| | | |
|---|---|---|
| Input | : | IR Video Frames [symbol] = [X₁,...,X_{N}] |

Labels [symbol] = [Y₁,...,Y_{N}]

| 1 | /*Background Subtraction */ | | |
|---|---|---|---|
| 2 | [symbol] ← TBBS( [symbol] ) where [symbol] = [S₁,...,S_{N}] | | |
| 3 | /*Feature Generation */ | | |
| 4 | U ← FPN(FFN(DCN( [symbol] ), DCN( [symbol] ))) | | |
| 5 | /* Region Proposal Network (RPN) */ | | |
| 6 | [symbol] ← RPN(U) | | |
| 7 | Calculate [symbol] _{RPN}( [symbol] , [symbol] ) and backward propagation | | |
| 8 | Freeze RPN for training cascade ROI heads | | |
| 9 | /*Cascade ROI Head */ | | |
| 10 | L ← 0 // Initialize loss variable | | |
| 11 | for i ← 1 to 3 by l do | | |
| 12 | \| | if if i = 1 then | |
| 13 | \| | \| | [symbol] ← Hᵢ(P,U) |
| 14 | \| | else | |
| 15 | \| | \|_{—} | [symbol] ← Hᵢ( [symbol] ₋₁,U) |

| | | |
|---|---|---|
| 16 | \|_{—} | L ← L + [symbol] _{MH}( [symbol] , [symbol] ) // Sequential update |

| | |
|---|---|
| 17 | Optimize the ROI head by minimizing L till converge |

### Performance Evaluation for FFBGD

For comparison between proposed FFBGD and baseline methods, COCO-style metrics are used [T.-Y. Lin, M. Maire, S. Belongie, J. Hays, P. Perona, D. Ramanan, P. Doll'ar, and C. L. Zitnick, “Microsoft COCO: Common objects in context,” in Computer Vision—ECCV 2014, 2014, pp. 740-755]. Specifically, mean average precision (mAP), AP at 50% (AP₅₀) and 75% (AP₇₅) of intersections of unions (IOU). AR₁, AR₁₀ and AR₁₀₀ denotes the average recall (AR) given 1, 10 and 100 detections per image. The model's efficiency was also considered, and evaluated in terms of frames per second (FPS).

Two train-test split schemes, i.e., random split and chronological split, were employed to evaluate both accuracy and robustness on the FFBGD and baseline methods [Z. Fu, C. Zhou, H. Yong, R. Jiang, X. Tian, Y. Chen, and X.-S. Hua, “Foreground gated network for surveillance object detection,” in 2018 IEEE Fourth International Conference on Multimedia Big Data (BigMM), September 2018] as illustrated in FIG. 16. The whole dataset was randomly split into a training set (70%) and a testing set (30%) under random split. The training set and testing set may have some images which are taken at the same location. The random split aims to evaluate the general model capacity of ethane leak detection. In contrast, the chronological split aims to split the dataset in half (50% training set and 50% testing set) according to where the videos were taken. Therefore, the training and testing sets are not correlated or under different distribution domains. The chronological split aims to validate the generalization of the trained detector on unseen images.

### Data Description for FFBGD Evaluation

The experimental dataset was collected from an existing petrochemical facility for training models. The dataset consists of 5352 8-bit 512×640 sampled images from IR videos, which were derived from optical gas imaging sensors. Professional technicians annotated all the regions of a gas leak in COCO format. Liquefied natural gas emissions have varying shapes due to variation of environmental factors such as wind speed. These videos are taken at multiple locations inside the same facility.

### Experimental Results for FFBGD Evaluation

### Framework Optimization

First, ablation experiments are presented to investigate the effectiveness of multi-modal inputs, backbone, FFN, and ROI head under random split as shown in Table 25. “✓” in Table 25 indicates that the corresponding input or component was implemented during the experiment. Specifically, the backbone experiments aim to investigate the impact of conventional CNN [S. Liu, M. Gao, V. John, Z. Liu, and E. Blasch, “Deep learning thermal image translation for night vision perception,” ACM Transactions on Intelligent Systems and Technology, vol. 12, no. 1, pp. 1-18, December 2020] and the exemplary implemented DCN [X. Zhu, H. Hu, S. Lin, and J. Dai, “Deformable ConvNets v2: More deformable, better results,” in 2019 IEEE Conference on Computer Vision and Pattern Recognition (CVPR), June 2019]. Meanwhile, the variants of ROI head, i.e. the normal ROI head [S. Ren, K. He, R. Girshick, and J. Sun, “Faster r-cnn: Towards real-time object detection with region proposal networks,” IEEE Transactions on Pattern Analysis and Machine Intelligence, vol. 39, no. 6, pp. 1137-1149, 2017] and the proposed mare also compared.

TABLE 25

| Input | | Backbone | | FFN | | ROI Head | | Evaluations | | |
|---|---|---|---|---|---|---|---|---|---|---|
| IR | Sparse | CNN | DCN | CF | SF | Normal | Cascade | mAP↑ | AP₅₀↑ | AP₇₅↑ |
| ✓ | — | ✓ | — | — | — | ✓ | — | 11.65 | 36.41 | 5.420 |
| — | ✓ | ✓ | — | — | — | ✓ | — | 14.05 | 44.70 | 5.142 |
| ✓ | ✓ | ✓ | — | ✓ | — | ✓ | — | 27.59 | 68.70 | 15.69 |
| ✓ | ✓ | — | ✓ | ✓ | — | ✓ | — | 29.57 | 70.52 | 16.71 |
| ✓ | ✓ | — | ✓ | — | ✓ | ✓ | — | 32.16 | 65.08 | 26.38 |
| ✓ | ✓ | — | ✓ | ✓ | ✓ | ✓ | — | 42.36 | 82.54 | 33.60 |
| ✓ | ✓ | — | ✓ | ✓ | ✓ | — | ✓ | 49.17 | 88.30 | 50.20 |

As shown in Table 25, compared with the model of solely IR input, using sparse tensors from TBBS as model inputs can improve accuracy in leak detection. The sparse tensor has a clean background that amplifies the pixels of gas emission. The amplified regions can help detectors to localize the liquefied natural gas emission. The sparse tensor may also include unexpected objects that damage the detection performance which is an inherent flaw in BGS. In an example the detector falsely detects a person and a tent as gas leaks. Adding image context from original IR images can reduce the side effect. After adding IR images, the false detected objects are removed in some examples. Using both IR and sparse tensor as inputs can achieve 53% improvement in AP₅₀ as illustrated in Table 25, which suggests combining both modalities is useful in gas leak detection.

As discussed above, ethane leaks are challenging to detect due to their non-rigid properties. Under the same setting in FFN and ROI head, the DCN can further improve the mAP, AP₅₀, AP₇₅ to 29.58, 70.52 and 16.71 respectively as shown in Table 25 as compared with 27.59, 68.70, and 15.69 respectively for a standard CNN in ResNet-50 albeit unconventionally using both IR and foreground inputs as with the DCN. This suggests the DCN can improve the performance by adjusting receptive fields for perceiving geometric transform in ethane leak detection. On the other hand, the effectiveness of spatial fusion (SF) and channel fusion (CF) modules in the FFN are also investigated, as illustrated in Table 25. Compared with single-modal results, both spatial fusion and channel fusion can improve the detector's performance. Compared with the channel fusion, the spatial fusion has higher AP₇₅. The result reflects that spatial fusion can help FFBGD achieve more precise localization of leak regions. However, spatial fusion has lower AP₅₀ than channel fusion. This means the implementation of channel fusion has more proposals around leaks from RPN, but the proposals are not as precise as the model equipped with spatial fusion. Combining spatial fusion and channel fusion in FFN can help FFBGD generate more proposals around the leak and reserve good quality in final detection. The combination can boost the mAP from 29.57 to 42.36, which achieves 30% improvement compared with the channel fusion implementation. Finally, the implementation of the Cascade ROI head can bring 13% improvement in mAP compared with the normal ROI head in S. Ren, K. He, R. Girshick, and J. Sun, “Faster r-cnn: Towards real-time object detection with region proposal networks,” IEEE Transactions on Pattern Analysis and Machine Intelligence, vol. 39, no. 6, pp. 1137-1149, 2017. Moreover, the significant improvement in AP₇₅ suggests that the cascade ROI head can generate tighter proposals in ethane leak detection.

The trade-off between detection accuracy and inference speed under varied numbers of proposals from RPN was also investigated. The mAP increases with more numbers of proposals while the FPS decreases. The decrements of FPS are much steeper after 50 proposals while the increments of mAP are slow. Therefore, 50 proposals are recommended to have balanced performance on FFBGD with moderate detection accuracy and faster inference speed. The finding provides us with a faster version of FFBGD denoted as FFBGD-P50 for liquefied natural gas leak detection.

The effectiveness of FFN compared with other fusion operators in SD scheme without including Cascade ROI head was also evaluated. Four baseline fusion operators, i.e. addition, embedding, cross non-local network (CNL) [L. Chi, G. Tian, Y. Mu, and Q. Tian, “Two-stream video classification with cross-modality attention,” in 2019 IEEE/CVF International Conference on Computer Vision Workshop (ICCVW), 2019, pp. 4511-4520] and CBAM [S. Woo, J. Park, J.-Y. Lee, and I. S. Kweon, “Cbam: Convolutional block attention module,” in Proceedings of the European Conference on Computer Vision (ECCV), September 2018] are selected to compare with our FFN. The proposed FFN consistently outperforms the other fusion operators over all other tested evaluation metrics in the context of the architecture tested.

TABLE 26

| | | Random Split | | | | | | Chronological Split | | | | | |
|---|---|---|---|---|---|---|---|---|---|---|---|---|---|
| Methods | Input | mAP↑ | AP₅₀↑ | AP₇₅↑ | AR₁↑ | AR₁₀↑ | AR₁₀₀↑ | mAP↑ | AP₅₀↑ | AP₇₅↑ | AR₁↑ | AR₁₀↑ | AR₁₀₀↑ |
| [symbol] | | | | | | | | | | | | | |
| [symbol] | IR | 11.48 | 35.42 | 5.318 | 18.20 | 20.18 | 20.18 | 10.24 | 22.32 | 3.970 | 12.33 | [symbol] | [symbol] |
| TBLD | [symbol] | 12.48 | 40.58 | 5.410 | 20.48 | 20.48 | 20.48 | 11.57 | 34.89 | 5.840 | 18.39 | 18.95 | 18.95 |
| [symbol] | | | | | | | | | | | | | |
| [symbol] | IR | 3.502 | 17.38 | [symbol] | [symbol] | 27.30 | 27.30 | 1.970 | [symbol] | [symbol] | [symbol] | 15.50 | [symbol] |
| [symbol] | IR | 8.988 | 24.48 | 4.129 | [symbol] | 27.60 | 31.90 | 11.00 | 26.08 | [symbol] | [symbol] | [symbol] | [symbol] |
| FPN | IR | 11.65 | 36.41 | 5.420 | 18.20 | 20.60 | 20.60 | 10.49 | [symbol] | [symbol] | [symbol] | [symbol] | 14.60 |
| DCR | IR | 17.81 | 48.91 | 10.12 | 23.70 | 23.00 | 23.00 | 1.967 | 4.976 | 0.596 | 8.000 | 8.000 | 8.000 |
| [symbol] | | | | | | | | | | | | | |
| [symbol] | [symbol] | 16.06 | 53.70 | 10.12 | 23.70 | 23.90 | 23.90 | 12.38 | 40.38 | 7.950 | 25.50 | 25.50 | 25.30 |
| MMTOD | [symbol] | 15.06 | 54.87 | [symbol] | 26.10 | 28.70 | 28.70 | 10.08 | [symbol] | [symbol] | 27.10 | 29.40 | 29.40 |
| UIF | [symbol] | 18.87 | 58.36 | [symbol] | [symbol] | 30.90 | 30.90 | 12.77 | [symbol] | [symbol] | 24.90 | 24.90 | 24.90 |
| FGRR | [symbol] | 36.13 | 72.28 | [symbol] | 42.10 | 44.55 | 44.55 | 27.34 | [symbol] | 24.01 | 30.14 | 30.14 | 30.14 |
| [symbol] | | | | | | | | | | | | | |
| FFBGD-P50 | [symbol] | 47.87 | 84.44 | [symbol] | [symbol] | 55.10 | 55.10 | 25.21 | [symbol] | 14.12 | 32.90 | 33.10 | 33.10 |
| FFBGD | [symbol] | 49.17 | 88.31 | 50.20 | [symbol] | 58.20 | [symbol] | 28.58 | [symbol] | 17.96 | 38.70 | 39.10 | 39.10 |

[symbol]

indicates data missing or illegible when filed

Comparison with State-of-the-Art Frameworks

Table 26 summarizes the comparison of comprehensive detection performance with other methods in object detection and gas leak detection. Specifically, the comparative baseline models are categorized into three groups, i.e. OGI, single-modal, multi-modal. The OGI includes two recent optical gas leak detection methods, [J. Shi, Y. Chang, C. Xu, F. Khan, G. Chen, and C. Li, “Rea-time leak detection using an infrared camera and faster r-cnn technique,” Computers & Chemical Engineering, vol. 135, p. 106780, 2020, and J. Bin, C. A. Rahman, S. Rogers, and Z. Liu, “Tensor-based approach for liquefied natural gas leakage detection from surveillance thermal cameras: A feasibility study in rural areas,” IEEE Transactions on Industrial Informatics, vol. 17, no. 12, pp. 8122-8130, December 2021]. Besides, “without motion” methods include detection methods that only take IR images as input, while “with motion” methods include the methods which are capable of taking both IR and sparse tensors as inputs. For “without motion” methods, T.-Y. Lin, P. Goyal, R. Girshick, K. He, and P. Doll'ar, “Focal loss for dense object detection,” IE EE Transactions on Pattern Analysis and Machine Intelligence, vol. 42, no. 2, pp. 318-327, 2020, T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017, B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490, and Z. Cai and N. Vasconcelos, “Cascade R-CNN: Delving into high quality object detection,” in 2018 IEEE/CVF Conference on Computer Vision and Pattern Recognition, June 2018 are selected for comparison. On the other hand, recent “with motion” object detectors, i.e., C. Devaguptapu, N. Akolekar, M. M. Sharma, and V. N. Balasubramanian, “Borrow from anywhere: Pseudo multi-modal object detection in thermal imagery,” in 2019 IEEE/CVF Conference on Computer Vision and Pattern Recognition Workshops (CVPRW), June 2019, S. Liu, H. Liu, V. John, Z. Liu, and E. Blasch, “Enhanced situation awareness through CNN-based deep multimodal image fusion,” Optical Engineering, vol. 59, no. 05, p. 1, May 2020, F. Farahnakian and J. Heikkonen, “Deep learning based multi-modal fusion architectures for maritime vessel detection,” Remote Sensing, vol. 12, no. 16, pp. 1-17, 2020, and Z. Fu, Y. Chen, H. Yong, R. Jiang, L. Zhang, and X. Hua, Foreground gating and background refining network for surveillance object detection,” IEEE Transactions on Image Processing, vol. 28, no. 12, pp. 6077-6090, December 2019 are selected to compare with the proposed FFBGD and FFBGD-P50.

In the “without motion” methods, most of the baseline methods such as RetinaNet, Cascade RCNN, and FPN struggle detect ethane emissions from thermal surveillance cameras. Recent gas leak detection framework, i.e., J. Bin, C. A. Rahman, S. Rogers, and Z. Liu, “Tensor-based approach for liquefied natural gas leakage detection from surveillance thermal cameras: A feasibility study in rural areas,” IEEE Transactions on Industrial Informatics, vol. 17, no. 12, pp. 8122-8130, December 2021, and J. Shi, Y. Chang, C. Xu, F. Khan, G. Chen, and C. Li, “Real-time leak detection using an infrared camera and faster r-cnn technique,” Computers & Chemical Engineering, vol. 135, p. 106780, 2020, combines BGS and ResNet-50 for improved performance. Besides, DCR also takes advantage of DCN, resulting in a better performance from IR images. On the other hand, “with motion” methods combine advantages of IR and sparse, which generally have better detection performance than both OGI and single-modal methods. Through observation, these methods have a higher recall, reducing the possibility of missing potential leak regions enhanced by motion. Thus, “with motion” methods have a more balanced performance in detecting liquefied natural gas leaks. Compared with current multimodal methods, the proposed FFBGD reaches the best performance in both precision and recall. Compared with the FGBR [Z. Fu, Y. Chen, H. Yong, R. Jiang, L. Zhang, and X. Hua, “Foreground gating and background refining network for surveillance object detection,” IEEE Transactions on Image Processing, vol. 28, no. 12, pp. 6077-6090, December 2019], both FFBGD and FFBGD-P50 have achieved significant improvement under the random split.

In this experiment, the compared methods were also trained under the chronological split. In this split, the images in the testing set are not correlated to images in the training set. It is noticeable that all detectors encounter severe degradation on performance. It is observed that some single-modal detectors such as Cascade RCNN have better precision. Nonetheless, the strong degradation of recall still indicates that the single-modal method is unstable for unseen scenarios. On the contrary, the “with motion” methods have less degradation on both precision and recall. In multi-modal methods, the FGBR has better performance in AP₇₅ than FFBGD-series models. However, the FGBR has lower recall than proposed models.

The result indicates that the proposed FFBGD-series has lower risk in missing gas leak which is crucial to safety-critical energy industries. Besides, the FFBGD has a higher mAP than FGBR. It indicates that the FFBGD still outperforms the FGBR.

In a detection example from the testing set as analyzed by FGBR, FFBGD-P50 and FFBGD in comparison to the ground truth from human labeling, where. the experimental scene is not included in the SI training set, FGBR fails to detect the gas emission from the IR images. On the contrary, both FFBGDP50 and FFBGD can localize partial leak regions. With more proposals from RPN, the FFBGD can localize most parts of the leak, although the shape of the bounding box is not as same as the ground truth. Therefore, the FFBGD-series frameworks are better than FGBR in the example.

TABLE 27

| Methods | FPS↑ |
|---|---|
| Faster RCNN | 16.66 |
| TBLD | 3.33 |
| RetinaNet | 23.2 |
| Cascade RCNN | 15.86 |
| FPN | 18.86 |
| DCR | 17.18 |
| DenseFuse | 9.08 |
| MMTOD | 8.79 |
| DIF | 16.47 |
| FGBR | 7.52 |
| FFBGD-P50 | 15.15 |
| FFBGD | 12.81 |

Table 27 also presents the comparison of running speed between the proposed FFBGD and baselines. Although “without motion” methods are faster than other groups of techniques, their detection quality is too bad to apply to industrial applications. Compared with “with motion” methods, the FFBGD is better than MMTOD, DenseFuse, and FGBR, while it is still slower than DIF. After reducing the number of proposals, the FFBGD-P50 can have a similar FPS to DIF while retaining good detection quality in ethane leak detection.

Ethane Leak Detection from Surveillance Multimodal Imaging

Despite the performance brought by the FFBGD framework described above, the system described above still has room to improve due to the properties of IR images. Compared with visual (VI) images, the IR cameras can solely perceive the objects according to their ambient temperatures, resulting in images that lacks semantic information such as objects' textures and colors. Without the semantic information, the ethane leak has similar pixel values to other background objects that have similar temperatures in IR images. Thus, it is challenging to distinguish the ethane leak in the IR image by LDAR surveyors, which may also limit the performance of IR-based computational models for ethane leak detection. In this regard, the semantic information of the VI image may compensate for the disadvantage of IR imaging. However, pure VI-based ethane leak detection is not reliable for the petrochemical industries because winds, fogs, and other climate phenomena can also generate vapor. Detecting leaks solely by the generated vapor can result in many false alarms in moist weather after deployment. In summary, IR-based and VI-based systems have unique advantages in ethane leak detection. In this regard, multimodal imaging is favorable to perceiving and detecting ethane through fusing information from VI and IR images. However, no relevant related studies have been reported to develop or adopt multimodal imaging devices for automatic ethane leak detection.

Beyond ethane leak detection, multimodal imaging devices have been widely adopted in many application domains such as autonomous driving, salient object detection, and so on. Contemporary multimodal frameworks are capable of fusing VI and IR images at feature-level to achieve better performance in corresponding applications than unimodal frameworks. To achieve the feature-level fusion, these frameworks require pixel-level aligned visible and infrared (VI-IR) image pairs as inputs. However, the VI-IR images are usually unaligned due to the difference in spectral characteristics. Thus, a registration of the VI-IR images is expected before applying multimodal frameworks to the images.

Recent multimodal frameworks concentrate on employing vision attention mechanisms to achieve feature-level fusion. Within the variants of vision attention, the recent Vision Transformer (ViT) achieves astonishing performance in information fusion through matrix multiplication in Multi-head Attention (MHA) for aggregating global representations [A. Prakash, K. Chitta, and A. Geiger, “Multi-modal fusion transformer for end-to-end autonomous driving,” in 2021 IEEE/CVF Conference on Computer Vision and Pattern Recognition (CVPR), June 2021, pp. 7073-7083, and L. Chi, G. Tian, Y. Mu, and Q. Tian, “Two-stream video classification with cross-modality attention,” in 2019 IEEE/CVF International Conference on Computer Vision Workshop (ICCVW), 2019, pp. 4511-4520]. Despite the improved fusion effectiveness brought by MHA, the serial productions in MHA also intensively increase the framework's complexity causing high latency and memory occupation during information fusion. The inefficient design of MHA limits the viability of ViT for deployment in real-world scenarios such as ethane leak detection.

Therefore, there are proposed the following methods to address the above challenges.

### Multi-Objective Optimization-Based Image Registration (MOIR)

MOIR is an algorithm to register VI-IR images based on multi-objective optimization. MOIR considers both angular and linear distances during the registration process, which greatly improves the alignment accuracy. Extensive experiments on public datasets demonstrate the generalization of MOIR.

### Vision Fourier-Based Ethane Detection (VFTED)

Once the VI-IR images are aligned by MOIR, these images are fed into the proposed VFTED to detect ethane leaks. The VFTED has a new vision attention module, i.e. Vision Fourier Transformer (VFT), to efficiently fuse heterogeneous features from VI and IR images under log-linear complexity. Meanwhile, a Fourier Multi-layer Perceptron (FMLP) is created to model the complex numbers after Fast Fourier Transform (FFT) and fuse the cross-domain representations from the image frequency. Finally, the VFT employs a mixing layer to mix the positional information to enhance fused features in a global manner. The experimental results verify that multimodal imaging can significantly improve the detection performance for ethane leaks.

### Image Registration for Ethane Leak Surveillance—Algorithm Design

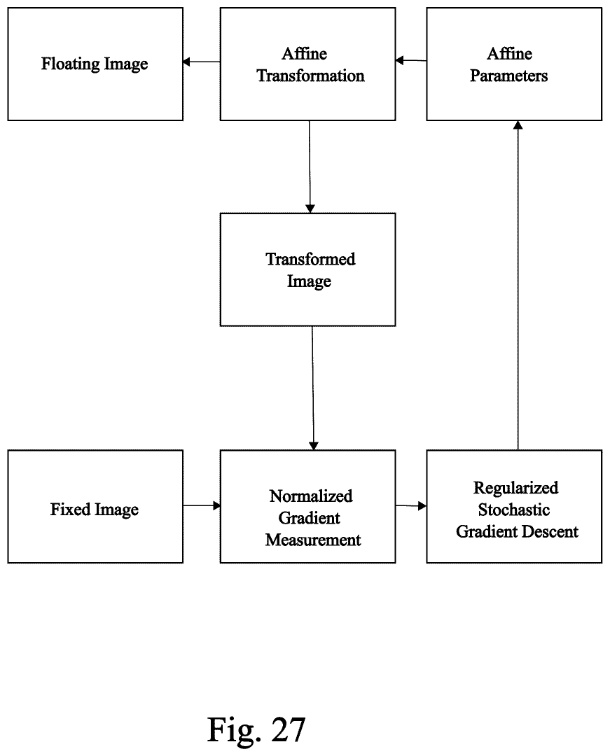

A Multi-objective Optimization-based Image Registration (MOIR) consists of two main components, i.e. Normalized Gradient Measurement (NGM) and Regularized Stochastic Gradient Descent (RSGD), to solve the affine parameters to align VI and IR images, as shown in FIG. 27. The NGM works as the objective function to measure the distance between gradients of floating images and fixed images. The NGM is comprised of Angular Distance (AD) and Linear Distance (LD) to measure the gradient difference from different perspectives, which also increases the accuracy of registration. Meanwhile, the conventional Stochastic Gradient Descent (SGD) is modified to RSGD with more advanced techniques in stochastic optimization, such as Variance Rectification Term (VRT) [L. Liu, H. Jiang, P. He, W. Chen, X. Liu, J. Gao, and J. Han, “On the variance of the adaptive learning rate and beyond,” in Proceedings of the Eighth International Conference on Learning Representations (ICLR 2020), April 2020, pp. 1-14]. Additionally, the MOIR, described above, can take either VI or IR images as floating images for the purpose of registration.

To show the effects of the registration in a human-recognizable manner, the registered VI and IR images may be merged to see if they are aligned via “color overlay” and “blend”. The “color overlay” is a conventional approach to merge two images. In this implementation, the VI image turns to green color while the IR image turns to pink. Then, the colored VI and IR image are directly merged together. Another “blend” combines the two images via the addition function in OpenCV. In an example, the objects' border in both “color overlay” and “blend” are well exhibited indicating a perfect registration between the VI and IR images. Thus, these registered image pairs enable us to investigate and apply feature-level fusion to multimodal imaging devices for ethane leak detection. MOIR was also evaluated on public datasets to demonstrate its generalization and novelty compared with contemporary registration methods, as discussed above.

### Vision Fourier Transformer for Multimodal Fusion

A vision transformer comprises a serial combination of Multi-Head Attention (MHA) and Multi-layer Perceptions (MLP) blocks to learn representations from images. Vision transformers are widely adopted in computer vision applications. Specifically, the images or features are split into several patches which are also named as “tokens” as same as words in natural language applications. Then, these tokens are fed into the MHA to calculate the vision attention. Finally, an MLP is used to refine the representations from the generated vision attention. The calculation of the MHA is derived through a scaled dot-product that can be formulated as follows [A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22]:

$$Q = {MLP}_{Q} ( E ) ; K = {MLP}_{K} ( E ) ; V = {MLP}_{V} ( E )$$

$$Attention ( Q , K , V ) = softmax ( \frac{{QK}^{T}}{\sqrt{{d}_{k}}} ) V$$

where E={e₁, . . . , e_{N}} is the collection of tokens from images or feature maps obtained by embedding functions [89]; [symbol] ,K,V are the query, key and values from corresponding MLPs; dₖ is the dimensionality of K. From the above equations, the vision attention is derived from serial matrix multiplications. The first matrix multiplication of Q and K aims to derive and scale the cosine similarities (or correlation) among all tokens, which is the source of global attention. The second matrix multiplication with V aims to enhance the representations based on the tokens' similarities. Although empirical studies confirm its capability in learning representations, the serial matrix multiplications of Q,K,V also significantly increase the computational complexity to O(n2).

### Fast Fourier Transform as Global Attention

The Fast Fourier Transform (FFT) is the Fourier transform applied to the discrete context, typically using the Cooley-Tukey algorithm. The the continuous, non-discrete Fourier Transform, shown as F below, and its inverse, shown as f below, as applied to a 2-dimensional image are

$$F ( u , v ) = {\int }_{∞}^{- ∞} {\int }_{∞}^{- ∞} f ( x , y ) {e}^{- j 2 π ( ux + vy )} dxdy$$

$$f ( x , y ) = {\int }_{∞}^{- ∞} {\int }_{∞}^{- ∞} F ( u , v ) {e}^{j 2 π ( ux + vy )} dudv$$

$${e}^{j 2 π ( ux + vy )} = cos 2 π ( ux + vy ) + j sin 2 π ( ux + vy )$$

where F(u, v) represents the features in frequency domain with (u, v) as axes; f(x, y) represents the features in spatial domain with (x, y) as axes. The FFT is a discrete version where x, y, u and v take discrete values. From this point of view, the FFT can be regarded as the integral of planar waves (or 2D sinusoidal signals) in the spatial domain. The magnitude of each coordinate of F(u, v) is related to the magnitude of a planar wave e^{j2π(ux+vy)} in a different frequency and direction and the complex phase of each coordinate corresponds to the phase of the respective planar wave. The image frequency F(u, v) can be treated as the global attention determining the concentration of various planar waves as tokens in an image. In this regard, the MHA can be replaced by FFT for extracting global attention. Meanwhile, compared with MHA, the FFT has O(n log(n)) in computational complexity, which is lower than the MHA. Thus, the purpose of the proposed framework aims to efficiently and effectively fuse the multimodal features for ethane leak detection based on the global attention in the frequency domain.

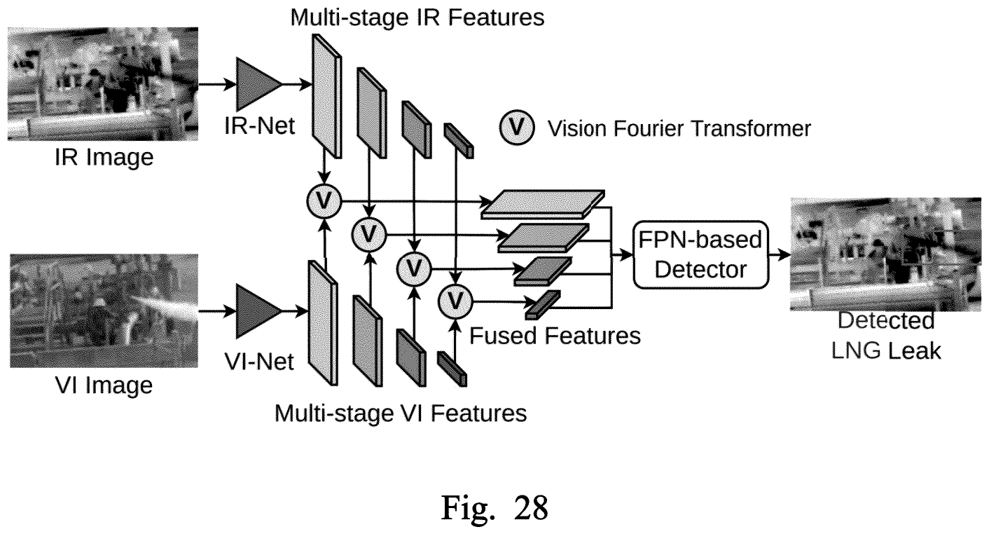

FIG. 28 shows the architecture of the proposed VFTED to fuse the features from registered VI and IR images for improved ethane leak detection. The overall framework is developed based on the feature pyramid network-based (FPN) object detection [T.-Y. Lin, P. Dollar, R. Girshick, K. He, B. Hariharan, and S. Belongie, “Feature pyramid networks for object detection,” in 2017 IEEE Conference on Computer Vision and Pattern Recognition (CVPR), July 2017] with additional dual backbones and multimodal fusion modules. First, two light-weighted backbones, i.e. IR-Net and VI-Net, extract the multi-stage features from IR and VI images respectively. Then, each IR feature is fused with the corresponding VI feature through the proposed vision Fourier transformer (VFT) inspired by the vision transformer (ViT). However, the VFT employs the concept of Fourier transforms to lower the computational complexity without degradation of detection performance on ethane leaks. Finally, the fused features are further processed, for example by an FPN-based detector, to achieve ethane detection. For example, a two-stage FPN-based detector may be used, e.g. Faster RCNN [90], to maximize the detection accuracy. A one-stage FPN-based detector, such as RetinaNet, may also be used as a faster alternative.

### Dual Backbones for Initial Feature Extraction

The proposed VFTED uses two backbones, IR-Net and VI-Net, to learn representations from IR and VI images. In an example, both backbones are developed based on ResNet-18 (R18) architecture [K. He, X. Zhang, S. Ren, and J. Sun, “Deep residual learning for image recognition,” in IEEE Conference on Computer Vision and Pattern Recognition (CVPR), 2016, pp. 770-778] which is the smallest model in the variations of ResNets. Since the dual backbones are required to model the multimodal inputs, larger variations such as ResNet-50 and ResNet-101 will make the model too heavy to converge during training. R18 has outputs of five stages denoted as {S₁, . . . , S₅} where the corresponding numbers of channels are {64, 64, 128, 256, 512}. The first-stage output S₁ is used to normalize and project the raw image to latent spaces with a simple convolution layer. The extracted representations are insufficiently processed for sophisticated manipulation such as multimodal fusion and ethane detection. Thus, in an example, only {S₂, S₃, S₄, S₅} are included in the further process.

### Vision Fourier Transformer for Multimodal Fusion

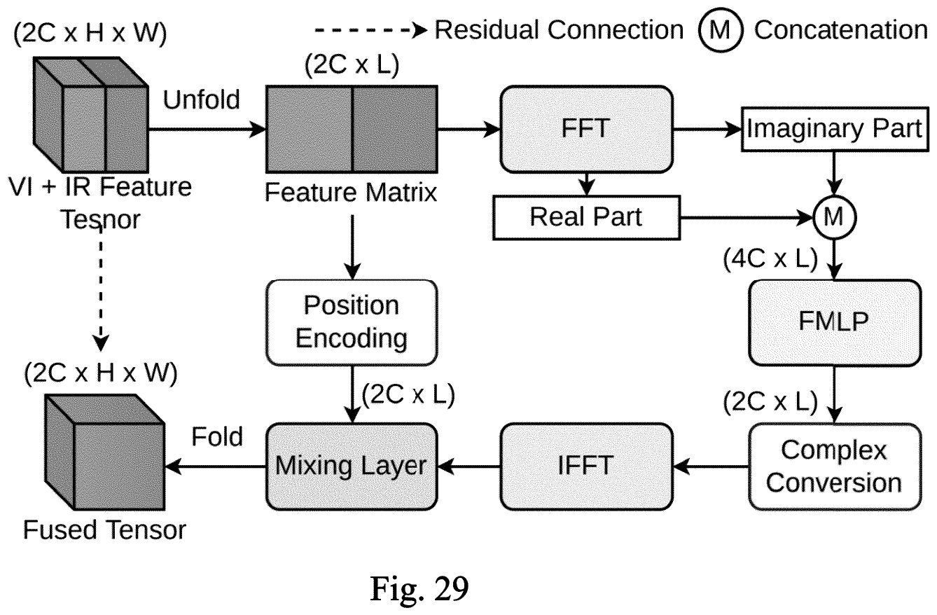

After deriving the VI and IR features from corresponding backbones, the proposed VFT will fuse these multimodal features at each stage. FIG. 29 shows the pipeline of the VFT. First, the VI and IR features are concatenated as a feature tensor denoted as [symbol] ∈ [symbol] ^{2C×H×W}. The C is the number of channels, while H and W are the height and width of the features from the aforementioned two backbones. The input feature tensor is unfolded into a single feature matrix X where the H and W collapse to feature-length, i.e. L=H×W. Since the spatial dimension is collapsed, the position encoding function is developed to describe the spatial location of elements on the feature matrix [A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22]. The position encoding function is an MLP that learns the encoding during optimization. Meanwhile, the FFT is applied to the feature matrix X to extract the global attention. The process is formulated as

$${Z}_{Re} + {jZ}_{Im} = FFT ( X ) {Z}_{Re} + {Z}_{Im} ∈ {ℝ}^{2 C \times L}$$

where the image frequency contains complex numbers. However, recent deep learning modules do not support the manipulation of complex numbers. To address this issue, the proposed VFT treats the real and imaginary parts as two individual real matrices. Specifically, the imaginary unit j is removed, but the values of imaginary numbers remain as real numbers. And, the values of real and imaginary parts are concatenated as one matrix, i.e. Z=[Z_{Re},Z_{Im}]∈ [symbol] ^{4C×L} which can be processed by deep learning modules. Since the Z contains raw image frequency from IR and VI features, a Fourier Multi-layer Perceptron (FMLP) is proposed to fuse the information in the frequency domain.

Recent transformers [A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22, W. Wang, E. Xie, X. Li, D.-P. Fan, K. Song, D. Liang, T. Lu, P. Luo, and L. Shao, “Pyramid vision transformer: A versatile backbone for dense prediction without convolutions,” in Proceedings of the IEEE/CVF International Conference on Computer Vision, 2021, pp. 568-578, and A. El-Nouby, H. Touvron, M. Caron, P. Bojanowski, M. Douze, A. Joulin, I. Laptev, N. Neverova, G. Synnaeve, J. Verbeek, and H. Jegou, “XCiT: Cross-covariance image transformers,” in Advances in Neural Information Processing Systems, 2021, pp. 1-14] adopt layer normalization that normalizes the features across channels and length directions. Nonetheless, the real and imaginary parts from VI and IR features are mixed in Z after the concatenation. Conventional layer normalization manipulates the real and imaginary parts together while the distributions of these parts are different. A separating normalization of them is suggested to adapt the distributions of real and imaginary parts accordingly, assisting the model's convergence and performance. Hereby, the FMLP initially normalizes the features channel-wise without mixing real and imaginary parts from VI and IR features. The channel-wise normalization is formulated as follows:

$$CN ( Z , k ) = \frac{{Z}^{( k )} - E ( {Z}^{( k )} )}{\sqrt{VAR ( {Z}^{( k )} )}} k ∈ [ 1 , 4 C ]$$

where E(.) and Var(.) are the mean and variance functions; k is the index of channel.

After the channel-wise normalization, the multimodal features are integrated and projected with a linear function in a length-wise manner.

The length-wise projection is formulated as

$$LP ( Z ) = {Z}^{T} W + b$$

where W∈ [symbol] ^{4C×4C} and b∈ [symbol] ^{4C×1} are the weights and biases. The length-wise projection fuses th I and IR information by mixing each planar wave at different frequencies. There are no non-linear activation units such as Rectified Linear Units (ReLU) and Gaussian Error Linear Unit (GELU) after the linear projection. The reason is that these additional activation units lead to all outputs being non-negative (in the case of ReLU) or restricted in the amount they can be negative (in the case of GELU). The derived image frequency has real and imaginary parts ranging from [−π,π]. Applied activation functions such as GELU truncate the essential information in the frequency domain. Finally, the output of FMLP is reformed as a complex matrix and converted into a matrix in the spatial domain through IFFT. The derived matrix is denoted as \hat{X}∈ [symbol] ^{(2C×L)}.

Similar to ViT, the proposed VFT also implements a mixing layer to refine the representations after IFFT. The mixing layer consists of an MLP [A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22], GELU, and layer normalization [A. Vaswani, N. Shazeer, N. Parmar, J. Uszkoreit, L. Jones, A. N. Gomez, L. u. Kaiser, and I. Polosukhin, “Attention is all you need,” in Advances in Neural Information Processing Systems, vol. 30, 2017, pp. 1-11], which follows the routine of conventional transformers [A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22, and W. Wang, E. Xie, X. Li, D.-P. Fan, K. Song, D. Liang, T. Lu, P. Luo, and L. Shao, “PVTv2: Improved baselines with pyramid vision transformer,” Computational Visual Media, vol. 8, no. 3, pp. 1-10, 2022.]. Finally, the output fused tensor adds the raw concatenated features tensor as residual connection, which assists the model in convergence [K. He, X. Zhang, S. Ren, and J. Sun, “Deep residual learning for image recognition,” in IEEE Conference on Computer Vision and Pattern Recognition (CVPR), 2016, pp. 770-778]. Specifically, the process carried out by the mixing layer can be formulated as follows:

$$PE = MLP ( X )$$

$$\hat{X} = GELU ( MLP ( LayerNorm ( \hat{X} + PE ) ) )$$

$$\hat{𝒳} = Fold ( \hat{X} ) + GELU ( Conv ( LN ( 𝒳 ) ) )$$

where Conv(.) is 1×1 convolution; PE is position encoding and \hat{χ} is the output fused tensor. The VFT is applied after every stage of the VI and IR backbones, which fuses the VI and IR features at different scales. Thus, there are four fused tensors {\hat{χ}₂, \hat{χ}₃, \hat{χ}₄, \hat{χ}₅} corresponding to {S₂, S₃, S₄, S₅} of IR-Net and VI-Net. The number of channels doubles after concatenation, resulting in {128, 256, 512, 1024} channels.

### FPN-Based Detector for Final Leak Detection

The Feature Pyramid Network (FPN) is a top-down structure that enhances image features by aggregating multi-scale information as shown in FIG. 12. For VFT outputs {\hat{χ}₂, \hat{χ}₃, \hat{χ}₄, \hat{χ}₅}, the FPN can be formulated as

$${P}_{i} = \{ \begin{matrix}Conv ( {\hat{𝒳}}_{i} ) & i = 5 \\ UP ( {\hat{𝒳}}_{i + 1} ) + Conv ( {\hat{𝒳}}_{i} ) & i ∈ [ 2 , 4 ]\end{matrix}$$

Where Conv(.) is a CNN with 1×1 kernel; UP(.) is the twice bilinear upsampling function. The outputs of FPN are denoted as {P₂, P₃, P₄, P₅} where the numbers of channels are set to {256, 256, 256, 256} based on empirical reports [152, 159]. Finally, these features are fed into detection heads in order to localize and classify the ethane on different scales. According to the nature of the detector, the FPN-based detection head can be categorized into one-stage and two-stage, as shown in FIGS. 13-14. The two and one-stage heads are described as follows:

Two-stage Head. The two-stage head may be developed, for example, based on the Faster RCNN [B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490]. An example two-stage head first employs a Region Proposal Network (RPN) to process the fused features from FPN. The RPN is a specific network to generate a set of coarse anchor boxes on where the ethane leak occurs. Then, the features inside the anchor boxes are extracted to refine the final positions of the ethane leaks via ROI align and an MLP classifier [K. He, G. Gkioxari, P. Doll'ar, and R. Girshick, “Mask r-cnn,” IEEE Transactions on Pattern Analysis and Machine Intelligence, vol. 42, no. 2, pp. 386-397, 2020].

One-stage Head. The one-stage head may be constructed, for example based on RetinaNet [T.-Y. Lin, P. Goyal, R. Girshick, K. He, and P. Doll'ar, “Focal loss for dense object detection,” IEEE Transactions on Pattern Analysis and Machine Intelligence, vol. 42, no. 2, pp. 318-327, 2020] which employs two identical networks, i.e. class subnet and box subnet, to directly distinguish and localize the ethane leaks from the fused features after FPN. The process excludes the RPN, reducing the computational loads. Thus, the one-stage head usually has a fast inference speed after deployment.

Empirical studies [Z.-Q. Zhao, P. Zheng, S.-T. Xu, and X. Wu, “Object detection with deep learning: A review,” IEEE Transactions on Neural Networks and Learning Systems, vol. 30, no. 11, pp. 3212-3232, 2019] report that two-stage head can maximize the chances of finding objects, which is crucial to safety-critical applications such as ethane detection. Thus, the two-stage FPN-based detector is set as the default detector in the experiments reported below. The term “VFTED” is used to denote the two-stage implementation. The one-stage version, referred to here as “VFTED-OS”, is a faster alternative.

For training the VFTED, the loss function [symbol] consists of a classification loss [symbol] _{cls}, and a localization loss [symbol] _{loc} to guide the framework toward accurate ethane leak detection. Specifically, the outputs of VFTED can be represented as

$$\{ {t}_{x}^{*} , {t}_{y}^{*} , {t}_{w}^{*} , {t}_{h}^{*} ; {p}^{*} \}$$

where t_{w}, t_{y}, t_{w} and tₕ denote the parameterized central coordinates, width and height; * denotes the prediction; and p is the object's confidence [B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490, and T.-Y. Lin, P. Goyal, R. Girshick, K. He, and P. Doll'ar, “Focal loss for dense object detection,” IEEE Transactions on Pattern Analysis and Machine Intelligence, vol. 42, no. 2, pp. 318-327, 2020]. Thus, the general loss function [symbol] can be formulated for a single box as follows:

$$\begin{matrix}ℒ = {ℒ}_{cls} ( p , {p}^{*} ) + λ {p}^{*} {ℒ}_{loc} ( t , {t}^{*} ) \\ = {ℒ}_{cls} ( p , {p}^{*} ) + λ {p}^{*} {\sum }_{i ∈ \{ x , y , w , h \}} R ( {t}_{i} - {t}_{i}^{*} )\end{matrix}$$

where [symbol] _{cls}(.) is the log loss over two classes (leak vs. not leak) [B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490]; λ=10 is the weight of localization loss; R(.) is the smooth L1 distance [B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490] that can be formulated as

$$R ( x ) = \{ \begin{matrix}0.5 {x}^{2} & \vert x \vert \leq 1 \\ \vert x \vert - 0.5 & \vert x \vert > 1\end{matrix}$$

More details can be found in B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490. The VFTED-OS also adopts additional Focal loss to balance the negative and positive training samples. The details can be found in T.-Y. Lin, P. Goyal, R. Girshick, K. He, and P. Doll'ar, “Focal loss for dense object detection,” IEEE Transactions on Pattern Analysis and Machine Intelligence, vol. 42, no. 2, pp. 318-327, 2020.

### Performance Evaluation of the Visual Fourier Transformer Ethane Detector

The performance of the proposed VFTED and baselines is evaluated by Precision (PR), Recall (RE) and F-Measure (FM). The detection of ethane is identified as correct when the matching Intersection of Union (IoU) with groundtruth and predicted bounding box is above 0.5, which is an evaluation standard commonly followed in evaluations of contemporary detection frameworks [Z.-Q. Zhao, P. Zheng, S.-T. Xu, and X. Wu, “Object detection with deep learning: A review,” IEEE Transactions on Neural Networks and Learning Systems, vol. 30, no. 11, pp. 3212-3232, 2019, and J. Bin, C. A. Rahman, S. Rogers, and Z. Liu, “Tensor-based approach for liquefied natural gas leakage detection from surveillance thermal cameras: A feasibility study in rural areas,” IEEE Transactions on Industrial Informatics, vol. 17, no. 12, pp. 8122-8130, 2021]. These evaluation metrics are listed as follows:

$$PR = \frac{TP}{TP + FP}$$

$$RE = \frac{TP}{TP + FN}$$

$$FM = 2 \cdot \frac{PR \cdot RE}{PR + RE}$$

$$IoU ( A , B ) = \vert \frac{A ⋂ B}{A ⋃ B} \vert$$

where TP, FP and FN are true positive, false positive, and false negative accordingly; A and B are two bounding boxes and |.| indicates area. The detection framework's accuracy and robustness should be considered and evaluated for safety-critical ethane detection. Two dataset split strategies, random split and chronological split, are implemented for VFTED and comparative methods as shown in FIG. 16. The collection of VI and IR image pairs is randomly divided into a training set (70%), and a testing set (30%), which follows the conventional procedure in objection detection [B. Cheng, Y. Wei, H. Shi, R. Feris, J. Xiong, and T. Huang, “Revisiting RCNN: On awakening the classification power of faster RCNN,” in Computer Vision—ECCV 2018, 2018, pp. 473-490, Z.-Q. Zhao, P. Zheng, S.-T. Xu, and X. Wu, “Object detection with deep learning: A review,” IEEE Transactions on Neural Networks and Learning Systems, vol. 30, no. 11, pp. 3212-3232, 2019]. The training and testing set may have correlated pairs after the random split. Thus, the random split aims to evaluate the general capacity of a framework in ethane detection. In contrast, the chronological split will result in balanced training (50%) and testing (50%) sets according to the scenarios of the images. Assuming the sample images are taken at 10 different scenarios, the chronological split will evenly divide the group of sample images into training (50%) and testing (50%) sets. Thus, the images are not correlated between training and testing sets. This strategy aims to verify the generalization and robustness of detection frameworks, which is more important for safety-critical ethane leak detection against unseen scenarios. Therefore, an overall metric is also shown representing a weighted sum of evaluation metrics between random split (30%) and chronological split (70%).

### Experimental Setup

For users' convenience, all the 8-bit or grayscale IR images are converted into 3-channel images before feeding into the network. Both VFTED and VFTED-OS are trained by stochastic gradient descent with an initial learning rate of 0.0025. The weight decays ten times after 30000 iterations with 0.9 momenta for stable convergence during training. The batch size is set as eight during training. Meanwhile, the predictive threshold is set to 0.5 across all the comparative methods. For a fair comparison, all the primary networks or backbones are fixed to R18 [K. He, X. Zhang, S. Ren, and J. Sun, “Deep residual learning for image recognition,” in IEEE Conference on Computer Vision and Pattern Recognition (CVPR), 2016, pp. 770-778]. Both VFTED and comparative baselines are trained and tested under random split and chronological split separately. All baseline methods were trained and tested on a cloud computing node configured with an NVIDIA Tesla P100 GPU card. The image was aligned using MOIR and using an image acquisition device described above in the material relating to MOIR.

### Effectiveness of Multimodal Fusion

Table 28 compares the detection performance of VFTED with single-modal and multimodal inputs. In this experiment, the VI and IR features are fused through an MLP after channel concatenation for a fair comparison. The multimodal fusion boosts the detection performance on all evaluation metrics. Specifically, the multimodal fusion achieves 60% improvement in overall FM which is sufficiently significant to demonstrate the effectiveness of multimodal fusion in ethane detection.

TABLE 28

| | | Random Split | | | Chronological Split | | | Overall | | |
|---|---|---|---|---|---|---|---|---|---|---|
| Modality | Backbone | PR↑ | RE↑ | FM↑ | PR↑ | RE↑ | FM↑ | PR↑ | RE↑ | FM↑ |
| IR | R18 | 55.16 | 58.32 | 56.70 | 7.66 | 15.80 | 10.32 | 21.91 | 28.56 | 24.23 |
| VI | R18 | 57.97 | 60.18 | 59.05 | 18.87 | 24.32 | 21.23 | 30.60 | 35.08 | 32.59 |
| VI + IR | R18 | 90.15 | 89.48 | 89.81 | 33.54 | 38.68 | 35.93 | 50.52 | 53.92 | 52.09 |
| VI + IR | V19 | 91.48 | 85.51 | 88.39 | 34.21 | 35.45 | 34.82 | 51.39 | 50.47 | 50.93 |
| VI + IR | MV3 | 87.49 | 88.68 | 88.08 | 30.64 | 29.41 | 30.01 | 47.70 | 47.19 | 47.44 |

### Backbone Selection

As aforementioned, the backbone aims to extract the image features from raw VI and IR images for further multimodal fusion. The quality of extracted VI and IR features also influences the effectiveness of frameworks in ethane detection. Thus, in addition to R18, two advanced efficient backbones, i.e. Vovnet-19 [Y. Lee and J. Park, “Centermask: Real-time anchor-free instance segmentation,” in 2020 IEEE/CVF Conference on Computer Vision and Pattern Recognition (CVPR), 2020, pp. 13 903-13 912](V19) and MobileNetV3 [A. Howard, M. Sandler, B. Chen, W. Wang, L.-C. Chen, M. Tan, G. Chu, V. Vasudevan, Y. Zhu, R. Pang, H. Adam, and Q. Le, “Searching for MobileNetV3,” in 2019 IEEE/CVF International Conference on Computer Vision (ICCV). IEEE, oct 2019](MV3), are selected as alternatives to evaluate the performance on ethane detection as shown in Table 28. The initial observation is that the V19 and R18 have similar performance under both random and chronological splits. In general, the V19 has slightly higher values in PR while R18 is better in RE. In industrial scenarios, a better RE means a higher probability of discovering an ethane leak at an early stage, which is favorable for such a safety-critical task. Meanwhile, the R18 also outperforms V19 in overall FM. Therefore, the R18 is chosen as the backbone for VI-Net and IR-Net in an example implementation of VFTED.

### Ablation Studies in VFT

TABLE 29

| | | | Random Split | | | Chronological Split | | | Overall | | |
|---|---|---|---|---|---|---|---|---|---|---|---|
| PE | FFT | IFFT | FR↑ | RE↑ | FM↑ | PR↑ | RE↑ | FM↑ | PR↑ | RE↑ | FM↑ |
| — | — | — | 90.15 | 89.48 | 89.81 | 33.54 | [symbol] | 35.93 | 50.52 | 53.92 | 52.09 |
| ✓ | — | — | 92.54 | 94.50 | 93.51 | 34.13 | 42.50 | 37.86 | 51.65 | 58.10 | 54.55 |
| ✓ | [symbol] | — | 91.65 | 93.80 | 92.71 | 36.23 | 43.93 | 39.71 | 52.86 | 58.89 | 55.61 |
| ✓ | [symbol] + [symbol] | — | 92.84 | 94.80 | 93.81 | 39.05 | [symbol] | 42.58 | 55.10 | 61.20 | 57.95 |
| ✓ | [symbol] + [symbol] | ✓ | 93.06 | 95.00 | 94.02 | 48.73 | 56.30 | 52.24 | 62.03 | 67.91 | 64.78 |

[symbol]

indicates data missing or illegible when filed

An ablation study was conducted to validate the modules in VFT. Table 29 presents the ablation study between PE, FFT and IFFT. Additional Position Encoding (PE) can improve general detection performance. Recalling the unfolding operator in VFT, PE enables VFT to realize the order of original features that maintain the semantic information even after dimensional collapse. Thus, PE is effective for the VFT. Although this manipulation avoids the difficulty in modeling complex numbers, the truncated information becomes another concern resulting in a slight improvement in overall FM. Moreover, the decreased performance in random split reflects that the framework's capacity shrinks due to the frequency domain's information loss. The proposed FMLP enables the VFT to consider both real and imaginary parts during multimodal fusion, which significantly improves the effectiveness of VFTED in ethane detection, as shown in Table 29. Another significant aspect of VFT is the implemented IFFT that converts the feature frequency into the spatial domain. The manipulation enables mixing layers to enhance the fused features globally, resulting in a better performance in ethane detection.

TABLE 30

| Backbone | Fusion | Overall | | |
|---|---|---|---|---|
| Setups | Strategies | FM ↑ | Memory ↓ | Latency ↓ |
| Single | Addition | 37.63 | — | — |
| Single | Cross-Attention | 39.75 | — | — |
| Single | Concatenation | 40.31 | — | — |
| Dual | Addition | 52.09 | 0.84 GB | 0.11 ms |
| Dual | Cross-Attention | 67.53 | 7.34 GB | 1.79 ms |
| Dual | Concatenation | 64.78 | 1.18 GB | 0.61 ms |

The fusion strategies were also compared. Two backbone setups were investigated, i.e. single and dual backbones. The single backbone setup indicates that there is only one network to learn representations from VI and IR images. In contrast, the dual backbone has IR-Net and VI-Net to extract features from VI and IR images, respectively. Combinations of features (or fusion strategies) from IR-Net and VI-Net were also evaluated in this study. Three fusion strategies are compared, i.e. addition, cross-attention [L. Chi, G. Tian, Y. Mu, and Q. Tian, “Two-stream video classification with cross-modality attention,” in 2019 IEEE/CVF International Conference on Computer Vision Workshop (ICCVW), 2019, pp. 4511-4520], and concatenation. Table 30 illustrates the experimental results of the backbone setups and fusion strategies. The single backbone setup is generally not comparable to the dual backbone setup, resulting in much lower overall FM. Turning to the dual backbone setup, the cross-attention and concatenation is much better than addition in overall FM. The cross-attention has slightly higher values than concatenation, while it consumes many memories and slows the process during inference. Thus, in an example implementation concatenation is chosen to balance the accuracy and efficiency of the framework.

TABLE 31

| | Random Split | | | Chronological Split | | | Overall | | |
|---|---|---|---|---|---|---|---|---|---|
| Normalization | PR↑ | RE↑ | FM↑ | PR↑ | RE↑ | FM↑ | PR↑ | RE↑ | FM↑ |
| Channel-wise | 93.06 | 95.00 | 94.02 | 48.73 | 56.30 | 52.24 | 62.03 | 67.91 | 64.78 |
| Batch-wise | 88.50 | 90.70 | 89.59 | 50.08 | 54.99 | 52.42 | 61.61 | 65.70 | 63.57 |
| Layer-wise | 94.94 | 91.58 | 93.23 | 45.46 | 55.33 | 49.91 | 60.30 | 66.21 | 62.91 |

Table 31 presents the results of the ablation study for the VFT with respect to various normalization methods. The results indicate that the proposed channel-wise normalization achieves the best performance over conventional batch-wise normalization and layer-wise normalization. Thus, channel-wise normalization is employed in the proposed VFT.

TABLE 32

| Multi- | | Random Split | | | Chronological Split | | | Overall | | |
|---|---|---|---|---|---|---|---|---|---|---|
| Scale | Stages | PR↑ | RE↑ | FM↑ | PR↑ | RE↑ | FM↑ | PR↑ | RE↑ | FM↑ |
| N | [symbol] | 85.85 | 89.25 | 87.51 | 46.54 | 48.83 | 47.65 | 58.33 | 60.95 | 59.61 |
| N | [symbol] | 86.15 | 80.17 | 83.05 | 41.88 | 48.61 | 44.99 | 55.16 | 58.08 | 56.41 |
| Y | All | 93.06 | 95.00 | 94.02 | 48.73 | 56.30 | 52.24 | 62.03 | 67.91 | 64.78 |

[symbol]

indicates data missing or illegible when filed

Table 32 presents the ablation studies of the multi-scale information brought by the FPN. Recalling the architecture of the proposed example implementation of the VFTED, there are four outputs, {S₂, S₃, S₄, S₅}, after the fusion of IR-Net and VI-Net. Without aggregating all fused features through FPN, the framework degrades to Faster RCNN [S. Ren, K. He, R. Girshick, and J. Sun, “Faster R-CNN: Towards real-time object detection with region proposal networks,” in Advances in Neural Information Processing Systems 28, 2015, pp. 91-99] that only takes either S4 or S5 as the inputs for detector heads. Compared with the results of S4 and S5, the aggregation of multi-scale information significantly improves the precision and sensitivity of ethane leak detection. Specifically, implementing FPN can result in a 15% improvement in overall FM. Thus, the FPN is included in the example implementation of VFTED to promote detection accuracy.

### Comparative Studies

First, the proposed VFT was compared with recent vision attention methods under the same design of a two-stage detection framework as VFTED. This comparison aims to validate the effectiveness of VFT in multimodal fusion. Second, the whole VFTED was compared with recent multimodal object detection frameworks. The VFTED-OS is also included to discuss the trade-off between variants of VFTED in this framework comparison.

Comparison with Vision Attention Methods

TABLE 33

| | Radom Split | | | Chronological Split | | | Overall | | |
|---|---|---|---|---|---|---|---|---|---|
| Methods | PR↑ | RE↑ | FM↑ | PR↑ | RE↑ | FM↑ | PR↑ | RE↑ | FM↑ |
| CBAM | 69.09 | 76.50 | 72.61 | 34.10 | 39.80 | 36.73 | 44.60 | 50.81 | 47.49 |
| SE | 37.80 | 54.70 | 44.71 | 21.49 | 26.10 | 23.57 | 26.38 | 34.68 | 29.91 |
| ViT | 88.86 | 90.50 | 89.67 | 35.23 | 41.80 | 38.23 | 51.32 | 56.41 | 53.67 |
| XCiT | 90.27 | 93.30 | 91.76 | 42.76 | 48.50 | 45.45 | 57.01 | 61.94 | 59.34 |
| PVT | 93.87 | 93.97 | 93.92 | 44.12 | 51.30 | 47.44 | 59.04 | 64.10 | 61.38 |
| Longformer | 87.60 | 90.04 | 88.80 | 43.74 | 51.78 | 47.43 | 56.90 | 63.26 | 59.84 |
| Performer | 94.30 | 96.32 | 95.30 | 48.59 | 54.61 | 51.42 | 62.30 | 67.12 | 64.59 |
| VFT(ours) | 93.06 | 95.00 | 94.02 | 48.73 | 56.30 | 52.24 | 62.03 | 67.91 | 64.78 |

In this comparative study, two classical local attention methods are chosen, specifically SE [J. Hu, L. Shen, S. Albanie, G. Sun, and E. Wu, “Squeeze-and-excitation networks,” IEEE Transactions on Pattern Analysis and Machine Intelligence, vol. 42, no. 8, pp. 2011-2023, 2020] and CBAM [S. Woo, J. Park, J.-Y. Lee, and I. S. Kweon, “Cbam: Convolutional block attention module,” in Proceedings of the European Conference on Computer Vision (ECCV), September 2018]. Meanwhile, five advanced global attention methods, ViT [A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” in International Conference on Learning Representations, June 2021, pp. 1-22], XCiT [A. El-Nouby, H. Touvron, M. Caron, P. Bojanowski, M. Douze, A. Joulin, I. Laptev, N. Neverova, G. Synnaeve, J. Verbeek, and H. Jegou, “XCiT: Cross-covariance image transformers,” in Advances in Neural Information Processing Systems, 2021, pp. 1-14], PVT [W. Wang, E. Xie, X. Li, D.-P. Fan, K. Song, D. Liang, T. Lu, P. Luo, and L. Shao, “PVTv2: Improved baselines with pyramid vision transformer,” Computational Visual Media, vol. 8, no. 3, pp. 1-10, 2022], Longformer [I. Beltagy, M. E. Peters, and A. Cohan, “Longformer: The long-document transformer,” arXiv:2004.05150,] and Performer [K. Choromanski, V. Likhosherstov, D. Dohan, X. Song, J. Davis, T. Sarlos, D. Belanger, L. J. Colwell, and A. Weller, “Masked language modeling for proteins via linearly scalable long-context transformers,” CoRR, vol. abs/2006.03555, 2020. [Online]. Available: https://arxiv.org/abs/2006.03555] were selected in this comparative study. Table 33 shows the results. Performer outperforms other attention methods within the baselines in random and chronological splits. Compared with the novel Performer, the proposed VFT has better evaluations in chronological split with comparable results in random split. And, the overall RE and FM of VFT are better than Performer. In order to investigate the facts behind the improved generalization, activation maps of fused features at the last FPN layer under the chronological split were examined using a visualization. The visualization is derived via Grad-CAM3. The region of the ethane leak as determined by human labeling was displayed on the graphs. Compared with contemporary methods, the activated features of VFT could be seen to concentrate more on where the ethane is. The observation suggests that the fine quality of the fused features from VFT contribute to generalization and ethane detection.

TABLE 34

| Methods | Types | Memory↓ | Latency↓ | Complexity↓ |
|---|---|---|---|---|
| CBAM | Local | 1.12 GB | 0.41 ms | O(2 · L · C) |
| SE | Local | 1.10 GB | 0.15 ms | O(L · C) |
| ViT | Global | 6.58 GB | 1.23 ms | O(L² · C) |
| PVT | Global | 1.33 GB | 0.78 ms | O((L/n)² · C) |
| XCiT | Global | 1.25 GB | 0.58 ms | O(L · C²) |
| Longformer | Global | 1.48 GB | 0.72 ms | O(L · w · C) |
| Performer | Global | 1.41 GB | 0.69 ms | O(L · m · C) |
| VFT (ours) | Global | 1.18 GB | 0.61 ms | Q(L · log(L) · C) |

Another comparison is complexity analysis among comparative vision attention methods. Table 34 reports the memory occupation, latency, and theoretical complexity when the batch size is set as one. The local attention methods have significantly lower memories, latency, and complexity due to the lightweight design of convolution neural networks. However, the boosted efficiency sacrifices the effectiveness during multimodal fusion. ViT is enhanced by MHA to achieve much better performance in ethane detection while the computational efficiency is much worse, as shown in Table 34. The MHA is a serial matrix multiplication between matrices Q, K, V, resulting in a complexity of O(L²·C) where a matrix size is L×C. PVT reduces the matrix size by a ratio of n before multiplication through a downsampling function to accelerate the inference speed. Performer and Longformer have similar insights to PVT and employ spatial reduction before matrix multiplication. Longformer applies a sliding window with w steps to calculate vision attention [I. Beltagy, M. E. Peters, and A. Cohan, “Longformer: The long-document transformer,” arXiv:2004.05150,]. Performer adopts the idea of m rank approximation from matrix factorization to decrease the complexity. As L is usually much larger than C, XCiT transposes the matrices of [symbol] and K before multiplication which can save more computation but sacrifices effectiveness in ethane leak detection [A. El-Nouby, H. Touvron, M. Caron, P. Bojanowski, M. Douze, A. Joulin, I. Laptev, N. Neverova, G. Synnaeve, J. Verbeek, and H. Jegou, “XCiT: Cross-covariance image transformers,” in Advances in Neural Information Processing Systems, 2021, pp. 1-14]. However, the aforementioned vision attention methods rely on matrix multiplication to generate attention, which is still heavy in computation. The proposed VFT employs the FFT to generate global attention that free the framework from complex matrix multiplication with the best performance and competitive efficiency in ethane leak detection.

Comparison with Multimodal Object Detection Frameworks

TABLE 35

| | Random Split | | | Chronological Split | | | Overall | | |
|---|---|---|---|---|---|---|---|---|---|
| Methods | PR↑ | RE↑ | FM↑ | PR↑ | RE↑ | FM↑ | PR↑ | RE↑ | FM↑ |
| CMIAN | 53.83 | 68.60 | 60.32 | 11.26 | 14.70 | 12.75 | 24.03 | 30.87 | 27.02 |
| IR2V1 | [symbol] | 89.10 | 85.02 | 31.54 | 38.20 | 34.55 | 46.47 | 53.47 | 49.69 |
| SKMPD | 89.10 | 90.60 | 89.84 | 33.40 | 44.30 | 38.09 | 50.11 | 58.19 | 53.61 |
| ECFFNet | 90.88 | 91.99 | 91.43 | 34.57 | 46.46 | 39.64 | 51.46 | 60.12 | 55.18 |
| RFF | 91.53 | 92.83 | 92.17 | 38.92 | [symbol] | 43.51 | 54.70 | 62.38 | 58.11 |
| CGFNet | 95.25 | 94.77 | 95.01 | 42.79 | [symbol] | 47.19 | 58.53 | 65.25 | 61.53 |
| VFTED (ours) | 93.06 | 95.00 | 94.02 | 48.73 | 56.30 | 52.24 | 62.03 | 67.91 | 64.78 |
| VFTED-OS (ours) | 87.28 | 98.20 | 92.42 | 34.64 | [symbol] | 40.06 | 46.23 | [symbol] | 55.77 |

[symbol]

indicates data missing or illegible when filed

Six novel multimodal object detection frameworks were selected in a comparative study against the proposed VFTED-series frameworks. Specifically, CMIAN [L. Zhang, Z. Liu, S. Zhang, X. Yang, H. Qiao, K. Huang, and A. Hussain, “Cross-modality interactive attention network for multispectral pedestrian detection,” Information Fusion, vol. 50, pp. 20-29, oct 2019], IR2VI [S. Liu, M. Gao, V. John, Z. Liu, and E. Blasch, “Deep learning thermal image translation for night vision perception,” ACM Trans. Intell. Syst. Technol., vol. 12, no. 1, pp. 1-18, December 2020], SKMPD [L. Ding, Y. Wang, R. Lagani'ere, D. Huang, X. Luo, and H. Zhang, “A robust and fast multispectral pedestrian detection deep network,” Knowledge-Based Systems, vol. 227, p. 106990, September 2021], ECFFNet [W. Zhou, Q. Guo, J. Lei, L. Yu, and J.-N. Hwang, “Ecffnet: Effective and consistent feature fusion network for rgb-t salient object detection,” IEEE Transactions on Circuits and Systems for Video Technology, vol. 32, no. 3, pp. 1224-1235, 2022], RFF [Q. Zhang, T. Xiao, N. Huang, D. Zhang, and J. Han, “Revisiting feature fusion for rgb-t salient object detection,” IEEE Transactions on Circuits and Systems for Video Technology, vol. 31, no. 5, pp. 1804-1818, 2021] and CGFNet [J. Wang, K. Song, Y. Bao, L. Huang, and Y. Yan, “Cgfnet: Cross-guided fusion network for rgb-t salient object detection,” IEEE Transactions on Circuits and Systems for Video Technology, vol. 32, no. 5, pp. 2949-2961, 2022] were selected for this experiment. Table 35 illustrates the performance evaluations over random and chronological splits. In the experiments of random split, both VFTED and CGFNet outperform the rest of baselines with considerable margin, while their scores are similar over PR, RE and FM. The main reason is that CGFNet [J. Wang, K. Song, Y. Bao, L. Huang, and Y. Yan, “Cgfnet: Cross-guided fusion network for rgb-t salient object detection,” IEEE Transactions on Circuits and Systems for Video Technology, vol. 32, no. 5, pp. 2949-2961, 2022] also employs global attention to fuse the cross-modality features. However, the results of chronological split indicates that VFTED has higher values over all evaluation criteria than the other methods compared. Compared with competitive CGFNet [J. Wang, K. Song, Y. Bao, L. Huang, and Y. Yan, “Cgfnet: Cross-guided fusion network for rgb-t salient object detection,” IEEE Transactions on Circuits and Systems for Video Technology, vol. 32, no. 5, pp. 2949-2961, 2022], the proposed VFTED can achieve around 10% improvement of FM in the chronological split, which also leads to the best performance in the overall evaluations.

TABLE 36

| | | | | | | | VFTED | VFTED-OS |
|---|---|---|---|---|---|---|---|---|
| Methods | CMIAN | IR2VI | SKMPD | ECFFNet | RFF | CGFNet | (ours) | (ours) |
| FPS↑ | 30.61 | 38.43 | 26.65 | 23.8 | 17.86 | 12.45 | 25.32 | 31.01 |

The computational efficiency of the compared methods is also evaluated by frames per second (FPS) as shown in Table 36. IR2VI employs simple addition to fuse VI and IR features resulting in the highest FPS among comparative methods [S. Liu, M. Gao, V. John, Z. Liu, and E. Blasch, “Deep learning thermal image translation for night vision perception,” ACM Trans. Intell. Syst. Technol., vol. 12, no. 1, pp. 1-18, December 2020]. However, its detection accuracy cannot satisfy the demand in industrial applications. CMIAN and SKMPD employ sophisticated designs in multimodal fusion based on local attention [L. Zhang, Z. Liu, S. Zhang, X. Yang, H. Qiao, K. Huang, and A. Hussain, “Cross-modality interactive attention network for multispectral pedestrian detection,” Information Fusion, vol. 50, pp. 20-29, oct 2019, and L. Ding, Y. Wang, R. Lagani'ere, D. Huang, X. Luo, and H. Zhang, “A robust and fast multispectral pedestrian detection deep network,” Knowledge-Based Systems, vol. 227, p. 106990, September 2021]. Thus, the performance of ethane detection is improved compared with IR2VI, but they also have decreased FPS, as shown in Table 36. ECFFNet [W. Zhou, Q. Guo, J. Lei, L. Yu, and J.-N. Hwang, “Ecffnet: Effective and consistent feature fusion network for rgb-t salient object detection,” IEEE Transactions on Circuits and Systems for Video Technology, vol. 32, no. 3, pp. 1224-1235, 2022], RFF [Q. Zhang, T. Xiao, N. Huang, D. Zhang, and J. Han, “Revisiting feature fusion for rgb-t salient object detection,” IEEE Transactions on Circuits and Systems for Video Technology, vol. 31, no. 5, pp. 1804-1818, 2021] and CGFNet [J. Wang, K. Song, Y. Bao, L. Huang, and Y. Yan, “Cgfnet: Cross-guided fusion network for rgb-t salient object detection,” IEEE Transactions on Circuits and Systems for Video Technology, vol. 32, no. 5, pp. 2949-2961, 2022] are much slower than CMIAN due to their high-complexity designs for information fusion. CGFNet [J. Wang, K. Song, Y. Bao, L. Huang, and Y. Yan, “Cgfnet: Cross-guided fusion network for rgb-t salient object detection,” IEEE Transactions on Circuits and Systemsfor Video Technology, vol. 32, no. 5, pp. 2949-2961, 2022] has 12.45 FPS which is half of VFTED's inference speed. Both CGFNet [117] and VFTED employ a global attention mechanism to fuse VI and IR features. The higher inference speed of VFTED also confirms the efficiency of the proposed VFT for information fusion. Although VFTED is not the fastest framework in ethane leak detection, the FPS of VFTED is acceptable for industrial applications with around 24 FPS. Meanwhile, the faster variant of VFTED, VFTED-OS, reaches the second-best FPS by implementing a one-stage FPN-based detector with comparable detection accuracy to SKMPD [L. Ding, Y. Wang, R. Lagani'ere, D. Huang, X. Luo, and H. Zhang, “A robust and fast multispectral pedestrian detection deep network,” Knowledge-Based Systems, vol. 227, p. 106990, September 2021], ECFFNet [W. Zhou, Q. Guo, J. Lei, L. Yu, and J.-N. Hwang, “Ecffnet: Effective and consistent feature fusion network for rgb-t salient object detection,” IEEE Transactions on Circuits and Systems for Video Technology, vol. 32, no. 3, pp. 1224-1235, 2022] and RFF [Q. Zhang, T. Xiao, N. Huang, D. Zhang, and J. Han, “Revisiting feature fusion for rgb-t salient object detection,” IEEE Transactions on Circuits and Systems for Video Technology, vol. 31, no. 5, pp. 1804-1818, 2021]. In summary, the experimental results show the effectiveness and efficiency of the proposed VFTED in ethane detection from multimodal imaging.

Comparison with Gas Leak Detection Frameworks

TABLE 37

| | Random Split | | | Chronological Split | | | Overall | | |
|---|---|---|---|---|---|---|---|---|---|
| Methods | PR↑ | RE↑ | FM↑ | PR↑ | RE↑ | FM↑ | PR↑ | RE↑ | FM↑ |
| GMM | 25.48 | 48.54 | 33.42 | 20.15 | 46.02 | 28.03 | 21.75 | 46.77 | 20.65 |
| ViBE | 26.37 | 43.51 | 32.84 | 23.87 | 40.24 | 29.96 | 24.62 | 41.22 | 30.83 |
| TBLD | 48.62 | 55.48 | 51.82 | 34.19 | 52.05 | 41.27 | 38.52 | 53.08 | 44.44 |
| GasNet | 42.68 | 48.53 | 45.42 | 29.03 | 45.01 | 35.29 | 33.12 | 46.07 | 38.33 |
| SAM | 36.99 | 66.33 | 47.49 | 31.60 | 60.65 | 41.55 | 33.22 | 62.35 | 43.34 |
| VFTED (ours) | 93.06 | 95.00 | 94.02 | 48.73 | 56.30 | 52.24 | 62.03 | 67.91 | 64.78 |
| VFTED-OS (ours) | 87.28 | 98.20 | 92.42 | 34.64 | 47.50 | 40.06 | 46.23 | 60.61 | 55.77 |

As discussed above, the conventional approaches applied background subtraction techniques to perceive the gas leak by calculating the difference between consecutive frames from thermal imaging device [J. Wang, L. P. Tchapmi, A. P. Ravikumar, M. McGuire, C. S. Bell, D. Zimmerle, S. Savarese, and A. R. Brandt, “Machine vision for natural gas methane emissions detection using an infrared camera,” Applied Energy, vol. 257, p. 113998, January 2020, B. Garcia-Garcia, T. Bouwmans, and A. J. R. Silva, “Background subtraction in real applications: Challenges, current models and future directions,” Computer Science Review, vol. 35, p. 100204, feb 2020, J. Bin, C. A. Rahman, S. Rogers, and Z. Liu, “Tensor-based approach for liquefied natural gas leakage detection from surveillance thermal cameras: A feasibility study in rural areas,” IEEE Transactions on Industrial Informatics, vol. 17, no. 12, pp. 8122-8130, 2021]. Thus, this comparative study aims to validate the performance of VFTED-series methods against these baselines, i.e., GMM [C. Stauffer and W. Grimson, “Adaptive background mixture models for real-time tracking,” in Proceedings. 1999 IEEE Computer Society Conference on Computer Vision and Pattern Recognition (Cat. No PR00149), Fort Collins, CO, USA, June 1999], ViBE [B. Garcia-Garcia, T. Bouwmans, and A. J. R. Silva, “Background subtraction in real applications: Challenges, current models and future directions,” Computer Science Review, vol. 35, p. 100204, feb 2020], TBLD [J. Bin, C. A. Rahman, S. Rogers, and Z. Liu, “Tensor-based approach for liquefied natural gas leakage detection from surveillance thermal cameras: A feasibility study in rural areas,” IEEE Transactions on Industrial Informatics, vol. 17, no. 12, pp. 8122-8130, 2021], GasNet [J. Wang, L. P. Tchapmi, A. P. Ravikumar, M. McGuire, C. S. Bell, D. Zimmerle, S. Savarese, and A. R. Brandt, “Machine vision for natural gas methane emissions detection using an infrared camera,” Applied Energy, vol. 257, p. 113998, January 2020] and SAM [B. Ayhan, C. Kwan, and J. O. Jensen, “Remote vapor detection and classification using hyperspectral images,” in Proc. SPIE 11010, Chemical, Biological, Radiological, Nuclear, and Explosives (CBRNE) Sensing XX, may 2019, pp. 1-16]. Before feeding images to these baselines, all VI and IR images are concatenated to consider the information from both modalities. Table 37 presents the experimental results. For the experiments in random split, the VFTED-series models obviously outperform the rest of the contemporary methods tested by a large margin. However, the results of the chronological split show that the SAM has a higher RE. That indicates that the SAM [23] features higher sensitivity in ethane leak detection. All values of PR of the baseline methods tested are much lower than the VFTED series due to the lack of discriminating capability in background subtraction, which significantly increases the chance of false detection. Compared with the baselines, the VFTED series can have much higher PR with competitive RE (or sensitivity) in the chronological split. Moreover, in the overall evaluations, both VFTED and VFTED-OS achieve 120% improvement in FM over advanced TBLD [J. Bin, C. A. Rahman, S. Rogers, and Z. Liu, “Tensor-based approach for liquefied natural gas leakage detection from surveillance thermal cameras: A feasibility study in rural areas,” IEEE Transactions on Industrial Informatics, vol. 17, no. 12, pp. 8122-8130, 2021] and GasNet [J. Wang, L. P. Tchapmi, A. P. Ravikumar, M. McGuire, C. S. Bell, D. Zimmerle, S. Savarese, and A. R. Brandt, “Machine vision for natural gas methane emissions detection using an infrared camera,” Applied Energy, vol. 257, p. 113998, January 2020]. The computational efficiency are also evaluated for these baselines and for VFTED as presented in Table 38. ViBE [O. Barnich and M. V. Droogenbroeck, “ViBe: A universal background subtraction algorithm for video sequences,” IEEE Transactions on Image Processing, vol. 20, no. 6, pp. 1709-1724, June 2011] achieves the highest inference speed, however its low overall FM scores suggest its incapability in ethane leak detection. Compared with SAM, the best baseline within gas leak detection frameworks, both variants of VFTED have comparable FPS and have higher scores in overall FM. In summary, the comparative study indicates that the proposed VFTED-series methods have balanced performance in ethane leak detection.

TABLE 38

| Methods | GMM | VIBE | TBLD | GasNet | SAM | VFTED (ours) | VFTED-OS (ours) |
|---|---|---|---|---|---|---|---|
| FPS↑ | 65.84 | 72.54 | 3.33 | 17.85 | 30.57 | 25.32 | 31.01 |

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method of detecting leaks of a chilled or pressurized fluid in a potential leakage area based on a sequence of infrared (IR) images of the potential leakage area, and a sequence of visual (VI) images of the potential leakage area, the method comprising, for plural time steps of a sequence of time steps each corresponding to a respective IR image and a respective VI image, carrying out the steps of:
using an IR backbone neural network, extracting IR image-level features from the respective IR image;
using a VI backbone neural network, extracting VI image-level features from the respective VI image;
comparing the IR image-level features with other IR image-level features extracted from one or more other IR images corresponding to different time steps of the sequence of time steps than the time step corresponding to the respective IR image and the respective VI image to obtain IR motion-enhanced features;
comparing the VI image-level features with other VI image-level features extracted from one or more other VI images corresponding to the different time steps of the sequence of time steps to obtain VI motion-enhanced features;
comparing the IR motion-enhanced features with the VI motion-enhanced features to obtain fused features; and
generating a detection output indicating a presence and a location of a leak of the chilled or pressurized fluid based on the fused features.

2. The method of claim 1 in which the IR backbone neural network and the VI backbone neural network each include multiple stages, the IR image-level features and the VI image-level features including outputs from plural of the multiple stages;
the steps of comparing the IR image-level features to obtain IR motion-enhanced features, comparing the VI image-level features to obtain VI motion-enhanced VI features, and comparing the IR motion-enhanced features with the VI motion-enhanced features to obtain fused features being carried out on the outputs from the plural stages to obtain the fused features as stage-specific fused features for each of the plural stages; and
the step of generating the detection output indicating the presence and the location of the leak of the chilled or pressurized fluid based on the fused features comprising comparing the stage-specific fused features from the plural stages.

3. The method of claim 2 in which comparing the stage-specific fused features includes obtaining stage-specific processed features based on the stage-specific fused features, the stage-specific processed features at a stage corresponding to more detailed features including upsampled information from another stage corresponding to less detailed features.

4. The method of claim 2 in which in the step of generating the detection output, for each stage a respective initial detection output is generated, and the detection output is generated based on the respective initial detection outputs.

5. The method of claim 2 in which in the step of generating the detection output, for each stage a respective initial detection output is generated, and the detection output is one of the respective initial detection outputs and is based directly or indirectly on the other respective initial detection outputs.

6. The method of claim 4 in which the respective initial detection outputs are generated using a coarse proposal network to generate coarse proposals, and a refining network to generate the initial detection outputs from features in the coarse proposals.

7. The method of claim 6 in which the features in the coarse proposals are extracted via an RoIAlign layer to provide input to the refining network.

8. The method of claim 4 in which the respective initial detection outputs are generated using a presence network to generate presence outputs indicating the presence of the leak, and a location network to generate location outputs indicating the location of the leak.

9. The method of claim 1 in which the IR backbone neural network and the VI backbone neural network have identical structure.

10. The method of claim 9 in which the IR backbone neural network and the VI backbone neural network have identical weights.

11. The method of claim 1 in which the step of comparing the IR image-level features with the other IR image-level features to obtain the IR motion-enhanced features is carried out using an IR subtraction network to obtain IR motion-extracted features, and then applying a temporal aggregation IR network to the IR motion-extracted features to obtain the IR motion-enhanced features, and the step of comparing the VI image-level features with the other VI image-level features to obtain VI motion-enhanced features is carried out using a VI subtraction network to obtain VI motion-extracted VI features, and then applying a temporal aggregation VI network to the VI motion-extracted features to obtain the VI motion-enhanced features.

12. The method of claim 11 in which the IR subtraction network includes an IR attention mechanism to dynamically adjust contributions of different spatial IR features of the IR image-level features to the IR motion-extracted features, and the VI subtraction network includes a VI attention mechanism to dynamically adjust contributions of different spatial VI features of the VI image-level features to the VI motion-extracted features.

13. The method of claim 11 in which the temporal aggregation VI network includes a 2-dimensional VI convolution network, and the temporal aggregation IR network includes a 2-dimension IR convolution network.

14. The method of claim 11 in which the IR subtraction network has identical structure to the VI subtraction network, and the temporal aggregation IR network has identical structure to the temporal aggregation VI network.

15. The method of claim 14 in which IR subtraction network has identical weights to the VI subtraction network, and the temporal aggregation IR network has identical weights to the temporal aggregation VI network.

16. The method of claim 1 in which the step of comparing the IR motion-enhanced features with the VI motion-enhanced features to obtain fused features is carried out by a multimodal fusion network comprising a 2-dimensional convolution network.

17. The method of claim 1 in which the step of comparing the IR motion-enhanced features with the VI motion-enhanced features to obtain fused features is carried out by a multimodal fusion module that includes a discrete Fourier transform to generate frequency domain features, a neural network connected to receive the frequency domain features to generate frequency domain outputs, and an inverse Fourier transform applied to the frequency domain outputs.

18. The method of claim 1 further comprising training together using end-to-end training the IR backbone neural network, the VI backbone neural network, and every neural network used in the steps of:
comparing the IR image-level features with the other IR image-level features to obtain the IR motion-enhanced features;
comparing the VI image-level features with the other VI image-level features to obtain the VI motion-enhanced features;
comparing the motion-enhanced IR features with the motion-enhanced VI features to obtain the fused features; and
generating the detection output indicating the presence and the location of the leak of the chilled or pressurized fluid based on the fused features.

19. The method of claim 1 in which the chilled or pressurized fluid comprises ethane, methane, propane, butane or CO₂.

20. The method ofany claim 1 further comprising the step of, before the steps of extracting the IR image level features and extracting the VI image-level features, registering the respective IR image and the respective VI image together to relatively align the respective IR image and the respective VI image.

21. A system for detecting leaks of a chilled or pressurized fluid, comprising:
a computer;
an infrared camera oriented to view an area of potential leakage of the chilled or pressurized fluid, the infrared camera being wiredly or wirelessly connected to send infrared images to the computer;
a visual camera oriented to view the area of potential leakage of the chilled or pressurized fluid, the visual camera being wiredly or wirelessly connected to send visual images to the computer;
the computer including a memory containing instructions to cause the computer to carry out the steps of claim 1.

22. A method of training a model for detecting leaks of a chilled or pressurized fluid using video infrared (IR) and video visual (VI) data, the method comprising the steps of:
supplying an IR neural network;
supplying a VI neural network;
supplying a combined neural network;
supplying the video IR data to the IR neural network to generate IR feature outputs;
supplying the video VI data to the VI neural network to generate VI feature outputs;
supplying IR and VI feature outputs to the combined neural networks to generate overall leak detection and localization outputs; and
comparing the leak detection and localization outputs to desired leak detection and localization outputs for the video IR and video VI data to generate end-to-end feedback to train the IR neural network, the VI neural network and the combined neural network, the model comprising the IR neural network, the VI neural network and the combined neural network.

23-25. (canceled)
